(19) United States
(12) Patent Application Publication
(10) Pub. No.: US 2025/0141516 A1
(43) Pub. Date: May 1, 2025

(54) METHOD AND APPARATUS FOR CHANNEL STATE INFORMATION ACQUISITION IN NETWORK COOPERATIVE COMMUNICATION SYSTEMS

(71) Applicant: Samsung Electronics Co., Ltd., Gyeonggi-do (KR)

(72) Inventors: Youngrok JANG, Gyeonggi-do (KR); Hyoungju JI, Gyeonggi-do (KR); Namjeong LEE, Gyeonggi-do (KR); Younsun KIM, Gyeonggi-do (KR)

(21) Appl. No.: 18/923,403

(22) Filed: Oct. 22, 2024

(30) Foreign Application Priority Data
Oct. 25, 2023 (KR) 10-2023-0143568

(51) Int. Cl. H04B 7/06; H04L 5/00; H04W 24/10

(52) U.S. Cl. CPC H04B 7/0626; H04L 5/0048; H04W 24/10

(57) ABSTRACT

The disclosure relates to a 5G or 6G communication system for supporting a higher data transmission rate. A method performed by a terminal in a wireless communication system includes receiving, from a base station, first configuration information on a sounding reference signal (SRS) resource, receiving, from the base station, second configuration information for a channel state information (CSI) report, transmitting, to the base station, an SRS for a first channel between a first transmission and reception point (TRP) and the terminal based on the first configuration information, and transmitting, to the base station, the CSI report including a measurement result of a second channel between a second TRP and the terminal based on the second configuration information.

### CROSS-REFERENCE TO RELATED APPLICATION(S)

This application is based on and claims priority under 35 U.S.C. § 119 to Korean Patent Application No. 10-2023-0143568, filed on Oct. 25, 2023, in the Korean Intellectual Property Office, the disclosure of which is incorporated herein by reference in its entirety.

### BACKGROUND

### 1. Field

The disclosure relates generally to operations of a user equipment (UE) and a base station in a wireless communication system, and more particularly, to a method for acquiring channel state information (CSI) in a network cooperative communication system and an apparatus capable of performing the same in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of the third generation partnership project (3GPP), long-term evolution (LTE) or evolved universal terrestrial radio access (E-UTRA)), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a UE or an MS transmits data or control signals to a base station (BS) or eNode B, and the downlink refers to a radio link via which the base station transmits data or control signals to the UE. The above multiple access scheme may separate data or control information of respective users by allocating and operating time-frequency resources for transmitting the data or control information for each user to avoid overlapping each other, that is, to establish orthogonality.

Since a 5G communication system, which is a post-LTE communication system, must freely reflect various requirements of users, service providers, and the like, services satisfying various requirements must be supported, including eMBB communication, mMTC, URLLC, and the like.

eMBB aims to provide a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the uplink for a single base station. The 5G communication system must provide an increased user-perceived data rate to the UE, as well as the maximum data rate. To satisfy such requirements, transmission/reception technologies including a further enhanced MIMO transmission technique are required to be improved. The data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of many UEs in a cell, enhancement coverage of UEs, improved battery time, a reduction in the cost of a UE, and the like, to effectively provide the IoT. Since the IoT provides communication functions while being provided to various sensors and various devices, it must support many UEs (e.g., 1,000,000 UEs/square kilometer (km²)) in a cell. The UEs supporting mMTC may require wider coverage than those of other services provided by the 5G communication system because the UEs are likely to be in a shadow area, such as a basement of a building, which is not covered by the cell due to the nature of the service. The UE supporting mMTC must be configured to be inexpensive, and may require a very long battery life-time such as 10 to 15 years since it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 milliseconds (ms), and may also require a packet error rate of 10-5 or less. Therefore, for the services supporting URLLC, a 5G system must provide a transmit time interval (TTI) shorter than those of other services, and also may require a design for assigning a large number of resources in a frequency band to secure reliability of a communication link.

The eMBB, URLLC, and mMTC, may be multiplexed and transmitted in a single system. In this case, different transmission/reception techniques and transmission/reception parameters may be used between services to satisfy different requirements of the respective services. 5G is not limited to the three services, however.

With the advance of wireless communication systems as described above, various services can be provided, and accordingly there is a need for ways to effectively provide these services.

### SUMMARY

The disclosure has been made to address at least the above-mentioned problems and/or disadvantages and to provide at least the advantages described below.

Accordingly, an aspect of the disclosure is to provide an apparatus and a method capable of effectively providing a service in a mobile communication system.

In accordance with an aspect of the disclosure, a method performed by a terminal in a wireless communication system includes receiving, from a base station, first configuration information on a sounding reference signal (SRS) resource, receiving, from the base station, second configuration information for a channel state information (CSI) report, transmitting, to the base station, an SRS for a first channel between a first transmission and reception point (TRP) and the terminal based on the first configuration information, and transmitting, to the base station, the CSI report including a measurement result of a second channel between a second TRP and the terminal based on the second configuration information.

In accordance with an aspect of the disclosure, a method performed by a base station in a wireless communication system includes transmitting, to a terminal, first configuration information on a sounding reference signal (SRS) resource, transmitting, to the terminal, second configuration information for a channel state information (CSI) report, receiving, from the terminal, an SRS for a first channel between a first transmission and reception point (TRP) and the terminal based on the first configuration information, and receiving, from the terminal, the CSI report including a measurement result of a second channel between a second TRP and the terminal based on the second configuration information.

In accordance with an aspect of the disclosure, a terminal in a wireless communication system includes a transceiver; and at least one processor coupled with the transceiver and configured to receive, from a base station, first configuration information on a sounding reference signal (SRS) resource, receive, from the base station, second configuration information for a channel state information (CSI) report, transmit, to the base station, an SRS for a first channel between a first transmission and reception point (TRP) and the terminal based on the first configuration information, and transmit, to the base station, the CSI report including a measurement result of a second channel between a second TRP and the terminal based on the second configuration information.

In accordance with an aspect of the disclosure, a base station in a wireless communication system includes a transceiver, and at least one processor coupled with the transceiver and configured to transmit, to a terminal, first configuration information on a sounding reference signal (SRS) resource, transmit, to the terminal, second configuration information for a channel state information (CSI) report, receive, from the terminal, an SRS for a first channel between a first transmission and reception point (TRP) and the terminal based on the first configuration information, and receive, from the terminal, the CSI report including a measurement result of a second channel between a second TRP and the terminal based on the second configuration information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment;

FIG. 2 illustrates a structure of a frame, a subframe, and a slot in a wireless communication system according to an embodiment;

FIG. 3 illustrates an example of a BWP configuration in a wireless communication system according to an embodiment;

FIG. 4 illustrates radio protocol structures of a base station and a UE in single cell, carrier aggregation (CA), and dual connectivity (DC) situations in a wireless communication system according to an embodiment;

FIG. 5 illustrates a beam application time which may be considered when using an integrated TCI scheme in a wireless communication system according to an embodiment;

FIG. 6 illustrates another MAC-CE structure for joint TCI state or separate DL or UL TCI state activation and indication in a wireless communication system according to an embodiment;

FIG. 7 illustrates one example of an aperiodic channel state information (CSI) reporting method;

FIG. 8 illustrates an example of CORESET configuration of a downlink control channel in a wireless communication system according to an embodiment;

FIG. 9 illustrates a structure of a downlink control channel in a wireless communication system according to an embodiment;

FIG. 10 illustrates a process for beam configuration and activation in a PDSCH according to an embodiment;

FIG. 11 illustrates an SRS antenna switching operation according to an embodiment;

FIG. 12 illustrates an example of antenna port configuration and resource assignment for cooperative communication in a wireless communication system according to an embodiment;

FIG. 13 illustrates an example of downlink control information (DCI) configuration for cooperative communication in a wireless communication system according to an embodiment;

FIG. 14 illustrates an enhanced PDSCH TCI state activation/deactivation MAC-CE structure according to an embodiment;

FIG. 15 illustrates elements constituting a base station Herein, and a process in which the base station acquires a channel through an SRS transmitted by a UE;

FIG. 16 illustrates a channel information feedback method according to an embodiment;

FIG. 17 illustrates operations of a UE according to an embodiment;

FIG. 18 illustrates operations of a base station according to an embodiment;

FIG. 19 illustrates a structure of a UE in a wireless communication system according to an embodiment; and

FIG. 20 illustrates a structure of a base station in a wireless communication system according to an embodiment.

### DETAILED DESCRIPTION

Hereinafter, embodiments of the disclosure will be described in detail with reference to the accompanying drawings.

Descriptions related to technical contents well-known in the relevant art and not associated directly with the disclosure will be omitted for the sake of clarity and conciseness.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

In the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure are merely specific examples to easily explain the technical contents and help understanding of the disclosure, and are not intended to limit the scope of the disclosure. That is, it will be apparent to those skilled in the art that other variants based on the technical idea of the disclosure may be implemented. Embodiments herein may be employed in combination, as necessary. For example, a part of one embodiment may be combined with a part of another embodiment to operate a base station and a terminal. As an example, a part of a first embodiment may be combined with a part of a second embodiment to operate a base station and a terminal. Although the embodiments will be described based on the frequency division duplex long term evolution (FDD LTE) system, other variants based on the technical idea of the embodiments may also be implemented in other communication systems such as time division duplex (TDD) LTE, and 5G, or NR systems.

In the drawings, the order of the description does not always correspond to the order in which steps of each method are performed, and the order relationship between the steps may be changed or the steps may be performed in parallel.

The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a UE, a mobile station (MS), a cellular phone, a smartphone, a computer, or a multimedia system capable of performing a communication function. In the disclosure, a “downlink (DL) refers to a radio link via which a base station transmits a signal to a terminal, and an uplink (UL) refers to a radio link via which a terminal transmits a signal to a base station.

LTE or LTE-A systems may be described herein by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the 5G may be the concept that covers the exiting LTE, LTE-A, and other similar services. In addition, based on determinations by those skilled in the art, the disclosure may also be applied to other communication systems through some modifications without significantly departing from the scope of the disclosure.

In the following description, the term “a/b” may be understood as at least one of a and b.

### NR Time-Frequency Resources

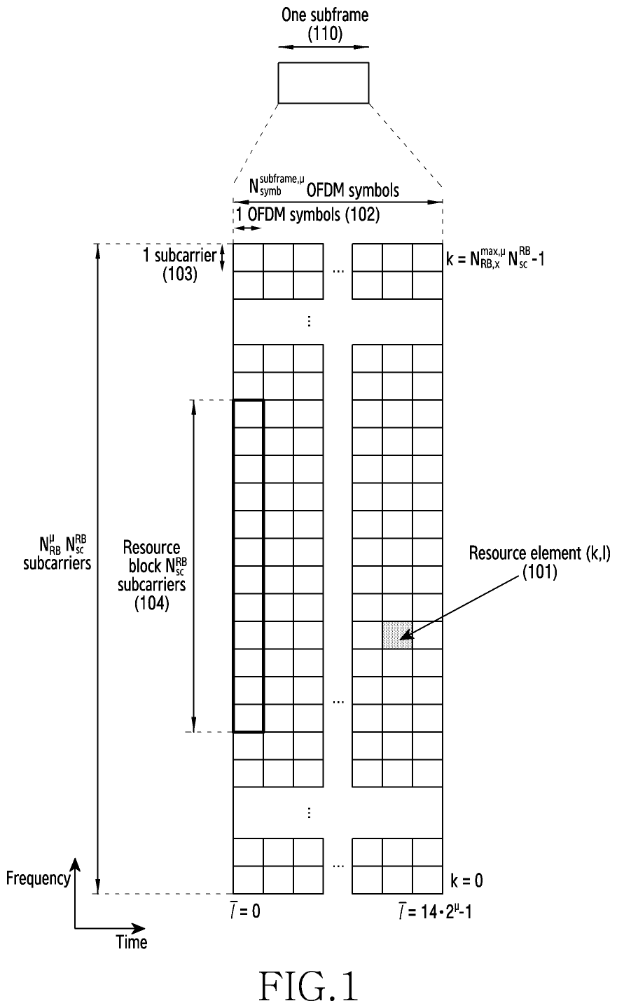

FIG. 1 illustrates a basic structure of a time-frequency domain, which is a radio resource domain used to transmit data or control channels, in a 5G system according to an embodiment.

Referring to FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

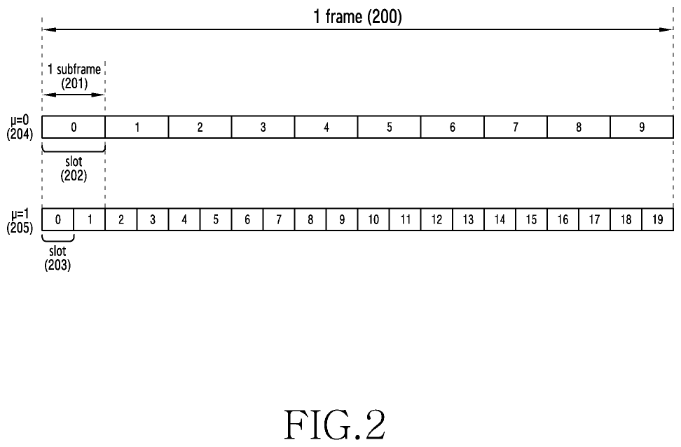

FIG. 2 illustrates a structure of a frame, a subframe, and a slot in a wireless communication system according to an embodiment.

Referring to FIG. 2, an example is provided of the structure of a frame 200, a subframe 201, and a slot 202. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot N_{symb}^{slot}=14). One subframe 201 may include one or multiple slots 202 and 203, and the number of slots 202 and 203 per one subframe 201 may vary depending on configuration values u for the subcarrier spacing 204 or 205. FIG. 2 illustrates when the subcarrier spacing configuration value is μ=0 (204), and when μ=1 (205). In the case of μ=0 (204), one subframe 201 may include one slot 202, and in the case of μ=1 (205), one subframe 201 may include two slots 203. That is, the number of slots per one subframe Nₛₗₒₜ^{sunframe,μ} may differ depending on the subcarrier spacing configuration value μ, and the number of slots per one frame Nₛₗₒₜ^{frame,μ} may differ accordingly. Nₛₗₒₜ^{sunframe,μ} and Nₛₗₒₜ^{frame,μ} may be defined according to each subcarrier spacing configuration u as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

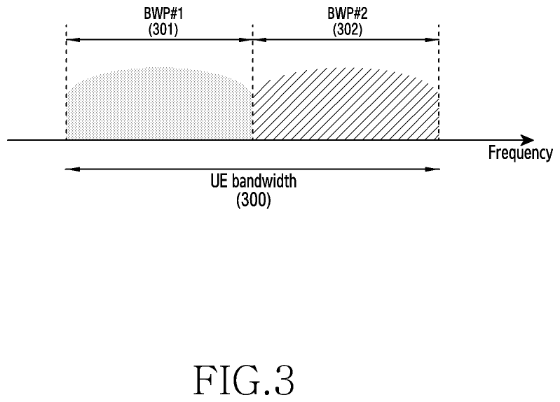

FIG. 3 illustrates an example of a BWP configuration in a wireless communication system according to an embodiment.

Referring to FIG. 3, an example is provided in which a UE bandwidth 300 is configured to include two BWPs, that is, BWP #1 301 and BWP #2 302. A base station may configure one or multiple BWPs for a UE, and may configure the following pieces of information in each BWP as given in Table 2 below.

TABLE 2

| | |
|---|---|
| BWP ::= | SEQUENCE { |
| bwp-Id | BWP-Id, |

(BWP identifier)

| | |
|---|---|
| locationAndBandwidth | INTEGER (1..65536), |

(BWP location)

| | |
|---|---|
| subcarrierSpacing | ENUMERATED {n0, n1, n2, n3, n4, |

```
    n5},
    (subcarrier spacing)
```

| | |
|---|---|
| cyclicPrefix | ENUMERATED { extended } |

(cyclic prefix)
}

The above example is non-limiting, and various parameters related to the BWP may be configured for the UE, in addition to the above configuration information. The base station may transfer the configuration information to the UE through upper layer signaling, for example, radio resource control (RRC) signaling. One configured BWP or at least one BWP among multiple configured BWPs may be activated. Whether to activate a configured BWP may be transferred from the base station to the UE semi-statically through RRC signaling, or dynamically through DCI.

According to an embodiment, before an RRC connection, an initial BWP for initial access may be configured for the UE by the base station through a master information block (MIB). More specifically, the UE may receive configuration information regarding a control resource set (CORESET) and a search space which may be used to transmit a physical downlink control channel (PDCCH) for receiving system information (which may correspond to remaining system information (RMSI) or system information block 1 (SIB1) necessary for initial access through the MIB in the initial access step. Each of the CORESET and the search space configured through the MIB may be considered identity (ID) 0. The base station may notify the UE of configuration information, such as frequency allocation information, time allocation information, and numerology, regarding CORESET #0 through the MIB. The base station may notify the UE of configuration information regarding the monitoring cycle and occasion in CORESET #0, that is, configuration information regarding search space #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

The BWP configuration may be used to support the case where the bandwidth supported by the UE is less than the system bandwidth. For example, the base station may configure the frequency location (configuration information 2) of the BWP for the UE, so that the UE can transmit/receive data at a specific frequency location within the system bandwidth.

In addition, the base station may configure multiple BWPs for the UE for the purpose of supporting different numerologies. For example, to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated. The base station may configure BWPs having different sizes of bandwidths for the UE for the purpose of reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. To reduce power consumed by the UE, the base station may configure a BWP of a relatively small bandwidth (for example, a BWP of 20 MHz) for the UE. The UE may perform a monitoring operation in the 20 MHz BWP in the absence of traffic and may transmit/receive data with the 100 MHz BWP as instructed by the base station if data has occurred.

In connection with the BWP configuring method, UEs, before being RRC-connected, may receive configuration information regarding the initial BWP through an MIB in the initial access step. To be more specific, a UE may have a CORESET configured for a downlink control channel which may be used to transmit DCI for scheduling a system information block (SIB) from the MIB of a physical broadcast channel (PBCH). The bandwidth of the CORESET configured by the MIB may be considered as the initial BWP, and the UE may receive, through the configured initial BWP, a physical downlink shared channel (PDSCH) through which an SIB is transmitted. The initial BWP may be used not only for receiving the SIB, but also for other system information (OSI), paging, random access, or the like.

### BWP Change

If a UE has one or more BWPs configured therefor, the base station may indicate, to the UE, to change (or switch or transition) the BWPs by using a BWP indicator field inside DCI. As an example, if the currently activated BWP of the UE is BWP #1 301 Referring to FIG. 3, the base station may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and thus, upon receiving a BWP change request, the UE needs to be able to receive or transmit the PDSCH or PUSCH scheduled by the corresponding DCI in the changed BWP with no problem. To this end, requirements for the delay time (T_{BWP}) required during a BWP change are specified in standards and, for example, may be defined as given in Table 3 below.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}Depends on UE capability.
Note 2:
If the BWP switch involves changing of SCS, the BWP switch delay is determined by the larger one between the SCS before BWP switch and the SCS after BWP switch.

The requirements for the BWP change delay time support type 1 or type 2, depending on the capability of the UE. The UE may report the supportable BWP delay time type to the base station.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the changed new BWP. If the base station wants to schedule a data channel by using the new BWP, the base station may determine time domain resource allocation regarding the data channel in consideration of the UE's BWP change delay time (T_{BWP}). For example, the base station may schedule the corresponding data channel after the BWP change delay time of the UE. Accordingly, the UE may not expect that the DCI that indicates a BWP change will indicate a slot offset (K0 or K2) value less than the BWP change delay time (T_{BWP}).

If the UE has received DCI (for example, DCI format 1_1 or 0_1) indicating a BWP change, the UE may not perform transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (for example, the last symbol of slot n+K−1).

### CA/DC

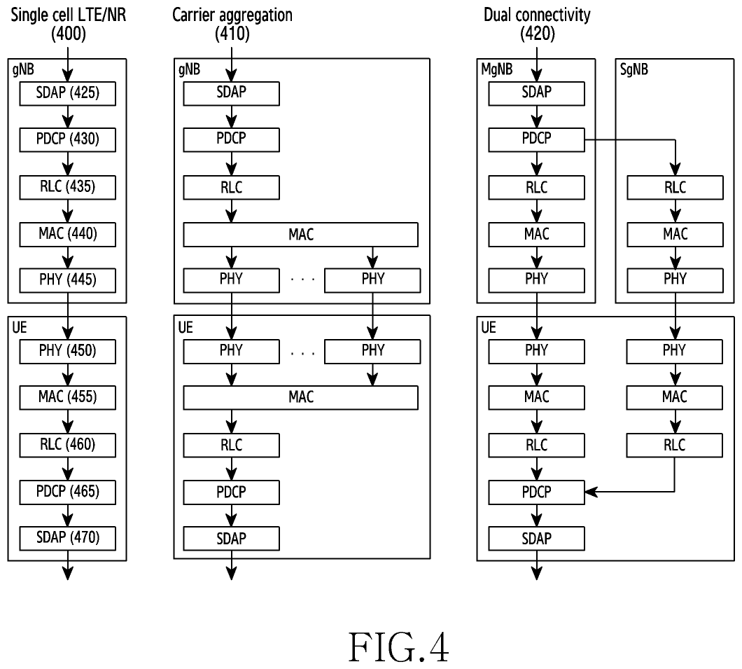

FIG. 4 illustrates radio protocol structures of a base station and a UE in single cell 400, CA 410, and DC 420 situations according to an embodiment.

Referring to FIG. 4, a radio protocol of a next-generation mobile communication system includes an NR service data adaptation protocol (SDAP) 425 or 470, an NR packet data convergence protocol (PDCP) 430 or 465, an NR radio link control (RLC) 435 or 460, and an NR medium access controls (MACs) 440 or 455, on each of UE and NR base station sides.

The main functions of the NR SDAP 425 or 470 may include transfer of user plane data, mapping between a quality of service (QOS) flow and a data radio bearer (DRB) for both DL and UL marking QoS flow ID in both DL and UL packets, and reflective QoS flow to DRB mapping for the UL SDAP protocol data units (PDUs).

As to the SDAP layer device, the UE may be configured, through an RRC message, whether to use the header of the SDAP layer device or whether to use functions of the SDAP layer device according to each PDCP layer device or according to each bearer or according to each logical channel. If an SDAP header is configured, the non-access stratum (NAS) QoS reflection configuration 1-bit indicator (NAS reflective QoS) of the SDAP header and the access stratum (AS) QOS reflection configuration 1-bit indicator (AS reflective QoS) thereof may be indicated by the base station, so that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 430 or 465 may include some of the following functions.
Header compression and decompression: Robust header compression (ROHC) only
Transfer of user data
In-sequence delivery of upper layer PDUs
Out-of-sequence delivery of upper layer PDUs
PDCP PDU reordering for reception
Duplicate detection of lower layer service data units (SDUs)
Retransmission of PDCP SDUs
Ciphering and deciphering
Timer-based SDU discard in uplink

The reordering of the NR PDCP device refers to reordering PDCP PDUs received from a lower layer in an order based on the PDCP SN and may include transferring data to an upper layer in the reordered sequence. Alternatively, the reordering of the NR PDCP device may include at least one of instantly transferring data without considering the order, recording PDCP PDUs lost as a result of reordering, reporting the state of the lost PDCP PDUs to the transmitting side, and requesting retransmission of the lost PDCP PDUs.

The main functions of the NR RLC 435 or 460 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The above-mentioned in-sequence delivery of the NR RLC device refers to successively delivering RLC SDUs received from the lower layer to the upper layer. The in-sequence delivery of the NR RLC device may include at least one of a function of, if one original RLC SDU is segmented into multiple RLC SDUs and the segmented RLC SDUs are received, reassembling the RLC SDUs and delivering the reassembled RLC SDUs, reordering the received RLC PDUs with reference to the RLC or PDCP SN, recording RLC PDUs lost as a result of reordering, reporting the state of the lost RLC PDUs to the transmitting side, and requesting retransmission of the lost RLC PDUs. The in-sequence delivery of the NR RLC device may include, if there is a lost RLC SDU, successively delivering only RLC SDUs before the lost RLC SDU to the upper layer, or may include, if a predetermined timer has expired although there is a lost RLC SDU, successively delivering all RLC SDUs received before the timer was started to the upper layer.

Alternatively, the in-sequence delivery of the NR RLC device may include, if a predetermined timer has expired although there is a lost RLC SDU, successively delivering all currently received RLC SDUs to the upper layer. The in-sequence delivery of the NR RLC device may include processing RLC PDUs in the received order (regardless of the sequence number order, in the order of arrival) and delivering the processed RLC PDUs to the PDCP device regardless of the order (out-of-sequence delivery), and may include, in the case of segments, receiving segments which are stored in a buffer or which are to be received later, reconfiguring the segments into one complete RLC PDU, processing, and delivering the segments to the PDCP device. NR RLC layer may include no concatenation function, which may be performed in the NR MAC layer or replaced with a multiplexing function of the NR MAC layer.

The out-of-sequence delivery of the NR RLC device refers to instantly delivering RLC SDUs received from the lower layer to the upper layer regardless of the order. The out-of-sequence delivery of the NR RLC device may include at least one of, if one original RLC SDU is segmented into multiple RLC SDUs and the segmented RLC SDUs are received, reassembling the RLC SDUs and delivering the reassembled RLC SDUs, and storing the RLC SN or PDCP SN of received RLC PDUs, and recording RLC PDUs lost as a result of reordering.

The NR MAC 440 or 455 may be connected to multiple NR RLC layer devices configured in one UE, and the main functions of the NR MAC may include some of the following functions.
Mapping between logical channels and transport channels
Multiplexing/demultiplexing of MAC SDUs
Scheduling information reporting
Error correction through hybrid automatic repeat request (HARQ)
Priority handling between logical channels of one UE
Priority handling between UEs by dynamic scheduling
MBMS service identification
Transport format selection
Padding

An NR PHY layer 445 or 450 may perform operations of channel-coding and modulating upper layer data, thereby obtaining OFDM symbols, and delivering the symbols through a radio channel, or demodulating OFDM symbols received through the radio channel, channel-decoding the same, and delivering the symbols to the upper layer.

The detailed structure of the radio protocol structure may vary according to the carrier (or cell) operating scheme. For example, in case that the base station transmits data to the UE, based on a single carrier (or cell), the base station and the UE may use a protocol structure having a single structure in each layer, such as 400. However, when the base station transmits data to the UE, based on CA which uses multiple carriers in a single TRP, the base station and the UE may use a protocol structure which has a single structure up to the RLC, but multiplexes the PHY layer through a MAC layer, such as 410. As another example, in case that the base station transmits data to the UE, based on DC which uses multiple carriers in multiple TRPs, the base station and the UE may use a protocol structure which has a single structure up to the RLC, but multiplexes the PHY layer through a MAC layer, such as 420.

### Unified TCI State

The unified TCI scheme may indicate that transmission/reception beam management schemes which have been divided into a TCI state scheme used for downlink reception by a UE and a spatial relation info scheme used for uplink transmission, in the legacy standards, are now integrated and managed according to the TCI state. Therefore, upon receiving an indication from the base station, based on the unified TCI scheme, the UE may perform beam management by using the TCI state in uplink transmission as well. If the base station has configured a TCI-State (higher layer signaling) having a tci-stateId-r17 (higher layer signaling) for the UE, the UE may perform an operation based on the unified TCI scheme by using the TCI-State. The TCI-State may exist in a joint TCI state or separate TCI state.

In the joint TCI state, the base station may indicate, to the UE, the TCI state to be applied for both uplink transmission and downlink reception through one TCI-State. If a joint TCI state-based TCI-State has been indicated to the UE, the UE may use the RS corresponding to qcl-Type1 in the joint TCI state-based TCI-State such that a parameter to be used for downlink channel estimation is indicated, and may use the RS corresponding to qcl-Type2 therein such that a parameter to be used as a downlink reception beam or reception filter is indicated. If a joint TCI state-based TCI-State has been indicated to the UE, the UE may use the RS corresponding to qcl-Type2 in the joint DL/UL TCI state-based TCI-State such that a parameter to be used as an uplink transmission beam or transmission filter is indicated. If a joint TCI state has been indicated to the UE, the UE may apply the same beam for both uplink transmission and downlink reception.

In the separate TCI state, the base station may individually indicate, to the UE, a UL TCI state to be applied for uplink transmission and a DL TCI state to be applied for downlink reception. If a UL TCI state has been indicated to the UE, the UE may use a reference RS or source RS configured in the UL TCI state such that a parameter to be used as an uplink transmission beam or transmission filter is indicated. If a DL TCI state has been indicated to the UE, the UE may use the RS corresponding to qcl-Type1 configured in the DL TCI state such that a parameter to be used for downlink channel estimation is indicated and may use the RS corresponding to qcl-Type2 therein such that a parameter to be used as a downlink reception beam or reception filter is indicated.

If both a DL TCI state and a UL TCI state have been indicated to the UE, the UE may use the reference RS or source RS configured in the UL TCI state such that a parameter to be used as an uplink transmission beam or transmission filter is indicated, may use the RS corresponding to qcl-Type1 configured in the DL TCI state such that a parameter to be used for downlink channel estimation is indicated, and may use the RS corresponding to qcl-Type2 therein such that a parameter to be used as a downlink reception beam or reception filter is indicated. If the reference RS or source RS configured in the DL TCI state and UL TCI state indicated to the UE is different, the UE may apply individual beams to uplink transmission and downlink reception, respectively, based on the indicated UL TCI state and DL TCI state.

The base station may configure a maximum of 128 joint TCI states for the UE through higher layer signaling in each specific BWP in a specific cell. A maximum of 64 or 128 DL TCI states, among separate TCI states, may be configured through higher layer signaling in each specific BWP in a specific cell, based on a UE capability report. DL TCI states among separate TCI states and joint TCI states may use the same higher layer signaling structure. As an example, if 128 joint TCI states are configured, and if 64 DL TCI states are configured among separate TCI states, the 64 DL TCI states may be included in the 128 joint TCI states.

A maximum or 32 or 64 UL TCI states, among separate TCI states, may be configured through higher layer signaling in each specific BWP in a specific cell, based on a UE capability report. Similarly to the relation between DL TCI states among separate TCI states and joint TCI states, UL TCI states among separate TCIs and joint TCI states may also use the same higher layer signaling structure. UL TCI states among separate TCIs may use a different higher layer signaling structure from joint TCI states and DL TCI states among separate TCI states.

As such, using different or identical higher layer signaling structures may be defined by specifications, or may be distinguished through different higher layer signaling configured by the base station, based on a UE capability report containing information regarding the use scheme which the UE may support among two types.

The UE may use one scheme among a joint TCI state and a separate TCI state configured by the base station such that a transmission/reception beam-related indication is received according to the unified TCI scheme. The base station may provide the UE with a configuration regarding whether one of the joint TCI state and separate TCI state is to be used, through higher layer signaling.

The UE may use one scheme selected from the joint TCI state and separate TCI state such that a transmission/reception beam-related indication is received through higher layer signaling. The base station may indicate a transmission/reception beam in two methods (a MAC-CE-based indication method and a MAC-CE-based activation and DCI-based indication method).

If a transmission/reception beam-related indication is provided to the UE through higher layer signaling by using a joint TCI state scheme, the UE may receive a MAC-CE indicating a joint TCI state from the base station and may perform a transmission/reception beam application operation, and the base station may schedule reception regarding a PDSCH including the MAC-CE for the UE through a PDCCH. If there is one joint TCI state including a MAC-CE, the UE may determine an uplink transmission beam or transmission filter and a downlink reception beam or reception filter by using a joint TCI state indicated after 3 ms since transmission of a PUCCH including HARQ-acknowledgement (ACK) information indicating whether a PDSCH including the MAC-CE is successfully received. If there are two or more joint TCI states including a MAC-CE, the UE may confirm that multiple joint TCI states indicated by the MAC-CE after 3 ms since transmission of a PUCCH including HARQ-ACK information indicating whether a PDSCH including the MAC-CE is successfully received correspond to respective codepoints of a TCI state field of DCI format 1_1 or 1_2, and may activate the indicated joint TCI state. The UE may then receive DCI format 1_1 or 1_2 and may apply one joint TCI state indicated by the TCI state field in the DCI to uplink transmission and downlink reception beams. In this regard, DCI format 1_1 or 1_2 may include downlink data channel scheduling information (with DL assignment) or may not include the downlink data channel scheduling information (without DL assignment).

If a transmission/reception beam-related indication is provided to the UE through higher layer signaling by using a separate TCI state scheme, the UE may receive a MAC-CE indicating a separate TCI state from the base station and may perform a transmission/reception beam application operation, and the base station may schedule reception regarding a PDSCH including the MAC-CE for the UE through a PDCCH. If there is one separate TCI state set including a MAC-CE, the UE may determine an uplink transmission beam or transmission filter and a downlink reception beam or reception filter by using separate TCI states included in a separate TCI state set indicated after 3 ms since transmission of a PUCCH including HARQ-ACK information indicating whether the PDSCH is successfully received. As used herein, a separate TCI state set may refer to a single or multiple separate TCI states which may have one codepoint of a TCI field in DCI format 1_1 or 1_2. One separate TCI state set may include one DL TCI state, may include one UL TCI state, or may include one DL TCI state and one UL TCI state.

If there are two or more separate TCI state sets including a MAC-CE, the UE may confirm that multiple separate TCI state sets indicated by the MAC-CE after 3 ms since transmission of a PUCCH including HARQ-ACK information indicating whether the PDSCH is successfully received corresponds to respective codepoints of a TCI state field of DCI format 1_1 or 1_2, and may activate the indicated joint TCI state set. Each codepoint of the TCI state field of DCI format 1_1 or 1_2 may indicate one DL TCI state, may indicate one UL TCI state, or may include one DL TCI state and one UL TCI state. The UE may receive DCI format 1_1 or 1_2 and may apply the separate TCI state set indicated by the TCI state field in the DCI to uplink transmission and downlink reception beams. In this regard, DCI format 1_1 or 1_2 may include downlink data channel scheduling information (with DL assignment) or may not include the downlink data channel scheduling information (without DL assignment).

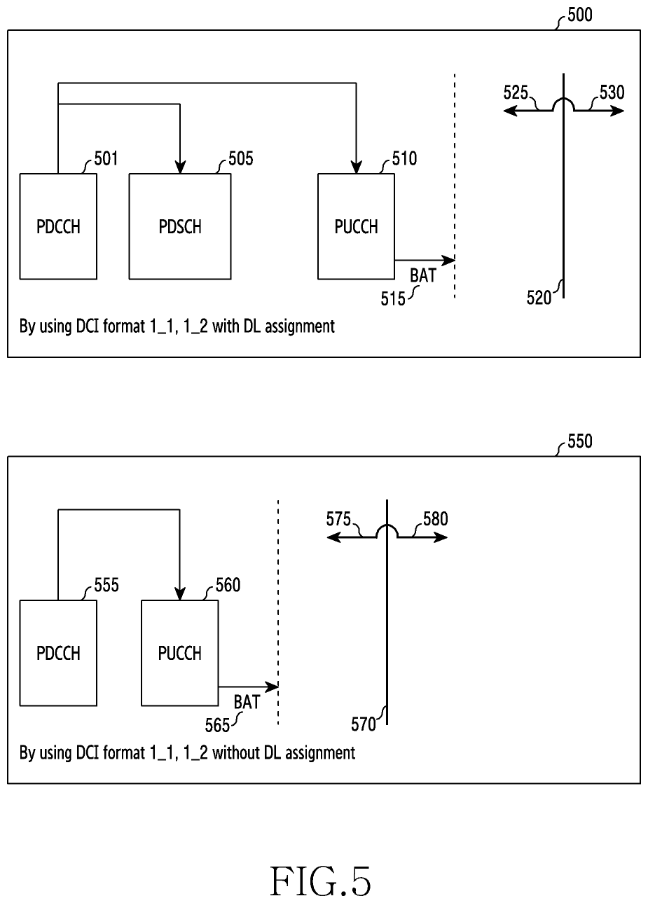

FIG. 5 illustrates a beam application time which may be considered when using an integrated TCI scheme in a wireless communication system according to an embodiment. Referring to FIG. 5, the UE may receive DCI format 1_1 or 1_2 including downlink data channel scheduling information (with DL assignment) including the downlink data channel scheduling information (without DL assignment) from the base station and may apply one joint TCI state or separate TCI state set indicated by the TCI state field in the DCI to uplink transmission and downlink reception beams.

DCI format 1_1 or 1_2 with DL assignment 500: if the UE receives DCI format 1_1 or 1_2_501 including downlink data channel scheduling information from the base station, and if the DCI format 1_1 or 1_2 indicates one joint TCI state or separate TCI state set based on a unified TCI scheme, the UE may receive a PDSCH 505 scheduled based on the received DCI and may transmit a PUCCH 510 including a HARQ-ACK indicating whether the DCI and PDSCH are successfully received. The HARQ-ACK may indicate whether both the DCI and PDSCH are successfully received. Upon failing to receive at least one of the DCI and PDSCH, the UE may transmit a NACK and, upon successfully receiving both, the UE may transmit a ACK.

DCI format 1_1 or 1_2 without DL assignment 550: if the UE receives DCI format 1_1 or 1_2_555 including no downlink data channel scheduling information from the base station, and if the DCI format 1_1 or 1_2 indicates one joint TCI state or separate TCI state set based on a unified TCI scheme, the UE may assume a combination of at least one of the following details to the DCI.

A CRC scrambled by using a CS-RNTI is included.

All bits assigned to all field used as a redundancy version (RV) field have a value of 1.

All bits assigned to all field used as a modulation and coding scheme (MCS) field have a value of 1.

All bits assigned to all field used as a new data indication (NDI) field have a value of 0.

In the case of frequency domain resource allocation (FDRA) type 0, all bits assigned to the FDRA field have a value of 0. In the case of FDRA type 1, all bits assigned to the FDRA field have a value of 1. If the FDRA scheme is dynamicSwitch, all bits assigned to the FDRA field have a value of 0.

The UE may transmit a PUCCH 560 including a HARQ-ACK indicating whether DCI format 1_1 or 1_2 including the above-described assumptions is received successfully.

In both DCI format 1_1 or 1_2 with DL assignment 500 and without DL assignment 550, if a new TCI state indicated through the DCI 501 or 555 is identical to the TCI state which has previously been indicated and applied to uplink transmission and downlink reception beams, the UE may maintain the previously applied TCI state and, if the new TCI state is different from the previously indicated TCI state, the UE may determine that the timepoint to apply a joint TCI state or separate TCI state set which may be indicated from the TCI state field included in the DCI is a timepoint 530 or 580 coming after the first slot 520 or 570 past a beam application time (BAT) 515 or 565 since PUCCH transmission, and may use the previously indicated TCI-state until 525 or 575 the slot 520 or 570.

In both DCI format 1_1 or 1_2 with DL assignment 500 and without DL assignment 550, a specific number of OFDM symbols may be configured as a BAT through higher layer signaling, based on UE capability report information, and the BAT and the numerology regarding the first slot after the BAT may be determined based on the smallest numerology among all cells to which the joint TCI state or separate TCI state set indicated through the DCI is applied.

The UE may apply one joint TCI state indicated through a MAC-CE or DCI to reception regarding CORESETs connected to all UE-specific search spaces, reception regarding a PDSCH scheduled by a PDCCH transmitted from a corresponding CORESET, transmission regarding a PUSCH, and transmission of all PUCCH resources.

If one separate TCI state set indicated through a MAC-CE or DCI includes one DL TCI state, the UE may apply the one separate TCI state set to reception regarding CORESETs connected to all UE-specific search spaces and reception regarding a PDSCH scheduled by a PDCCH transmitted from a corresponding CORESET, and may apply the one separate TCI state set to all PUSCH and PUCCH resources, based on the previously indicated UL TCI state.

If one separate TCI state set indicated through a MAC-CE or DCI includes one UL TCI state, the UE may apply the one separate TCI state set to all PUSCH and PUCCH resources, and may apply the one separate TCI state set to reception regarding CORESETs connected to all UE-specific search spaces and reception regarding a PDSCH scheduled by a PDCCH transmitted from a corresponding CORESET, based on the previously indicated DL TCI state.

If one separate TCI state set indicated through a MAC-CE or DCI includes one DL TCI state and one UL TCI state, the UE may apply the DL TCI state to reception regarding CORESETs connected to all UE-specific search spaces and reception regarding a PDSCH scheduled by a PDCCH transmitted from a corresponding CORESET, and may apply the UL TCI state to all PUSCH and PUCCH resources.

### Unified TCI State MAC-CE

The base station may schedule a PDSCH including the following MAC-CE for the UE, and the UE may then interpret each codepoint of the TCI state field in DCI format 1_1 or 1_2, based on information in the MAC-CE received from the base station, after three slots used to transmit a HARQ-ACK regarding the PDSCH to the base station. That is, the UE may activate each entry of the MAC-CE received from the base station in each codepoint of the TCI state field in DCI format 1_1 or 1_2.

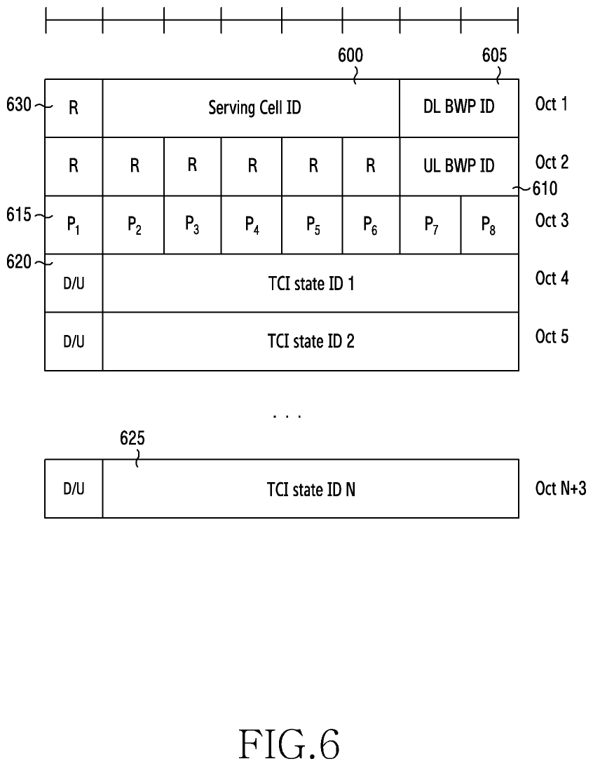

FIG. 6 illustrates another MAC-CE structure for joint TCI state or separate DL or UL TCI state activation and indication in a wireless communication system according to an embodiment. Each field in the MAC-CE structure may include the following indications.

Serving cell ID 600 may indicate to which serving cell the MAC-CE is to be applied. This field may have a length of five bits. If the serving cell indicated by this field is included in at least one of simultaneousU-TCI-UpdateList1, simultaneousU-TCI-UpdateList2, simultaneousU-TCI-UpdateList3, or simultaneousU-TCI-UpdateList4 (higher layer signaling), the MAC-CE may be applied to all serving cells included in at least one list among simultaneousU-TCI-UpdateList1, simultaneousU-TCI-UpdateList2, simultaneousU-TCI-UpdateList3, and simultaneousU-TCI-UpdateList4 in which the serving cell indicated by this field is included.

DL BWP ID 605 may indicate to which DL BWP the MAC-CE is to be applied, and each codepoint of this field may correspond to each codepoint of the BWP indicator in the DCI. This field may have a length of two bits.

UL BWP ID 610 may indicate to which UL BWP the MAC-CE is to be applied, and each codepoint of this field may correspond to each codepoint of the BWP indicator in the DCI. This field may have a length of two bits.

Pᵢ 615 may indicate whether each codepoint of the TCI state field in DCI format 1_1 or 1_2 is to have multiple TCI states or to have one TCI state. The value of Pᵢ, if 1, means that the corresponding i^{th} codepoint has multiple TCI states, and this may indicate that the corresponding codepoint may include a separate DL TCI state and a separate UL TCI state. The value of Pᵢ, if 0, means that the corresponding i^{th} codepoint has a single TCI state, and this may indicate that the corresponding codepoint may include one of a joint TCI state, a separate DL TCI state, or a separate UL TCI state.

D/U 620 may indicate whether the TCI state ID field in the same octet corresponds to a joint TCI state, a separate DL TCI state, or a separate UL TCI state. The value of this field, if 1, may indicate that the TCI state ID field in the same octet corresponds to a joint TCI state or a separate DL TCI state. The value of this field, if 0, may indicate that the TCI state ID field in the same octet corresponds to or a separate UL TCI state.

TCI state ID N 625 may indicate a TCI state which may be recognized by TCI-StateId (higher layer signaling). If the D/U field is configured to be 1, this field may be used to express TCI-StateId which may be expressed by seven bits. If the D/U field is configured to be 0, the most significant bit (MBS) of this field may be considered as a reserved bit, and the remaining six bits may be used to express UL-TCIState-Id (higher layer signaling). The number of TCI states which may be activated to the maximum may be 8 in the case of joint TCI states and may be 16 in separate DL or UL TCI states.

R 630 indicates a reserved bit and may be configured to be 0.

Referring to FIG. 6, as to the MAC-CE, the UE may include the third octet including fields P₁, P₂, . . . , P₈ in the MAC-CE structure regardless of whether unifiedTCI-StateType-r17 in MIMOparam-r17 in ServingCellConfig (higher layer signaling) is configured to be joint or separate. In such a case, the UE may perform TCI state activation by using a MAC-CE structure which is fixed regardless of higher layer signaling configured by the base station. As an example, in the above-described MAC-CE, the UE may omit the third octet including fields P₁, P₂, . . . , P₈ if unifiedTCI-StateType-r17 in MIMOparam-r17 in ServingCellConfig (higher layer signaling) is configured to be joint. In such a case, the UE may save the payload of the corresponding MAC-CE by a maximum of eight bits according to higher layer signaling configured by the base station. The D/U field positioned at the first bit, starting from the fourth octet, may all be considered as an R field, and the R fields may all be configured to be 0 bit.

### CSI Resource Configuration

NR has a CSI framework used by a base station to indicate a UE's CSI measurement and reporting. The CSI framework of NR may be configured by at least two elements including a resource setting and a report setting, and the report setting may refer to at least one ID of the resource setting to have a mutually connected relationship.

The resource setting may include information related to a reference signal (RS) for CSI measurement by the UE. The base station may configure at least one resource setting for the UE. As an example, the base station and the UE may exchange signaling information as in Table 4 below to transfer information regarding the resource setting.

TABLE 4
-- ASNISTART
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP- |

CSI-RS-ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI- |

SSB-ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resource Type | ENUMERATED { aperiodic, semiPersistent, |

periodic },
...
}
-- TAG-CSI-RESOURCECONFIG-STOP
-- ASNISTOP

In Table 4, signaling information CSI-ResourceConfig includes information regarding each resource setting. According to the above signaling information, each resource setting may include a resource setting index (csi-ResourceConfigId) or a BWP index (bwp-ID) or a resource's time axis transmission configuration (resourceType) or a resource set list (csi-RS-ResourceSetList) including at least one resource set. The resource's time axis transmission configuration may be configured to be aperiodic transmission or semi-persistent transmission or periodic transmission. The resource set list may be a set including resource sets for channel measurement, or a set including resource sets for interference measurement. If the resource set list is a set including resource sets for channel measurement, each resource set may include at least one resource, and this may be the index of a CSI-RS resource or synchronization/broadcast channel (SS/PBCH) block (SSB). If the resource set list is a set including resource sets for interference measurement, each resource set may include at least one interference measurement resource (CSI interference measurement (CSI-IM)).

As an example, if a resource set includes a CSI-RS, the base station and the UE may exchange signaling information as in Table 5 below to transfer information regarding the resource set.

TABLE 5
-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodic TriggeringOffset | INTEGER(0..6) |

OPTIONAL, -- Need S

| | |
|---|---|
| trs-Info | ENUMERATED {true} |

OPTIONAL, -- Need R
...
}
-- TAG-NZP-CSI-RS-RESOURCESET-STOP
-- ASNISTOP

In Table 5, signaling information NZP-CSI-RS-ResourceSet includes information regarding each resource set. According to the above signaling information, each resource set may at least include a resource set index (nzp-CSI-ResourceSetId) or information regarding an index set (nzp-CSI-RS-Resources) of an included CSI-RS, and may include a part of information (repetition) regarding a space domain transmission filter of an included CSI-RS resource or whether the included CSI-RS resource is used for tracking (trs-Info).

The CSI-RS may be the most representative reference signal included in a resource set. The base station and the UE may exchange signaling information as in Table 6 below to transfer information regarding the CSI-RS resource.

TABLE 6
-- ASNISTART
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, |
| db6} | OPTIONAL, -- Need R |
| scramblingID | ScramblingId, |
| periodicity AndOffset | CSI-ResourcePeriodicity AndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}
-- TAG-NZP-CSI-RS-RESOURCE-STOP
-- ASNISTOP

In Table 6, signaling information NZP-CSI-RS-Resource includes information regarding each CSI-RS. Information included in the signaling information NZP-CSI-RS-Resource is as follows.
nzp-CSI-RS-ResourceId: CSI-RS resource index
resourceMapping: CSI-RS resource's resource mapping information
powerControlOffset: the ratio between PDSCH energy per RE (EPRE) and CSI-RS EPRE
powerControlOffsetSS: the ratio between SS/PBCH block EPRE and CSI-RS EPRE
scramblingID: CSI-RS sequence's scrambling index
periodicityAndOffset: CSI-RS resource's transmission period and slot offset
qcl-InfoPeriodicCSI-RS: TCI-state information if the corresponding CSI-RS is a periodic CSI-RS

The resourceMapping included in the signaling information NZP-CSI-RS-Resource denotes resource mapping information of the CSI-RS resource, and may include frequency RE mapping, the number of ports, symbol mapping, a CDM type, the frequency resource density, and frequency band mapping information. The number of ports, frequency resource density, CDM type, and time-frequency axis RE mapping, which may be configured thereby, may have a value determined in one of the rows in Table 7 below

TABLE 7

| | Ports | Density | cdm- | | CDM group | | |
|---|---|---|---|---|---|---|---|
| Row | X | ρ | Type | (k, l) | index j | k′ | l′ |
| 1 | 1 | 3 | No CDM | (k₀, l₀), (k₀ + 4, l₀), (k₀ + 8, l₀) | 0, 0, 0 | 0 | 0 |
| 2 | 1 | 1, 0.5 | No CDM | (k₀, l₀) | 0 | 0 | 0 |
| 3 | 2 | 1, 0.5 | FD-CDM2 | (k₀, l₀) | 0 | 0, 1 | 0 |
| 4 | 4 | 1 | FD-CDM2 | (k₀, l₀) (k₀ + 2, l₀) | 0, 1 | 0, 1 | 0 |
| 5 | 4 | 1 | FD-CDM2 | (k₀, l₀), (k₀, l₀ + 1) | 0, 1 | 0, 1 | 0 |
| 6 | 8 | 1 | FD-CDM2 | (k₀, l₀), (k₁, l₀), (k₂, l₀), (k₃, l₀) | 0, 1, 2, 3 | 0, 1 | 0 |
| 7 | 8 | 1 | FD-CDM2 | (k₀, l₀) (k₁, l₀), (k₀, l₀ + 1), (k₁, l₀ + 1) | 0, 1, 2, 3 | 0, 1 | 0 |
| 8 | 8 | 1 | CDM4 | (k₀, l₀), (k₁, l₀) | 0, 1 | 0, 1 | 0, 1 |
| | | | (FD2, | | | | |
| | | | TD2) | | | | |
| 9 | 12 | 1 | FD- | (k₀, l₀), (k₁, l₀), (k₂, l₀), (k₃, l₀), (k₄, l₀), (k₅, l₀) | 0, 1, 2, 3, 4, 5 | 0, 1 | 0 |
| | | | CDM2 | | | | |
| 10 | 12 | 1 | CDM4 | (k₀, l₀), (k₁, l₀), (k₂, l₀) | 0, 1, 2 | 0, 1 | 0, 1 |
| | | | (FD2, | | | | |
| | | | TD2) | | | | |
| 11 | 16 | 1, 0.5 | FD-CDM2 | (k₀, l₀), (k₁, l₀) (k₂, l₀), (k₃, l₀) | 0, 1, 2, 3, 4, 5, | 0, 1 | 0 |
| | | | | (k₀, l₀ + 1), (k₁, l₀ + 1), (k₂, l₀ + 1), (k₃, l₀ + 1) | 6, 7 | | |
| 12 | 16 | 1, 0.5 | CDM4 | (k₀, l₀), (k₁, l₀), (k₂, l₀), (k₃, l₀) | 0, 1, 2, 3 | 0, 1 | 0, 1 |
| | | | (FD2, | | | | |
| | | | TD2) | | | | |
| 13 | 24 | 1, 0.5 | FD-CDM2 | (k₀, l₀) (k₁, l₀), (k₂, l₀), (k₀, l₀ + 1) (k₁, l₀ + 1), (k [symbol] | 0, 1, 2, 3, 4, 5 | 0, 1 | 0 |
| | | | | (k₀, l₁), (k₁, l₁), (k₂, l₁), (k0, l₁ + 1), (k₁, l₁ + 1), (k2, [symbol] | 6, 7, 8, 9, 10, 11 | | |
| 14 | 24 | 1, 0.5 | CDM4 | (k₀, l₀), (k₁, l₀), (k₂, l₀), (k₀, l₁), (k₁, l₁), (k₂, l₁) | 0, 1, 2, 3, 4, 5 | 0, 1 | 0, 1 |
| | | | (FD2, | | | | |
| | | | TD2) | | | | |
| 15 | 24 | 1, 0.5 | CDM8 | (k₀, l₀), (k₁, l₀), (k₂, l₀) | 0, 1, 2 | 0, 1 | 0, 1, |
| | | | (FD2, | | | | 2, 3 |
| | | | TD4 | | | | |
| 16 | 32 | 1, 0.5 | FD-CDM2 | (k₀, l₀), (k₁, l₀), (k₂, l₀), (k₃, l₀) | 0, 1, 2, 3, 4, 5, | 0, 1 | 0 |
| | | | | (k₀, l₀ + 1), (k₁, l₀ + 1), (k₂, l₀ + 1), (k₃, l₀ + 1), | 6, 7, 8, 9, 10, 11, | | |
| | | | | (k₀, l₁), (k₁, l₁), (k₂, l₁), (k₃, l₁) | 12, 13, 14, 15 | | |
| | | | | (k₀, l₁ + 1), (k₁, l₁ + 1), (k₂, l₁ + 1), (k₃, l₁ + 1) | | | |
| 17 | 32 | 1, 0.5 | CDM4 | (k₀, l₀) (k₁, l₀) (k₂, l₀) (k₃, l₀), (k₀, l₁), (k₁, l₁), ( [symbol] | 0, 1, 2, 3, 4, 5, | 0, 1 | 0, 1 |
| | | | (FD2, | | 6, 7 | | |
| | | | TD2) | | | | |
| 18 | 32 | 1, 0.5 | CDM8 | (k₀, l₀), (k₁, l₀).(k₂, l₀) (k₃, l₀) | 0, 1, 2, 3 | 0, 1 | 0, 1, |
| | | | (FD2, | | | | 2, 3 |
| | | | TD4) | | | | |

[symbol]

indicates data missing or illegible when filed

Table 7 enumerates a frequency resource density which can be configured according to the number (X) of CSI-RS ports, a CDM type, frequency-axis and time-axis start positions (k, l) of a CSI-RS component RE pattern, and the number (k′) of frequency-axis REs and the number (l′) of time-axis REs of the CSI-RS component RE pattern. The above-mentioned CSI-RS component RE pattern may be a basic unit constituting a CSI-RS resource. The CSI-RS component RE pattern may be configured by as many REs as YZ through as many frequency-axis REs as Y=1+max(k′) and as many time-axis REs as Z=1+max(l′). If the number of CSI-RS ports is 1, the CSI-RS RE position may be designated without restricting subcarriers in a physical resource block (PRB), and the CSI-RS RE position may be designated by a 12-bit bitmap. If the number of CSI-RS ports belongs to {2, 4, 8, 12, 16, 24, 32}, and if Y=2, the CSI-RS RE position may be designated for every two subcarriers in the PRB, and the CSI-RS RE position may be designated by a 6-bit bitmap. If the number of CSI-RS ports is 4, and if Y=4, the CSI-RS RE position may be designated for every four subcarriers in the PRB, and the CSI-RS RE position may be designated by a 3-bit bitmap. Similarly, the time-axis RE position may be designated by a bitmap having a total of 14 bits.

### CSI Report Configuration

Herein, a report setting may refer to at least one ID of a resource setting to have a mutually connected relationship, and the resource setting(s) having a connected relationship with the report setting provide configuration information including information regarding an RS for channel information measurement. If the resource setting(s) having a connected relationship with the report setting are used for channel information measurement, measured channel information may be used for a channel information report according to the reporting method configured by the report setting having a connected relationship.

Herein, a report setting may include configuration information related to a CSI reporting method. As an example, the base station and the UE may exchange signaling information as in Table 8 below to transfer information regarding the report setting.

TABLE 8
-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId |
| csi-IM-ResourcesForInterference | CSI-ResourceConfigId |

OPTIONAL, -- Need R

| | |
|---|---|
| nzp-CSI-RS-ResourcesForInterference | CSI-ResourceConfigId |

OPTIONAL, -- Need R

| | |
|---|---|
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
(1..maxNrofUL-Allocations)) OF INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, |
| n4} | OPTIONAL -- Need S |

},

| | |
|---|---|
| cri-R1-CQI | NULL, |
| cri-RSRP | NULL, |
| ssb-Index-RSRP | NULL, |
| cri-RI-LI-PMI-CQI | NULL, |

},

| | |
|---|---|
| reportFreqConfiguration | SEQUENCE { |
| cqi-FormatIndicator | ENUMERATED { |
| widebandCQI, subbandCQI } | OPTIONAL, -- |

Need R

| | |
|---|---|
| pmi-Formatindicator | ENUMERATED { |
| widebandPMI subbandPMI } | OPTIONAL, -- |

Need R

| | |
|---|---|
| csi-ReportingBand | CHOICE { |
| subbands3 | BIT |

STRING(SIZE(3)),

| | |
|---|---|
| subbands4 | BIT |

STRING(SIZE(4)),

| | |
|---|---|
| subbands5 | BIT |

STRING(SIZE(5)),

| | |
|---|---|
| subbands6 | BIT |

STRING(SIZE(6)),

| | |
|---|---|
| subbands7 | BIT |

STRING(SIZE(7)),

| | |
|---|---|
| subbands8 | BIT |

STRING(SIZE(8)),

| | |
|---|---|
| subbands9 | BIT |

STRING(SIZE(9)),

| | |
|---|---|
| subbands10 | BIT |

STRING(SIZE(10)),

| | |
|---|---|
| subbands11 | BIT |

STRING(SIZE(11)),

| | |
|---|---|
| subbands12 | BIT |

STRING(SIZE(12)),

| | |
|---|---|
| subbands13 | BIT |

STRING(SIZE(13)),

| | |
|---|---|
| subbands14 | BIT |

STRING(SIZE(14)),

| | |
|---|---|
| subbands15 | BIT |

STRING(SIZE(15)),

| | |
|---|---|
| subbands16 | BIT |

STRING(SIZE(16)),

| | |
|---|---|
| subbands17 | BIT |

STRING(SIZE(17)),

| | |
|---|---|
| subbands18 | BIT |

STRING(SIZE(18)),
...

| | |
|---|---|
| subbands19-v1530 | BIT |

```
STRING(SIZE(19)),
    } OPTIONAL -- Need S
  }
OPTIONAL, -- Need R
```

| | |
|---|---|
| timeRestrictionForChannelMeasurements | ENUMERATED |

{configured, notConfigured},

| | |
|---|---|
| timeRestrictionForInterferenceMeasurements | ENUMERATED |

{configured, notConfigured},

| | |
|---|---|
| codebookConfig | CodebookConfig |

OPTIONAL, -- Need R

| | |
|---|---|
| dummy | ENUMERATED |
| {n1, n2 } | OPTIONAL, -- Need |

R

| | |
|---|---|
| groupBasedBeamReporting | CHOICE { |
| enabled | NULL, |
| disabled | SEQUENCE { |
| nrofReportedRS | ENUMERATED {n1, |
| n2, n3, n4 } | OPTIONAL -- Need S |

```
    }
  },
```

| | |
|---|---|
| cqi-Table | ENUMERATED {table1, table2, table3, |
| spare 1 } | OPTIONAL, -- Need R |
| subbandSize | ENUMERATED { value1, value2 }, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

```
  }
OPTIONAL -- Need R
  ]]
}
```

In Table 8, signaling information CSI-ReportConfig includes information regarding each report setting. Information included in the signaling information CSI-ReportConfig may be as follows.
reportConfigId: report setting index
carrier: serving cell index
resourcesForChannelMeasurement: resource setting index for channel measurement having a connected relationship with the report setting
csi-IM-ResourcesForInterference: resource setting index having a CSI-IM resource for interference measurement having a connected relationship with the report setting
nzp-CSI-RS-ResourcesForInterference: resource setting index having a CSI-RS resource for interference measurement having a connected relationship with the report setting
reportConfigType: indicates a channel report's time-axis transmission configuration and transmission channel, and may have an aperiodic transmission or semi-persistent physical uplink control channel (PUCCH) transmission or semi-persistent physical uplink shared channel (PUSCH) transmission or periodic transmission configuration.
reportQuantity: indicates the type of reported channel information, and may have a channel information type (“cri-RI-PMI-CQI”, “cri-RI-i1”, “cri-RI-i1-CQI”, “cri-RI-CQI”, “cri-RSRP”, “ssb-Index-RSRP”, “cri-RI-LI-PMI-CQI”) when no channel report is transmitted (“none”) and when a channel report is transmitted. In this regard, the channel information type includes the following elements: a channel quality indicator (CQI), a precoding matric indicator (PMI), a CSI-RS resource indicator (CRI), an SS/PBCH block resource indicator (SSBRI), a layer indicator (LI), a rank indicator (RI), and/or reference signal received power (L1-RSRP).
reportFreqConfiguration: indicates whether reported channel information includes only information regarding the entire band (wideband) or includes information regarding each sub-band, and may have configuration information regarding a sub-band in which channel information is included if the reportFreqConfiguration includes information regarding each sub-band
timeRestrictionForChannelMeasurements: indicates whether there is a time-axis restriction in a reference signal for channel measurement among reference signals referenced by reported channel information
timeRestrictionForInterferenceMeasurements: indicates whether there is a time-axis restriction in a reference signal for interference measurement among reference signals referenced by reported channel information
codebookConfig: codebook information referenced by reported channel information
groupBasedBeamReporting: whether the channel report has beam grouping
cqi-Table: CQI table index referenced by reported channel information
subbandSize: index indicating the sub-band size of channel information
non-PMI-PortIndication: port mapping information referenced when reporting non-PMI channel information

If the base station indicates channel information reporting through higher layer signaling or L1 signaling, the UE may perform channel information reporting with reference to configuration information as above, included in the indicated report setting.

The base station may instruct the UE to report CSI through higher layer signaling including RRC signaling or MAC control element (CE) signaling, or L1 signaling (for example, common DCI, group-common DCI, UE-specific DCI).

For example, the base station may instruct the UE to provide an aperiodic CSI report through higher layer signaling or DCI which uses DCI format 0_1. The base station configures parameters for an aperiodic CSI report by the UE, or multiple CSI report trigger states including parameters for the CSI report, through higher layer signaling. The parameters for a CSI report or the CSI report trigger states may include a set including slot intervals between a PDCCH including DCI and a PUSCH including a CSI report, or possible slot intervals, a reference signal ID for channel state measurement, the type of included channel information, and the like. If the base station indicates some of the multiple CSI report trigger states to the UE through DCI, the UE reports channel information according to the CSI report configuration of the report setting configured according to the indicated CSI report trigger state. The channel information reporting may be performed through a PUSCH scheduled by DCI format 0_1. Time-axis resource assignment regarding the PUSCH, including the UE's CSI report, may be performed by indicating the slot interval with the PDCCH indicated through DCI, the start symbol in the slot for time-axis resource assignment regarding the PUSCH, the symbol length, and the like. For example, it is possible to indicate the position of a slot used to transmit a PUSCH, including the UE's CSI report, through the slot interval with the PDCCH indicated through DCI, and to indicate the start symbol in the slot and the symbol length through the time domain resource assignment field of DCI described above.

For example, the base station may indicate a semi-persistent CSI report transmitted by a PUSCH to the UE through DCI which uses DCI format 0_1. The base station may activate or deactivate a semi-persistent CSI report transmitted by a PUSCH through DCI scrambled by an SP-CSI-RNTI. If the semi-persistent CSI report is activated, the UE may periodically report channel information according to the configured slot interval. If the semi-persistent CSI report is deactivated, the UE may stop periodic channel information reporting which has been activated. The base station configures parameters for a semi-persistent CSI report by the UE, or multiple CSI report trigger states including parameters for the semi-persistent CSI report, through higher layer signaling. The parameters for a CSI report or the CSI report trigger states may include a set including slot intervals between a PDCCH including DCI which indicates the CSI report and a PUSCH including the CSI report, or possible slot intervals, the slot interval between the slot used to activate higher layer signaling which indicates the CSI report and the PUSCH including the CSI report, the slot interval period of the CSI report, the type of included channel information, and the like. If the base station activates some of the multiple CSI report trigger states or some of the multiple report settings to the UE through higher layer signaling or DCI, the UE may report channel information according to the CSI report configuration configured in the report setting included in the indicated CSI report trigger state or in the activated report setting. The channel information reporting may be performed through a PUSCH scheduled semi-persistently by DCI format 0_1 scrambled by an SP-CSI-RNTI. Time-axis resource assignment regarding the PUSCH, including the UE's CSI report, may be performed by indicating the slot interval period of the CSI report, the slot interval with the slot used to activate higher layer signaling or the slot interval with the PDCCH indicated through DCI, the start symbol in the slot for time-axis resource assignment regarding the PUSCH, the symbol length, and the like. For example, it is possible to indicate the position of a slot used to transmit a PUSCH, including the UE's CSI report, through the slot interval with the PDCCH indicated through DCI, and to indicate the start symbol in the slot and the symbol length through the time domain resource assignment field of DCI format 0_1 described above.

For example, the base station may indicate a semi-persistent CSI report transmitted by a PUCCH to the UE through higher layer signaling (for example, MAC-CE). The base station may activate or deactivate the semi-persistent CSI report transmitted by a PUCCH through the MAC-CE signaling. If the semi-persistent CSI report is activated, the UE may periodically report channel information according to a configured slot interval. If the semi-persistent CSI report is deactivated, the UE may stop the periodic channel information reporting which has been activated. The base station configures parameters for the semi-persistent CSI report by the UE through higher layer signaling. The parameters for the CSI report may include a PUCCH resource used to transmit the CSI report, the slot interval period of the CSI report, the type of included channel information, and the like. The UE may transmit the CSI report through a PUCCH. Alternatively, if the PUCCH for the CSI report overlaps the PUSCH, the CSI report may be transmitted by the PUSCH. It is possible to indicate the position of the PUCCH transmission slot in which the CSI report is included through the slot interval period of the CSI report configured through higher layer signaling, and the slot interval between the slot used to activate higher layer signaling and the PUCCH including the CSI report, and to indicate the start symbol in the slot and the symbol length through the start symbol to which the PUCCH resource configured through higher layer signaling is assigned, and the symbol length.

For example, the base station may indicate a periodic CSI report to the UE through higher layer signaling. The base station may activate or deactivate the periodic CSI report through higher layer signaling including RRC signaling. If the periodic CSI report is activated, the UE may periodically report channel information according to a configured slot interval. If the periodic CSI report is deactivated, the UE may stop the previously active periodic channel information reporting. The base station configures a report setting including parameters for the periodic CSI report by the UE through higher layer signaling. The parameters for the CSI report may include a PUCCH resource configuration for the CSI report, the slot interval between the slot used to activate higher layer signaling which indicates the CSI report and the PUCCH including the CSI report, the slot interval period of the CSI report, the reference signal ID for channel state measurement, the type of included channel information, and the like. The UE may transmit the CSI report through a PUCCH. Alternatively, if the PUCCH for the CSI report overlaps the PUSCH, the CSI report may be transmitted by the PUSCH. It is possible to indicate the position of the slot used to transmit the PUCCH including the CSI report through the slot interval period of the CSI report configured through higher layer signaling, and the slot interval between the slot used to activate higher layer signaling and the PUCCH including the CSI report, and to indicate the start symbol in the slot and the symbol length through the start symbol to which the PUCCH resource configured through higher layer signaling is assigned, and the symbol length.

In the above-described CSI report setting (CSI-ReportConfig), each report setting CSI-ReportConfig may be associated with a CSI resource setting associated with the corresponding report setting, and one downlink BWP identified by a higher layer parameter BWP identifier (bwp-id) given by the CSI-ResourceConfig. As a time-domain reporting operation regarding each report setting CSI-ReportConfig, an “aperiodic”, “semi-persistent”, or “periodic” scheme is supported, and this may be configured by the base station for the UE by using parameter reportConfigType configured from the higher layer. A semi-persistent CSI reporting method supports “PUCCH-based semi-persistent (semi-PersistentOnPUCCH)” or “PUSCH-based semi-persistent (semi-PersistentOnPUSCH)”. In the case of a periodic or semi-persistent CSI reporting method, the base station may configure a PUCCH or PUSCH resource to transmit CSI for the UE through higher layer signaling. The period and slot offset of the PUCCH or PUSCH resource to transmit CSI may be given as numerology of the uplink BWP configured to transmit a CSI report. In the case of an aperiodic CSI reporting method, the base station may schedule a PUSCH resource to transmit CSI for the UE through L1 signaling (above-described DCI format 0_1).

In the above-described CSI resource setting (CSI-ResourceConfig), each CSI resource setting CSI-ReportConfig may include S (≥1) CSI resource sets (given by higher layer parameter csi-RS-ResourceSetList). The CSI resource set list may include a non-zero power (NZP) CSI-RS-resource set and an SS/PBCH block set or may include a CSI-interference measurement (CSI-IM) resource set. Each CSI resource setting may be positioned on a downlink BWP identified by higher layer parameter bwp-id, and the CSI resource setting may be connected to a CSI report setting on the same DL BWP. The time-domain operation of a CRI-RS resource in a CSI resource setting may be configured to be one of “aperiodic”, “periodic”, or “semi-persistent” from higher layer parameter resourceType. In a periodic or semi-persistent CSI resource setting, the number of CSI-RS resource sets may be limited to S=1, and the configured period and slot offset may be given by numerology of the DL bandwidth identified by bwp-id. The base station may configure one or more CSI resource settings for channel or interference measurement through higher layer signaling for the UE, wherein the CSI resources may include CSI-IM resources for interference measurement, NZP CSI-IM resources for interference measurement, and NZP CSI-IM resources for channel measurement.

In CRI-RS resource sets associated with a resource setting having higher layer parameter resourceType configured to be “aperiodic”, “periodic”, or “semi-persistent”, a trigger state regarding a CSI report setting having reportType configured to be “aperiodic” and a resource setting regarding channel or interference measurement regarding one or multiple component cells (CCs) may be configured by higher layer parameter CSI-AperiodicTriggerStateList.

An aperiodic CSI report by the UE may use a PUSCH, a periodic CSI report may use a PUCCH, and a semi-persistent CSI report may be performed by using a PUSCH when the semi-persistent CSI report has been triggered or activated by DCI, or by using a PUCCH after the semi-persistent CSI report has been activated by a MAC control element (CE). As described above, a CSI resource setting may also be configured to be aperiodic, periodic, or semi-persistent. A combination between a CSI report setting and a CSI resource configuration may be supported based on Table 9 below.

TABLE 9
Table 5.2.1.4-1: Triggering/Activation of CSI Reporting
for the possible CSI-RS Configurations.

| | Periodic | | |
|---|---|---|---|
| CSI-RS | CSI | Semi-Persistent | Aperiodic |
| Configuration | Reporting | CSI Reporting | CSI Reporting |
| Periodic | No dynamic | For reporting on | Triggered by |
| CSI-RS | triggering/ | PUCCH, the UE | DCI; additionally, |
| | activation | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Semi-Persistent | Not | For reporting on | Triggered by |
| CSI-RS | Supported | PUCCH, the UE | DCI; additionally, |
| | | receives an | activation command |
| | | activation command | [10, TS 38.321] |
| | | [10, TS 38.321]; | possible as defined |
| | | for reporting on | in Subclause |
| | | PUSCH, the UE | 5.2.1.5.1. |
| | | receives triggering | |
| | | on DCI | |
| Aperiodic | Not | Not Supported | Triggered by |
| CSI-RS | Supported | | DCI; additionally, |
| | | | activation command |
| | | | [10, TS 38.321] |
| | | | possible as defined |
| | | | in Subclause |
| | | | 5.2.1.5.1. |

An aperiodic CSI report may be triggered by a “CSI request” field of above-described DCI format 0_1 corresponding to scheduling DCI regarding a PUSCH. The UE may monitor the PDCCH, may acquire DCI format 0_1, and may acquire PUSCH-related scheduling information and a CSI request indicator. The CSI request indicator may be configured by NTS (=0, 1, 2, 3, 4, 5, or 6) bits, and may be determined by higher layer signaling (reportTriggerSize). One trigger state among one or multiple aperiodic CSI report trigger states which may be configured by higher layer signaling (CSI-AperiodicTriggerStateList) may be triggered by the CSI request indicator.

If all bits of the CSI request field are 0, this may indicate that no CSI report is requested.

If the number (M) of CSI trigger states in configured CSI-AperiodicTriggerStateLite is greater than 2NTs−1, M CSI trigger states may be mapped to 2NTs−1 according to a predefined mapping relationship, and one of the trigger states of 2NTs−1 may be indicated by the CSI request field.

If the number (M) of CSI trigger states in configured CSI-AperiodicTriggerStateLite is less than or equal to 2NTs−1, one of M CSI trigger states may be indicated by the CSI request field.

Table 10 below illustrates an example of the relation between a CSI request indicator and a CSI trigger state which may be indicated by the indicator.

TABLE 10

| CSI request | | CSI- | CSI- |
|---|---|---|---|
| field | CSI trigger state | ReportConfigId | ResourceConfigId |
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may perform measurement in a CSI resource in a CSI trigger state triggered by the CSI request field, and may generate CSI therefrom (including at least one of CQI, PMI, CRI, SSBRI, LI, RI, L1-RSRP, or the like described above). The UE may transmit the acquired CSI by using a PUSCH scheduled by corresponding DCI format 0_1. If one bit corresponding to the uplink data indicator (UL-SCH indicator) in DCI format 0_1 indicates “1”, the uplink data (UL-SCH) and the acquired CSI may be multiplexed with the PUSCH resource scheduled by DCI format 0_1 and then transmitted. If one bit corresponding to the uplink data indicator (UL-SCH indicator) in DCI format 0_1 indicates “0”, only CSI may be mapped to the PUSCH resource scheduled by DCI format 0_1 without the uplink data (UL-SCH) and then transmitted.

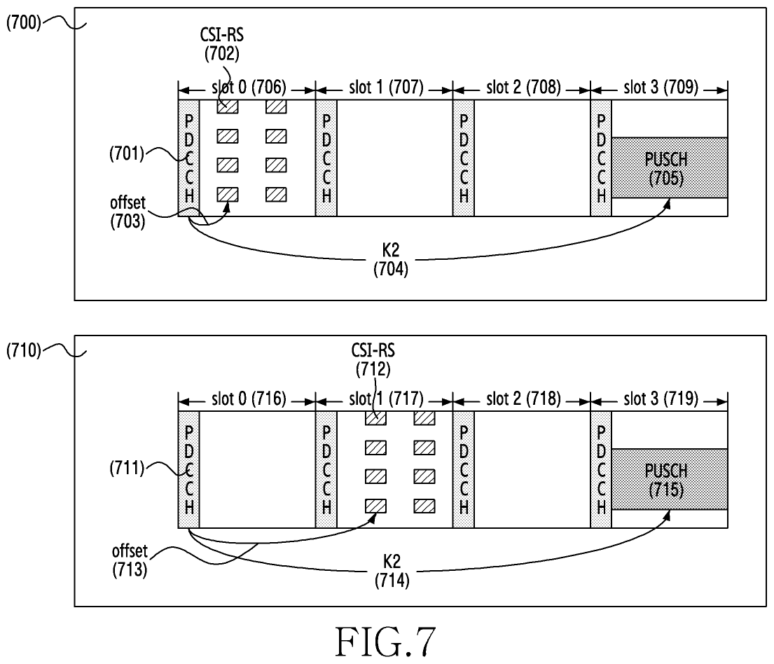

FIG. 7 illustrates one example of an aperiodic CSI reporting method according to an embodiment.

Referring to FIG. 7, in example 700, the UE may monitor the PDCCH 701 to acquire DCI format 0_1, and may acquire scheduling information regarding the PUSCH 705 and CSI request information therefrom. The UE may acquire resource information regarding the CSI-RS 702 which is to be measured from a received CSI request indicator. The UE may determine the CRI-RS 702 resource transmitted at which timepoint is to be measured, based on the timepoint at which DCI format 0_1 has been received and the offset-related parameter (above-described aperiodicTriggeringOffset) regarding in a CSI resource set configuration (for example, NZP CSI-RS resource set configuration (NZP-CSI-RS-ResourceSet)). To be more specific, the base station may configure the offset value X of parameter aperiodicTriggeringOffset in the NZP CSI-RS resource set configuration through higher layer signaling for the UE, and the configured offset value X may refer to the offset between the slot used to receive DCI which triggers an aperiodic CSI report and the slot used to transmit a CSI-RS resource. For example, the value of parameter aperiodicTriggeringOffset and the offset value X may have a mapping relationship given in Table 11 below.

TABLE 11

| aperiodicTriggeringOffset | Offset X |
|---|---|
| 0 | 0 slot |
| 1 | 1 slot |
| 2 | 2 slots |
| 3 | 3 slots |
| 4 | 4 slots |
| 5 | 16 slots |
| 6 | 24 slots |

In example 700 in FIG. 7, the above-described offset value is configured X=0. In this case, the UE may receive the CRI-RS 702 in the slot used to receive DCI format 0_1 which triggers an aperiodic CSI report (corresponding to slot 0 706, and may report CSI information measured by the received CRI-RS to the base station through the PUSCH 705. The UE may acquire scheduling information (pieces of information corresponding to respective fields of DCI format 0_1 described above) regarding the PUSCH 705 for a CSI report from DCI format 0_1. As an example, the UE may acquire information regarding the slot to transmit the PUSCH 705 from the above-described time-domain resource assignment information regarding the PUSCH 705. In example 700, the UE acquired 3 as the K2 value 704 corresponding to the PDCCH-to-PUSCH slot offset value, and the PUSCH 705 may accordingly be transmitted in slot 3 709 which is three slots spaced apart from the timepoint (slot 0 706) at which the PDCCH 701 has been received.

In example 710, the UE acquired 3 as the K2 value 714 corresponding to the PDCCH-to-PUSCH slot offset value, the UE may monitor the PDCCH 711 to acquire DCI format 0_1, and may acquire scheduling information regarding the PUSCH 715 and CSI request information therefrom. The UE may acquire resource information regarding the CSI-RS 712 which is to be measured from a received CSI request indicator. In example 710, the above-described offset value regarding a CSI-RS is configured X=1. In this case, the UE may receive the CRI-RS 712 in the slot used to receive DCI format 0_1 which triggers an aperiodic CSI report (corresponding to slot 0 716, and may report CSI information measured by the received CRI-RS to the base station through the PUSCH 715.

An aperiodic CSI report may include at least one of CSI part 1 and CSI part 2 or both, and the aperiodic CSI report, if transmitted through a PUSCH, may be multiplexed with a transport block. After a CRC is inserted into the input bit of aperiodic CSI for the sake of multiplexing, the CRC may undergo encoding and rate matching, may be mapped to the resource element in the PUSCH in a specific pattern, and may then be transmitted. The CRC insertion may be omitted depending on the coding method or the length of input bits. The number of modulation symbols calculated for rate matching during multiplexing of CSI part 1 or CSI part 2 included in the aperiodic CSI report may be calculated as in Table 12 below.

TABLE 12
For CSI part 1 transmission on PUSCH not using repetition type B with UL-SCH, the
number of coded modulation symbols per layer for CSI part 1 transmission, denoted as
Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} \}$
...
For CSI part 1 transmission on an actual repetition of a PUSCH with repetition Type B
with UL-SCH, the number of coded modulation symbols per layer for CSI part 1
transmission, denoted as Q_{CSI-part1}′, is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} ,$
${\sum }_{l = 0}^{{N}_{symb , actual}^{PUSCH} - 1} {M}_{sc , nominal}^{UCI} ( l ) - {Q}_{ACK / CG - UCI}^{′} \}$
...
For CSI part 1 transmission on PUSCH without UL-SCH, the number of coded modulation
symbols per layer for CSI part 1 transmission, denoted as Q_{CSI-part1}′, is determined as
follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ ,$
${\sum }_{l = 0}^{{N}_{symb , all}^{PUSCH} - 1} {M}_{SC}^{UCI} ( l ) - {Q}_{ACK}^{′} \}$
else
${Q}_{CSI - 1}^{′} = {\sum }_{l = 0}^{{N}_{symb , all}^{PUSCH} - 1} {M}_{SC}^{UCI} ( l ) - {Q}_{ACK}^{′}$
end if
...
For CSI part 2 transmission on PUSCH not using repetition type B with UL-SCH, the
number of coded modulation symbols per layer for CSI part 2 transmission, denoted as
Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B
with UL-SCH, the number of coded modulation symbols per layer for CSI part 2
transmission, denoted as Q_{CSI-part2}′, is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ ,$
$⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} ,$
${\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
For CSI part 2 transmission on PUSCH without UL-SCH, the number of coded modulation
symbols per layer for CSI part 2 transmission, denoted as Q_{CSI-part2}′, is determined as
follows:
${Q}_{CSI - 2}^{′} = {\sum }_{l = 0}^{{N}_{symb , all}^{PUSCH} - 1} {M}_{SC}^{UCI} ( l ) - {Q}_{ACK}^{′} - {Q}_{CSI - 1}^{′}$

Particularly, in the case of PUSCH repetitive transmission types A and B, the UE may multiplex an aperiodic CSI report only with the first repetitive transmission among PUSCH repetitive transmissions and then transmit the report, since multiplexed aperiodic CSI report information is encoded in a polar code type, and respective PUSCH repetitions need to have the same frequency and time resource assignment for the CSI report information to be multiplexed with multiple PUSCH repetitions. Particularly, in the case of PUSCH repetitive transmission type B, respective actual repetitions may have different OFDM symbol lengths, and the aperiodic CSI report may thus be multiplexed with the first PUSCH repetition only and then transmitted.

In PUSCH repetitive transmission type B, if the UE receives DCI which schedules an aperiodic CSI report or activates a semi-persistent CSI report without transport block-related scheduling, the value of nominal repetition may be assumed to be 1 even if the number of PUSCH repetitive transmission configured through higher layer signaling is greater than 1. In addition, if the UE has scheduled or activated an aperiodic or semi-persistent CSI report without transport block-related scheduling, based on PUSCH repetitive transmission type B, the UE may expect that the first nominal repetition will be identical to the first actual repetition. In the PUSCH transmitted while including semi-persistent CSI, based on PUSCH repetitive transmission type B, without DCI-related scheduling after a semi-persistent CSI report has been activated by DCI, if the first nominal repetition is different from the first actual repetition, transmission regarding the first nominal repetition may be disregarded.

### CSI Computation Time

Assuming that the base station will indicate an aperiodic CSI report or a semi-persistent CSI report to the UE through DCI, the UE may determine whether valid channel reporting can be performed through the indicated CSI report in consideration of the channel computation time (CSI computation time) necessary for the CSI report. In the aperiodic CSI report or semi-persistent CSI report indicated through DCI, the UE may perform a valid CSI report from the uplink symbol after symbol Z since the last symbol included in the PDCCH including the DCI which indicates the CSI report is ended. The above-mentioned symbol Z may vary depending on the numerology of the downlink BWP corresponding to the PDCCH including DCI which indicates the CSI report, the numerology of the uplink BWP corresponding to the PUSCH used to transmit the CSI report, and the type or characteristics (report quantity, frequency band granularity, the number of ports of the reference number, the codebook type, and the like) of channel information reported in the CSI report. In other words, in order for a specific CSI report to be deemed to be a valid CSI report (in order for the CSI report to be a valid CSI report), uplink transmission of the CSI report is not to be performed prior to symbol Zref by including timing advance. In this regard, symbol Zref refers to an uplink symbol which starts a cyclic prefix (CP) after time T_{proc,CSI}=(Z)(2048+144)·κ2^{-μ}·T_{C} since the moment the last symbol of the triggering PDCCH is ended. The detailed value of Z follows the description below, T_{c}=1/(Δfₘₐₓ·N_{f}), Δfₘₐₓ=480·10² Hz, N_{f}=4096, κ=64 and μ is numerology. In this regard, μ may be promised to use one which causes the largest T_{proc,CSI} value among (μ_{PDCCH}, μ_{CSI-RS}, μ_{UL}), μ_{PDCCH} may denote a subcarrier spacing used for PDCCH transmission, μ_{CSI-RX} may denote a subcarrier spacing used for CSI-RS transmission, and μ_{UL} may denote a subcarrier spacing of an uplink channel used for uplink control information (UCI) transmission for CSI reporting. As another example, μ may also be promised to use one which causes the largest T_{proc,CSI} value among (μ_{PDCCH}, μ_{UL}). The above description will be referenced for definition of μ_{PDCCH} and μ_{UL}. For convenience, it will be assumed that, if the above condition is satisfied, CSI reporting validity condition 1 is satisfied.

In addition, if the reference signal for channel measurement regarding the aperiodic CSI report indicated to the UE through DCI is an aperiodic reference signal, a valid CSI report may be performed from an uplink symbol after symbol Z′ since the last symbol including the reference signal is ended. The above-mentioned symbol Z′ may vary depending on the numerology of the downlink BWP corresponding to the PDCCH including DCI which indicates the CSI report, the numerology of the bandwidth corresponding to the reference signal for channel measurement regarding the CSI report, the numerology of the uplink BWP corresponding to the PUSCH used to transmit the CSI report, and the type or characteristics (report quantity, frequency band granularity, the number of ports of the reference number, the codebook type, and the like) of channel information reported in the CSI report. In other words, in order for a specific CSI report to be deemed to be a valid CSI report (in order for the CSI report to be a valid CSI report), uplink transmission of the CSI report is not to be performed prior to symbol Zref by including timing advance. In this regard, symbol Zref′ refers to an uplink symbol which starts a CP after time since the T_{proc,CSI}′=(Z′)(2048+144)·κ2^{-μ}·T_{c} since the moment the last symbol of the aperiodic CSI-RS or aperiodic CSI-IM triggered by the triggering PDCCH is ended. The detailed value of Z′ follows the description below, T_{c}=1/(Δfₘₐₓ·N_{f}), Δfₘₐₓ=480·10² Hz, N_{f}=4096, κ=64, and μ is numerology. In this regard, μ may be promised to use one which causes the largest T_{proc,CSI} value among (μ_{PDCCH}, μ_{CSI-RS}, μ_{UL}), μ_{PDCCH} may denote a subcarrier spacing used for PDCCH transmission, μ_{CSI-RS} may denote a subcarrier spacing used for CSI-RS transmission, and μ_{UL} may denote a subcarrier spacing of an uplink channel used for UCI transmission for CSI reporting. As another example, μ may be promised to use one which causes the largest T_{proc,CSI} value among (μ_{PDCCH}, μ_{UL}). The above description will be referenced for definition of μ_{PDCCH} and μ_{UL}. For convenience, it will be assumed that, if the above condition is satisfied, CSI reporting validity condition 2 is satisfied.

If the base station indicates an aperiodic CSI report regarding an aperiodic reference signal to the UE through DCI, the UE may perform a valid CSI report from the first uplink symbol satisfying both a timepoint after symbol Z since the last symbol included in the PDCCH including the DCI which indicates the CSI report is ended and a timepoint after symbol Z′ since the last symbol including the reference signal is ended. That is, aperiodic CSI reporting based on an aperiodic reference signal is deemed to be a valid CSI report only if the aperiodic CSI reporting satisfies both CSI reporting validity conditions 1 and 2.

If a CSI report timepoint indicated by the base station fails to satisfy the CSI computation time requirement, the UE may determine that the corresponding CSI report is invalid and may not consider updating the channel information state for the CSI report.

The above-described symbols Z and Z′ for CSI computation time calculation follow Table 13 and Table 14 below. For example, if channel information reported in a CSI report includes wideband information only, if the number of ports of the reference signal is 4 or less, if there is one reference signal resource, and if the codebook type is “typeI-SinglePanel”, or if the type (report quantity) of reported channel information is “cri-RI-CQI”, symbols Z and Z′ follow Z₁, Z₁′ values in Table 14. This will hereinafter be referred to as delay requirement 2. Furthermore, if a PUSCH including a CSI report includes no TB or HARQ-ACK, and if the UE's CPU occupation is 0, symbols Z and Z′ follow Z₁, Z₁′ values in Table 13, and this will hereinafter be referred to as delay requirement 1. The above-mentioned CPU occupation is described below in detail. In addition, if the report quantity is “cri-RSRP” or “ssb-Index-RSRP”, symbols Z and Z′ follow Z₃, Z₃′ values in Table 14, where X1, X2, X3, and X4 refer to UE capability regarding the beam reporting time, and KB1 and KB2 refer to UE capability regarding the beam changing time. Symbols Z and Z′ follow Z. Z values in Table 14 if the symbols Z and Z′ do not correspond to the type or characteristics of channel information reported in the CSI report described above.

TABLE 13

Z₁ [symbols]

| μ | Z₁ | Z′₁ |
|---|---|---|
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₁ |
| 1 | 33 | 30 | 72 | 69 | 33 | X₂ |
| 2 | 44 | 42 | 141 | 140 | min(44, X₃ + KB₁) | X₃ |
| 3 | 97 | 85 | 152 | 140 | min(97, X₄ + KB₂) | X₄ |

### CSI Reference Resource

When indicating an aperiodic/semi-persistent/periodic CSI report to the UE, the base station may configure a CSI reference resource to determine the reference time and frequency regarding the channel to be reported in the CSI report. The frequency of the CSI reference resource may be information regarding the carrier and sub-band to measure CSI, indicated in the CSI report configuration, and this may correspond to each of the carrier and reportFreqConfiguration in CSI-ReportConfig (higher layer signaling). The time of the CSI reference resource may be defined as a time reference used to transmit the CSI report. For example, if CSI report #X is indicated to be transmitted in uplink slot n′ of a carrier and a BWP to be used to transmit the CSI report, the time of the CSI reference resource of CSI report #X may be defined as downlink slot n-nCSI-ref of a carrier and a BWP to be used to measure CSI. Downlink slot n is calculated as n=└n′·2^{μ}^{_{DL}}/2^{μ}^{_{UL}}┘ assuming that the numerology of a carrier and a BWP to be used to measure CSI is μDL, and the numerology of a carrier and a BWP to be used to transmit CSI report #X is μUL. If CSI report #X transmitted in uplink slot n′ is a semi-persistent or periodic CSI report, the interval (nCSI-ref) between downlink slot n and the slot of the CSI reference signal follows n_{CSI-ref}=4·2^{μ}^{_{DL}} if a single CSI-RS/SSB resource is connected to the CSI report according to the number of CSI-RS/SSB resources for channel measurement, and follows N_{CSI-ref}=5·2^{μ}^{_{DL}} if multiple CSI-RS/SSB resources are connected to the CSI report. If CSI report #X transmitted in uplink slot n′ is an aperiodic CSI report, the calculation is n_{CSI-ref}=└Z′/N_{symb}^{slot}┘ in consideration of CSI computation time Z′ for channel measurement. N_{symb}^{slot} refers to the number of symbols included in one slot, and N_{symb}^{slot}=14 is assumed in NR.

If the base station instructs the UE to transmit a CSI report in uplink slot n′ through higher layer signaling or DCI, the UE may report CSI by performing channel measurement or interference measurement in a CSI-RS resource, a CSI-IM resource, or an SSB resource transmitted not later than the CSI reference resource slot of the CSI report transmitted in uplink slot n′ among CSI-RS resources or CSI-IM or SSB resources associated with the corresponding CSI report. As used herein, a CSI-RS resource, a CSI-IM resource, or an SSB resource associated with the corresponding CSI report may refer to a CSI-RS resource, a CSI-IM resource, or an SSB resource included in a resource set configured in a resource setting referenced by a report setting for a CSI report by the UE configured through higher layer signaling, or a CSI-RS resource, a CSI-IM resource, or an SSB resource referenced by a CSI report trigger state including a parameter for the corresponding CSI report, or a CSI-RS resource, a CSI-IM resource, or an SSB resource indicated by the ID of the RS set.

Herein, a CSI-RS/CSI-IM/SSB occasion refers to a transmission timepoint of CSI-RS/CSI-IM/SSB resource(s) determined by a higher layer configuration or a combination of a higher layer configuration and DCI triggering. As an example, in the case of a semi-persistent or periodic CSI-RS resource, the slot to transmit the resource is determined by a slot period and a slot offset configured by higher layer signaling, and transmission symbol(s) in the slot are determined according to resource mapping information (resourceMapping). As another example, in the case of an aperiodic CSI-RS resource, the slot to transmit the resource is determined by a slot offset with a PDCCH including DCI which indicates a channel report configured by higher layer signaling, and transmission symbol(s) in the slot are determined according to resource mapping information (resourceMapping).

The above-described CSI-RS occasion may be determined by independently considering the transmission timepoint of each CSI-RS resource or by comprehensively considering the transmission timepoint of one or more CSI-RS resource(s) included in a resource set, and the following two types of interpretation are accordingly possible in a CSI-RS occasion following each resource set configuration.

Interpretation 1: from the starting timepoint of the earliest symbol used to transmit one specific resource, among one or more CSI-RS resources included in resource set(s) configured in a resource setting referenced by a report setting configured for a CSI report, to the ending timepoint of the latest symbol.

Interpretation 2: from the starting timepoint of the earliest symbol used to transmit a CRI-RS resource which is transmitted at the earliest timepoint, among all CSI-RS resources included in resource set(s) configured in a resource setting referenced by a report setting configured for a CSI report, to the ending timepoint of the latest symbol used to transmit a CRI-RS resource which is transmitted at the latest timepoint.

The two interpretations regarding a CSI-RS occasion may be considered both and applied individually. of the two interpretations may both be considered in a CSI-IM occasion and an SSB occasion, as in the case of the CSI-RS occasion, but the principle thereof is similar to the above description, and repeated descriptions thereof will be omitted herein.

Herein, “a CSI-RS/CSI-IM/SSB occasion for CSI report #X transmitted in uplink slot” refers to a set of a CSI-RS occasion, a CSI-IM occasion, and an SSB occasion which are not later than the CSI reference resource of CSI report #X transmitted in uplink slot n′ among a CSI-RS occasion, a CSI-IM occasion, and an SSB occasion of a CSI-RS resource, a CSI-IM resource, and an SSB resource included in a resource set configured in a resource setting referenced by a report setting configured for CSI report #X.

The following two types of interpretation are possible in “the latest CSI-RS/CSI-IM/SSB occasion among CSI-RS/CSI-IM/SSB occasions for CSI report #X transmitted in uplink slot n′”.

Interpretation 3: a set of occasions including the latest CSI-RS occasion among CSI-RS occasions for CSI report #X transmitted in uplink slot n′, the latest CSI-IM occasion among CSI-RS occasions for CSI report #X transmitted in uplink slot n′, and the latest SSB occasion among SSB occasions for CSI report #0 transmitted in uplink slot n′

Interpretation 4: the latest occasion among all CSI-RS occasions, CSI-IM occasions, and SSB occasions for CSI report #X transmitted in uplink slot n′

Interpretations 3 and 4 regarding “the latest CSI-RS/CSI-IM/SSB occasion among CSI-RS/CSI-IM/SSB occasions for CSI report #X transmitted in uplink slot n′” may be considered both and applied individually. In view of interpretations 1-1 and interpretation 2) in a CSI-RS occasion, a CSI-IM occasion, and an SSB occasion, four different types of interpretation regarding “the latest CSI-RS/CSI-IM/SSB occasion among CSI-RS/CSI-IM/SSB occasions for CSI report #X transmitted in uplink slot n′” may be considered all and applied individually, such as applying interpretation 1 and interpretation 3, applying interpretation 1 and interpretation 4, applying interpretation 2 and interpretation 3, and applying interpretation 2 and interpretation 4.

The base station may indicate a CSI report in consideration of the amount of channel information which the UE can calculate simultaneously for the CSI report, that is, the number of channel information calculation units (CSI processing units (CPU)) of the UE. Assuming that the number of channel information calculation units which the UE can calculate simultaneously is N_{CPU}, the UE may not expect the base station's CSI report indication which requires more channel information calculation than N_{CPU}, or may not consider update of channel information which requires more channel information calculation than N_{CPU}. The UE may report N_{CPU} to the base station through higher layer signaling, or the base station may configure N_{CPU} through higher layer signaling.

It is assumed that the CSI report indicated to the UE by the base station occupies some or all CPUs for channel information calculation, among the entire number N_{CPU} of channel information calculation units which the UE can calculate simultaneously. Assuming that, in each CSI report, the number of channel information calculation units necessary for CSI report n (n=0, 1, . . . , N−1), for example, is O_{CPU}⁽ⁿ⁾, the number of channel information calculation units necessary for a total of N CSI reports may be Σₙ₌₀^{N-1}O_{CPU}⁽ⁿ⁾. Channel information calculation units necessary for each reportQuantity configured in a CSI report may be configured as in Table 15 below.

TABLE 15
- o_{CPU}⁽ⁿ⁾=0: when reportQuantity configured in a CSI report is configured to be “none”,
and trs-info is configured in a CSI-RS resource set connected to the CSI report
- o_{CPU}⁽ⁿ⁾=1: when reportQuantity configured in a CSI report is configured to be “none”,
“cri-RSRP”, or “ssb-Index-RSRP”, and trs-info is not configured in a CSI-RS resource
set connected to the CSI report
- when reportQuantity configured in a CSI report is configured to be “cri-RI-PMI-
CQI”, “cri-RI-i1”, “cri-RI-i1-CQI”, “cri-RI-CQI”, or “cri-RI-LI-PMI-CQI”
>> o_{CPU}⁽ⁿ⁾=N_{CPU}: when an aperiodic CSI report is triggered, and the CSI report is not
multiplexed with one or both of TB/HARQ-ACK. When the CSI report is sideband
CSI, corresponds to a maximum of 4 CRI-RS ports, and corresponds to a single
resource without a CRI report, codebookType corresponds to “type1-SinglePanel”, or
reportQuantity corresponds to “cri-RI-CQI”
(The above case corresponds to the above-described delay requirement 1, and may be
considered to be when the UE quickly calculates CSI by using all available CPUs and
then reports)
>> o_{CPU}⁽ⁿ⁾=K_{S}: all remaining cases other than above cases. K_{S} refers to the number of
CSI-RS resources in a CSI-RS resource set for channel measurement

If the number of channel information calculation units needed by the UE for multiple CSI reports is greater than the number N_{CPU} of channel information calculation units which the UE can calculate simultaneously the UE may not consider update of channel information for some CSI reports. Among multiple indicated CSI reports, a CSI report for which channel information update will not be considered is determined in consideration of the time for which channel information calculation at least necessary for the CSI report occupies CPUs and the priority of reported channel information. For example, channel information update may not be considered in a CSI report if the time for which channel information calculation for the CSI report occupies CPUs starts at the latest timepoint, and it is possible to consider no channel information update preferentially in a CSI report having a low priority of channel information.

The priority of channel information may be determined with reference to Table 16 below.

TABLE 16
CSI priority value Pri_{iCSI}(y,k,c,s)=2·N_{cells}·Mₛ·y+ N_{cells}· Mₛ·k+ Mₛ·c+s,
- y=0 in the case of an aperiodic CSI report transmitted through a PUSCH, y=1 in the
case of a semi-persistent CSI report transmitted through a PUSCH, y=2 in the case of
a semi-persistent CSI report transmitted through a PUCCH, y=3 in the case of a periodic
CSI report transmitted through a PUCCH;
- k=0 if a CSI report includes L1-RSRP, k=1 if a CSI report includes no L1-RSRP
- c: serving cell index, N_{cell}: maximum number of serving cells configured through
higher layer signaling (maxNrofServingCells);
- s: CSI report configuration index (reportConfigID), Mₛ: maximum number of CSI
report configurations configured through higher layer signaling (maxNrofCSI-
ReportConfigurations).

CSI priority regarding a CSI report is determined through the priority value Pri_{iCSI}(y,k,c,s) in Table 16. In Table 16, the CSI priority value is determined through the type of channel information included in the CSI report, time-axis reporting characteristics (aperiodic, semi-persistent, or periodic) of the CSI report, the PUSCH or PUCCH used to transmit the CSI report, the serving cell index, and the CSI report configuration index. The CSI priority regarding CSI reports are determined by comparing the priority value Pri_{iCSI}(y,k,c,s) thereof such that a CSI report having a small priority value is deemed to have a high CSI priority.

Assuming that the time for which channel information calculation necessary for a CSI report indicated to the UE by the base station occupies CPUs is a CPU occupation time, the CPU occupation time is determined in consideration of some or all of the following: the type (report quantity) of channel information included in the CSI report, time-axis reporting characteristics (aperiodic, semi-persistent, or periodic) of the CSI report, the slot or symbol occupied by DCI or higher layer signaling which indicates the CSI report, and the slot or symbol occupied by a reference signal for channel state measurement.

### PDCCH: Regarding DCI

In a 5G system, scheduling information regarding a PUSCH or PDSCH is included in DCI and transferred from a base station to a UE through the DCI. The UE may monitor, in the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached to the DCI message payload, and the CRC may be scrambled by a radio network temporary identifier (RNTI) corresponding to the identity of the UE. Different RNTIs may be used according to the purpose of the DCI message (for example, UE-specific data transmission, power control command, random access response, or the like). The RNTI is not explicitly transmitted but is transmitted while being included in a CRC calculation process. Upon receiving a DCI message transmitted through the PDCCH, the UE may identify the CRC by using the allocated RNTI, and thus may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 17 below, for example.

TABLE 17
- Identifier for DCI formats - [1] bit
- Frequency domain resource assignment
-[┌log₂(N_{RB}^{UL,BWP} (N_{RB}^{UL,BWP} − 1)/2)┐] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- TPC(transmit power control) command for scheduled PUSCH - [2] bits
- UL/SUL(supplementary UL) indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below, for example.

TABLE 18

| - | Carrier indicator - 0 or 3 bits | |
|---|---|---|
| - | UL/SUL indicator - 0 or 1 bit | |
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{UL,BWP} /p┐ bits |
| | • | For resource allocation type 1, ┌log₂(N_{RB}^{UL,BWP} (N_{RB}^{UL,BWP} + |
| | | 1)/2)┐ bits |
| - | Time domain resource assignment -1, 2, 3, or 4 bits | |
| - | VRB-to-PRB mapping - 0 or 1 bit, only for resource allocation type 1. | |
| | • | 0 bit if only resource allocation type 0 is configured; |
| | • | 1 bit otherwise. |
| - | Frequency hopping flag - 0 or 1 bit, only for resource allocation type 1. | |
| | • | 0 bit if only resource allocation type 0 is configured; |
| | • | 1 bit otherwise. |
| - | Modulation and coding scheme - 5 bits | |
| - | New data indicator - 1 bit | |
| - | Redundancy version - 2 bits | |
| - | HARQ process number - 4 bits | |
| - | 1st downlink assignment index - 1 or 2 bits | |
| | • | 1 bit for semi-static HARQ-ACK codebook; |
| | • | 2 bits for dynamic HARQ-ACK codebook with single |
| | | HARQ-ACK codebook. |
| - | 2nd downlink assignment index - 0 or 2 bits | |
| | • | 2 bits for dynamic HARQ-ACK codebook with two |
| | | HARQ-ACK sub-codebooks; |
| | • | 0 bit otherwise. |
| - | TPC command for scheduled PUSCH - 2 bits | |
| - | SRS resource indicator - ┌log₂(Σₖ₌₁^{L}^{ₘₐₓ}(ₖ^{N}^{_{SRS}}))┐or ┌log₂(N_{SRS})┐ bits | |
| | • | ┌log₂(Σₖ₌₁^{L}^{ₘₐₓ}(ₖ^{N}^{_{SRS}}))┐ bits for non-codebook based PUSCH |
| | | transmission, |
| | • | ┌log₂(N_{SRS})┐ bits for codebook based PUSCH transmission. |

| | |
|---|---|
| - | Precoding information and number of layers-up to 6 bits |
| - | Antenna ports - up to 5 bits |
| - | SRS request - 2 bits |
| - | CSI request - 0, 1, 2, 3, 4, 5, or 6 bits |
| - | CBG transmission information - 0, 2, 4, 6, or 8 bits |
| - | PTRS-DMRS association - 0 or 2 bits. |
| - | beta_offset indicator - 0 or 2 bits |
| - | DMRS sequence initialization - 0 or 1 bit |

DCI format 1_0 may be used as fallback DCI for scheduling the PDSCH, and the CRC may be scrambled by a C-RNTI. DCI format 1_0 in which the CRC is scrambled by a C-RNTI may include the following pieces of information given in Table 19 below, for example.

TABLE 19

| | |
|---|---|
| - | Identifier for DCI formats - [1] bit |
| - | Frequency domain resource assignment - |
| | [┌log₂(N_{RB}^{DL,BWP}(N_{RB}^{DL,BWP} + 1)/2)┐] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator - 3 bits |
| - | PDSCH-to-HARQ feedback timing indicator - [3] bits |

DCI format 1_1 may be used as non-fallback DCI for scheduling the PDSCH, and the CRC may be scrambled by a C-RNTI. DCI format 1_1 in which the CRC is scrambled by a C-RNTI may include the following pieces of information given in Table 20 below, for example.

TABLE 20

| - | Carrier indicator - 0 or 3 bits | |
|---|---|---|
| - | Identifier for DCI formats - [1] bits | |
| - | Bandwidth part indicator - 0, 1 or 2 bits | |
| - | Frequency domain resource assignment | |
| | • | For resource allocation type 0, ┌N_{RB}^{DL,BWP} /p┐ bits |
| | • | For resource allocation type 1, |
| | | ┌log₂(N_{RB}^{DL,BWP}(N_{RB}^{DL,BWP} + 1)/2┐ bits |
| - | Time domain resource assignment -1, 2, 3, or 4 bits | |
| - | VRB-to-PRB mapping - 0 or 1 bit, only for resource allocation | |
| | type 1. | |
| | • | 0 bit if only resource allocation type 0 is configured; |
| | • | 1 bit otherwise. |

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |
| | For transport block 1: |
| - | Modulation and coding scheme - 5 bits |
| - | New data indicator - 1 bit |
| - | Redundancy version - 2 bits |
| | For transport block 2: |
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ_feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

### PDCCH: CORESET, REG, CCE, and Search Space

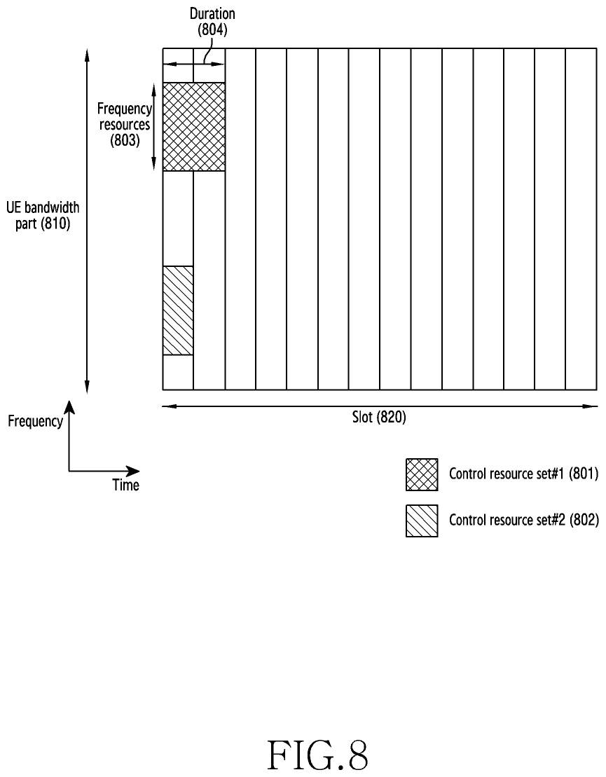

FIG. 8 illustrates an example of a CORESET used to transmit a downlink control channel in a 5G wireless communication system according to an embodiment. Referring to FIG. 8, an example is illustrated in which a UE BWP 810 is configured along the frequency axis, and CORESET #1 801 and CORESET #2 802 are configured within one slot 820 along the time axis. The CORESETs 801 and 802 may be configured in a specific frequency resource 803 within the entire UE BWP % n along the frequency axis. The CORESETs 801 and 802 may be configured as one or multiple OFDM symbols along the time axis, and this may be defined as a CORESET duration 804. In FIG. 8, CORESET #1 801 is configured to have a CORESET duration corresponding to two symbols, and CORESET #2 802 is configured to have a CORESET duration corresponding to one symbol.

A CORESET in 5G described above may be configured for a UE by a base station through upper layer signaling (for example, system information, MIB, or RRC signaling). The description that a CORESET is configured for a UE means that information such as a CORESET identity, the CORESET's frequency location, and the CORESET's symbol duration is provided. For example, this information may include the following pieces of information given in Table 21 below.

TABLE 21

| | |
|---|---|
| ControlResourceSet ::= | SEQUENCE { |

```
    -- Corresponds to L1 parameter ‘CORESET-ID’
    controlResourceSetId
          ControlResourceSetId,
  (CORESET identity))
```

| | |
|---|---|
| frequencyDomainResources | BIT STRING |

```
    (SIZE (45)),
  (frequency domain resource assignment information)
    duration
          INTEGER (1..maxCoReSetDuration),
  (time domain resource assignment information)
    cce-REG-MappingType
          CHOICE {
  (CCE-to-REG mapping type)
          interleaved
          SEQUENCE {
              reg-BundleSize
          ENUMERATED {n2, n3, n6},
        (REG bundle size)
              precoderGranularity
          ENUMERATED {sameAsREG-bundle, allContiguousRBs},
              interleaverSize
          ENUMERATED {n2, n3, n6}
              (interleaver size)
              shiftIndex
          INTEGER(0..maxNrofPhysicalResourceBlocks−1)
```

OPTIONAL

```
            (interleaver shift)
      },
```

| | |
|---|---|
| nonInterleaved | NULL |

```
    },
    tci-StatesPDCCH
          SEQUENCE(SIZE (1..maxNrofTCI-StatesPDCCH)) OF TCI-
```

| | |
|---|---|
| StateId | OPTIONAL, |

```
  (QCL configuration information)
    tci-PresentInDCI
        ENUMERATED {enabled}
```

OPTIONAL, -- Need S

}

In Table 21, tci-StatesPDCCH (simply referred to as transmission configuration indication (TCI) state) configuration information may include information of one or multiple SS/PBCH block indexes or CSI-RS indexes, which are quasi-co-located (OCLed) with a demodulation reference signal (DMRS) transmitted in a corresponding CORESET.

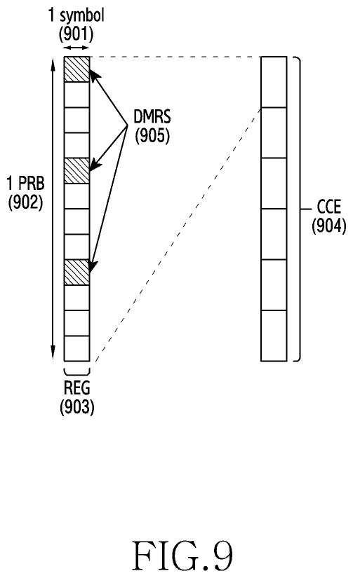

FIG. 9 illustrates an example of a basic unit of time and frequency resources constituting a downlink control channel available in a 5G system according to an embodiment. Referring to FIG. 9, the basic unit of time and frequency resources constituting a control channel may be referred to as a resource element group (REG) 903, and the REG 903 may be defined by one OFDM symbol 901 along the time axis and one physical resource block (PRB) 902, that is, 12 subcarriers, along the frequency axis. The base station may configure a downlink control channel allocation unit by concatenating the REGs 903.

Provided that the basic unit of downlink control channel allocation in 5G is a control channel element (CCE) 904, one CCE 904 may include multiple REGs 903. To describe the REG 903, for example, the REG 903 may include 12 REs, and if one CCE 904 includes six REGs 903, one CCE 904 may then include 72 REs. A downlink CORESET, once configured, may include multiple CCEs 904, and a specific downlink control channel may be mapped to one or multiple CCEs 904 and then transmitted according to the aggregation level (AL) in the CORESET. The CCEs 904 in the CORESET are distinguished by numbers, and the numbers of CCEs 904 may be allocated according to a logical mapping scheme.

The basic unit of the downlink control channel illustrated at the REG 903, may include both REs to which DCI is mapped, and an area to which DMRS 905 for decoding the DCI is mapped. Three DRMSs 905 may be transmitted inside one REG 903. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs may be defined for blind decoding. The search space is a set of downlink control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured ALs.

Search spaces may be classified into common search spaces and UE-specific search spaces. A group of UEs or all UEs may search a common search space of the PDCCH to perform dynamic scheduling regarding system information. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by investigating the UE-specific search space of the PDCCH. The UE-specific search space may be defined UE-specifically as various system parameters and the identity of the UE.

In 5G, a parameter for a search space regarding a PDCCH may be configured for the UE by the base station through upper layer signaling (for example, SIB, MIB, RRC signaling). For example, the base station may provide the UE with configurations such as the number of PDCCH candidates at each aggregation level L, the monitoring cycle regarding the search space, the monitoring occasion in each symbol in a slot regarding the search space, the search space type (common search space or UE-specific search space), a combination of an RNTI and a DCI format to be monitored in the corresponding search space, a CORESET index for monitoring the search space, and the like. For example, the information configured for the UE by the base station may include the following pieces of information in Table 22 below.

TABLE 22

| | |
|---|---|
| SearchSpace ::= | SEQUENCE |

```
    -- Identity of the search space. SearchSpaceId = 0 identifies the SearchSpace
    configured via PBCH (MIB) or ServingCellConfigCommon.
    searchSpaceId
        SearchSpaceId,
  (search space identity)
    controlResourceSetId
        ControlResourceSetId,
  (CORESET identity)
```

| | |
|---|---|
| monitoringSlotPeriodicityAndOffset | CHOICE { |

```
  (monitoring slot level periodicity)
        sl1
        NULL,
        sl2
        INTEGER (0..1),
        sl4
        INTEGER (0..3),
        sl5
        INTEGER (0..4),
        sl8
        INTEGER (0..7),
        sl10
        INTEGER (0..9),
        sl16
        INTEGER (0..15),
        sl20
        INTEGER (0..19)
    }
        OPTIONAL,
```

| | |
|---|---|
| duration(monitoring duration) | INTEGER (2..2559) |
| monitoringSymbolsWithinSlot | BIT |

```
    STRING (SIZE (14))
            OPTIONAL,
  (monitoirng symbols within slot)
    nrofCandidates
        SEQUENCE {
  (number of PDCCH candidates for each aggregation level)
        aggregationLevel1
        ENUMERATED {n0, n1, n2, n3, n4, n5, n6, n8},
        aggregationLevel2
        ENUMERATED {n0, n1, n2, n3, n4, n5, n6, n8},
        aggregationLevel4
        ENUMERATED {n0, n1, n2, n3, n4, n5, n6, n8},
        aggregationLevel8
        ENUMERATED {n0, n1, n2, n3, n4, n5, n6, n8},
        aggregationLevel16
        ENUMERATED {n0, n1, n2, n3, n4, n5, n6, n8}
    },
```

| | |
|---|---|
| searchSpaceType | CHOICE { |

```
    (search space type)
        -- Configures this search space as common search space (CSS) and DCI
    formats to monitor.
        common
        SEQUENCE {
    (common search space)
      }
        ue-Specific
        SEQUENCE {
    (UE-specific search space)
          -- Indicates whether the UE monitors in this USS for DCI
    formats 0-0 and 1-0 or for formats 0-1 and 1-1.
          formats
          ENUMERATED {formats0-0-And-1-0, formats0-1-And-1-1},
          ...
        }
```

According to configuration information, the base station may configure one or multiple search space sets for the UE. The base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. The combinations of DCI formats and RNTIs monitored in a common search space are not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space, and are not limited to the examples given below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI) for indicating power control command for PUCCH
Transmit power control for SRS RNTI (TPC-SRS-RNTI): used to indicate a power control command regarding an SRS

The DCI formats enumerated above may follow the definitions given in Table 23 below.

TABLE 23

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In a 5G system, the search space at aggregation level L in connection with CORESET p and search space set s may be expressed by Equation (1) below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , ma x}^{( L )}} ⌋ + {n}_{CI} ) mod ⌊ \frac{{N}_{CCE , p}}{L} ⌋ \} + i \qquad ( i )$$

In Equation. (1),
L: aggregation level
n_{CI}: carrier index
   N_{CCE,p}: total number of CCEs existing in CORESET p
   n_{s,f}^{μ}: slot index
M_{s,max}^{(L)}: number of PDCCH candidates at aggregation level L
   m_{s,n}_{_{CI}}=0, . . . , M_{s,max}^{(L)}−1: PDCCH candidate index at aggregation level L
   i=0, . . . , L−1

$$Y {p , {n}_{s , f}^{μ}}_{} = ( {A}_{p} \cdot {Y}_{p , {n}_{s , f}^{μ} - 1} ) mod D , \\ {Y}_{p , - 1} = {n}_{RNTI} \neq 0 , \\ {A}_{p} = 39827 for p mod 3 = 0 , \\ {A}_{p} = 39829 for p mod 3 = 1 , \\ {A}_{p} = 39839 for p mod 3 = 2 , \\ D = 65537$$

n_{RNTI}: UE identity

The Y_{p,n}_{_{s,f}}_{^{μ}} value may correspond to 0 in the case of a common search space.

The Y_{p,n}_{_{s,f}}_{^{μ}} value may correspond to a value changed by the UE's identity (C-RNTI or ID configured for the UE by the base station) and the time index in the case of a UE-specific search space.

In 5G, multiple search space sets may be configured by different parameters (for example, parameters in Table 22), and the group of search space sets monitored by the UE at each timepoint may differ accordingly. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### Sounding Reference Signal (SRS)

The base station may configure at least one SRS configuration in each uplink BWP to transfer configuration information for SRS transmission to the UE and may also configure as least one SRS resource set in each SRS configuration. As an example, the base station and the UE may exchange upper signaling information as follows, to transfer information regarding the SRS resource set.
srs-ResourceSetId: SRS resource set index
srs-ResourceIdList: a set of SRS resource indices referred to by SRS resource sets
resource Type: time domain transmission configuration of SRS resources referred to by SRS resource sets, and may be configured as one of “periodic”, “semi-persistent”, and “aperiodic”. If configured as “periodic” or “semi-persistent”, associated CSI-RS information may be provided according to the place of use of SRS resource sets. If configured as “aperiodic”, an aperiodic SRS resource trigger list/slot offset information may be provided, and associated CSI-RS information may be provided according to the place of use of SRS resource sets.
usage: a configuration regarding the place of use of SRS resources referred to by SRS resource sets, and may be configured as one of “beamManagement”, “codebook”, “nonCodebook”, and “antennaSwitching”.
alpha, p0, pathlossReferenceRS, srs-PowerControlAdjustmentStates: provides a parameter configuration for adjusting the transmission power of SRS resources referred to by SRS resource sets.

The UE may understand that an SRS resource included in a set of SRS resource indices referred to by an SRS resource set follows the information configured for the SRS resource set.

The base station and the UE may transmit/receive upper layer signaling information to transfer individual configuration information regarding SRS resources. As an example, the individual configuration information regarding SRS resources may include time-frequency domain mapping information inside slots of the SRS resources, and this may include information regarding intra-slot or inter-slot frequency hopping of the SRS resources. The individual configuration information regarding SRS resources may include time domain transmission configuration of SRS resources and may be configured as one of “periodic”, “semi-persistent”, and “aperiodic.” The time domain transmission configuration of SRS resources may be limited to have the same time domain transmission configuration as the SRS resource set including the SRS resources. If the time domain transmission configuration of SRS resources is configured as “periodic” or “semi-persistent”, the time domain transmission configuration may further include an SRS resource transmission cycle and a slot offset (for example, periodicityAndOffset).

The base station may activate or deactivate SRS transmission for the UE through upper layer signaling including RRC signaling or MAC CE signaling, or L1 signaling (for example, DCI). For example, the base station may activate or deactivate periodic SRS transmission for the UE through upper layer signaling. The base station may indicate activation of an SRS resource set having resourceType configured as “periodic” through upper layer signaling, and the UE may transmit the SRS resource referred to by the activated SRS resource set. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. The spatial domain transmission filter applied to the transmitted SRS resource may refer to spatial relation info configured for the SRS resource or may refer to associated CSI-RS information configured for the SRS resource set including the SRS resource. The UE may transmit the SRS resource inside the uplink BWP activated in the periodic SRS resource activated through upper layer signaling.

For example, the base station may activate or deactivate semi-persistent SRS transmission for the UE through upper layer signaling. The base station may indicate activation of an SRS resource set through MAC CE signaling, and the UE may transmit the SRS resource referred to by the activated SRS resource set. The SRS resource set activated through MAC CE signaling may be limited to an SRS resource set having resourceType configured as “semi-persistent”. Intra-slot time-frequency domain resource mapping of the transmitted SRS resource follows resource mapping information configured for the SRS resource, and slot mapping, including the transmission cycle and slot offset, follows periodicityAndOffset configured for the SRS resource. The spatial domain transmission filter applied to the transmitted SRS resource may refer to spatial relation info configured for the SRS resource or may refer to associated CSI-RS information configured for the SRS resource set including the SRS resource. If spatial relation info is configured for the SRS resource, the spatial domain transmission filter may be determined, without following the spatial relation info, by referring to configuration information regarding spatial relation info transferred through MAC CE signaling that activates semi-persistent SRS transmission. The UE may transmit the SRS resource inside the uplink BWP activated in the semi-persistent SRS resource activated through upper layer signaling.

The base station may trigger aperiodic SRS transmission by the UE through DCI. The base station may indicate one of aperiodic SRS triggers (aperiodicSRS-ResourceTrigger) through the SRS request field of DCI. The UE may understand that the SRS resource set including the aperiodic SRS resource trigger indicated through DCI in the aperiodic SRS resource trigger list, among configuration information of the SRS resource set, has been triggered. The UE may transmit the SRS resource referred to by the activated SRS resource set. Intra-slot time-frequency domain resource mapping of the transmitted SRS resource follows resource mapping information configured for the SRS resource. In addition, slot mapping of the transmitted SRS resource may be determined by the slot offset between the SRS resource and a PDCCH including DCI, and this may refer to value(s) included in the slot offset set configured for the SRS resource set. Specifically, as the slot offset between the SRS resource and the PDCCH including DCI, a value indicated in the time domain resource assignment field of DCI, among offset value(s) included in the slot offset set configured for the SRS resource set, may be applied. The spatial domain transmission filter applied to the transmitted SRS resource may refer to spatial relation info configured for the SRS resource or may refer to associated CSI-RS configured for the SRS resource set including the SRS resource. The UE may transmit the SRS resource inside the uplink BWP activated in the aperiodic SRS resource triggered through DCI.

If the base station triggers aperiodic SRS transmission for the UE through DCI, a minimum time interval may be necessary between the transmitted SRS and the PDCCH including the DCI that triggers aperiodic SRS transmission, for the UE to transmit the SRS by applying configuration information regarding the SRS resource. The time interval for SRS transmission by the UE may be defined as the number of symbols between the last symbol of the PDCCH including the DCI that triggers aperiodic SRS transmission and the first symbol mapped to the first transmitted SRS resource among transmitted SRS resource(s). The minimum time interval may be determined with reference to the PUSCH preparation procedure time needed by the UE to prepare PUSCH transmission. The minimum time interval may have a different value depending on the place of use of the SRS resource set including the transmitted SRS resource. For example, the minimum time interval may be determined as N2 symbols defined in consideration of UE processing capability that follows the UE's capability with reference to the UE's PUSCH preparation procedure time. In addition, if the place of use of the SRS resource set is configured as “codebook” or “antennaSwitching” in view of the place of use of the SRS resource set including the transmitted SRS resource, the minimum time interval may be determined as N2 symbols, and if the place of use of the SRS resource set is configured as “nonCodebook” or “‘beamManagement”, the minimum time interval may be determined as N2+14 symbols. The UE may transmit an aperiodic SRS if the time interval for aperiodic SRS transmission is greater than or equal to the minimum time interval, and may ignore the DCI that triggers the aperiodic SRS if the time interval for aperiodic SRS transmission is less than the minimum time interval. Table 24 below shows how configuration information spatialRelationInfo may be applied.

TABLE 24

| SRS-Resource ::= | SEQUENCE { |
|---|---|
| srs-ResourceId | SRS-ResourceId, |
| nrofSRS-Ports | ENUMERATED {port1, ports2, |
| ports4}, | |
| ptrs-PortIndex | ENUMERATED {n0, n1} |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, |
| n4}, | |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED {neither, |
| groupHopping, sequenceHopping }, | |
| resourceType | CHOICE { |
| aperiodic | SEQUENCE { |
| ... | |
| }, | |
| semi-persistent | SEQUENCE { |
| periodicityAndOffset-sp | SRS- |
| PeriodicityAndOffset, | |
| ... | |
| }, | |
| periodic | SEQUENCE { |
| periodicityAndOffset-p | SRS- |
| Periodicity AndOffset, | |
| ... | |
| } | |
| }, | |
| sequenceId | INTEGER (0..1023), |
| spatialRelationInfo | SRS-SpatialRelationInfo |

OPTIONAL, -- Need R
...
}

Configuration information spatialRelationInfo in Table 24 may be applied, with reference to one reference signal, to a beam used for SRS transmission corresponding to beam information of the corresponding reference signal. For example, configuration of spatialRelationInfo may include information as in Table 25 below.

TABLE 25

| SRS-SpatialRelationInfo ::= | SEQUENCE [ | |
|---|---|---|
| servingCellId | ServCellIndex | OPTIONAL, -- Need |

S

| | |
|---|---|
| referenceSignal | CHOICE { |
| ssb-Index | SSB-Index, |
| csi-RS-Index | NZP-CSI-RS-ResourceId, |
| srs | SEQUENCE{ |
| resourceId | SRS-ResourceId, |
| uplinkBWP | BWP-Id |

```
    }
  }
}
```

Referring to the above-described spatialRelationInfo configuration, an SS/PBCH block index, CSI-RS index, or SRS index may be configured as the index of a reference signal to be referred to use beam information of a specific reference signal. Upper signaling referenceSignal corresponds to configuration information indicating which reference signal's beam information is to be referred to for corresponding SRS transmission, ssb-Index refers to the index of an SS/PBCH block, csi-RS-Index refers to the index of a CSI-RS, and srs refers to the index of an SRS. If upper signaling referenceSignal has a configured value of “ssb-Index”, the UE may apply the reception beam which was used to receive the SS/PBCH block corresponding to ssb-Index as the transmission beam for the corresponding SRS transmission. If upper signaling referenceSignal has a configured value of “‘csi-RS-Index”, the UE may apply the reception beam which was used to receive the CSI-RS corresponding to csi-RS-Index as the transmission beam for the corresponding SRS transmission. If upper signaling referenceSignal has a configured value of “‘srs”, the UE may apply the reception beam which was used to transmit the SRS corresponding to srs as the transmission beam for the corresponding SRS transmission.

### SRS: Antenna Switching

An SRS transmitted from a UE may be used by a base station for DL CSI acquisition. As a specific example, in a single-cell or multi-cell CA situation based on TDD, a base station may schedule transmission of an SRS to a UE and may then measure an SRS transmitted from the UE. In this case, the BS may assume reciprocity between the DL/UL channels, thereby considering that UL channel information estimated based on the SRS transmitted from the UE is DL channel information and may perform DL signal/channel scheduling for the UE by using the same. The UE may be informed by the BS that the usage of an SRS for DL channel information acquisition is antenna switching.

As an example, according to the relevant standard, the usage of an SRS may be configured for the BS and/or UE by using a higher layer parameter (for example, usage of RRC parameter SRS-ResourceSet). In this regard, the usage of an SRS may be configured as a beam management usage, a codebook transmission usage, a non-codebook transmission usage, an antenna switching usage, or the like.

As described above, if the BS has configured the usage parameter in SRS-ResourceSet (higher layer signaling) to be “antennaSwitching” for the UE, the UE may receive at least one higher layer signaling configuration from the BS according to reported UE capability. The UE may report “supportedSRS-TxPortSwitch” as UE capability, and the value thereof may be as follows. In the following, mTnR may refer to UE capability supporting transmission through m antennas and reception through n antennas.
t1r2: a UE capability report value indicating that the UE is capable of a 1T2R operation
t1r1-t1r2: a UE capability report value indicating that the UE is capable of a 1T1R or 1T2R operation.
t2r4: a UE capability report value indicating that the UE is capable of a 2T4R operation
t1r4: a UE capability report value indicating that the UE is capable of a 1T4R operation
t1r6: a UE capability report value indicating that the UE is capable of a 1T6R operation
t1r8: a UE capability report value indicating that the UE is capable of a 1T8R operation
t2r6: a UE capability report value indicating that the UE is capable of a 2T6R operation
t2r8: a UE capability report value indicating that the UE is capable of a 2T8R operation
t4r8: a UE capability report value indicating that the UE is capable of a 4T8R operation
t1r1-t1r2-t1r4: a UE capability report value indicating that the UE is capable of a 1T1R, 1T2R, or 1T4R operation
t1r4-t2r4: a UE capability report value indicating that the UE is capable of a 1T4R or 2T4R operation
t1r1-t1r2-t2r2-t2r4: a UE capability report value indicating that the UE is capable of a 1T1R, 1T2R, 2T2R, or 2T4R operation
t1r1-t1r2-t2r2-t1r4-t2r4: a UE capability report value indicating that the UE is capable of a 1T1R, 1T2R, 2T2R, 1T4R, or 2T4R operation
t1r1: a UE capability report value indicating that the UE is capable of a 1T1R operation
t2r2: a UE capability report value indicating that the UE is capable of a 2T2R operation
t1r1-t2r2: a UE capability report value indicating that the UE is capable of a 1T1R or 2T2R operation
t4r4: a UE capability report value indicating that the UE is capable of a 4T4R operation
t1r1-t2r2-t4r4: a UE capability report value indicating that the UE is capable of a 1T1R, 2T2R, or 4T4R operation

### 1T2R

In relation to the UE's 1T2R operation, similar to a combination including at least one of the following details, the UE may receive a higher layer signaling configuration from the BS, and may perform a 1T2R operation accordingly.

If the UE has reported some or all of srs-AntennaSwitching2SP-1Periodic-r17 and srs-ExtensionAperiodicSRS-r17 which are UE capability reports

If the UE has reported only srs-AntennaSwitching2SP-1Periodic-r17,

The UE may have a maximum of two SRS resource sets having a resourceType value of “semi-persistent” in SRS-ResourceSet (higher layer signaling) configured by the BS, and the UE may have a maximum of one SRS resource set having a resource Type value of “periodic” in SRS-ResourceSet (higher layer signaling) configured by the BS, or

The UE may have a maximum of two SRS resource sets having different resourceType values in SRS-ResourceSet (higher layer signaling) configured by the BS.

In the above details, two SRS resource sets having a resourceType value of “semi-persistent” in SRS-ResourceSet (higher layer signaling) may not be activated simultaneously.

In the above details, each SRS resource set may include two SRS resources transmitted in different OFDM symbols.

In the above details, each SRS resource in each SRS resource set may be made up of one SRS port, and the SRS port of each SRS resource in each SRS resource set may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. The first and second OFDM symbol locations are different from each other, but slot locations may be identical to or different from each other.

If the UE has reported srs-ExtensionAperiodicSRS-r17 only,

The UE may have a maximum of two SRS resource sets having a resourceType value of “aperiodic” in SRS-ResourceSet (higher layer signaling) configured by the BS, and the UE may have a maximum of one SRS resource set having a resourceType value of “periodic” or “semi-persistent” in SRS-ResourceSet (higher layer signaling) configured by the BS, or

The UE may have a maximum of two SRS resource sets having different resourceType values in SRS-ResourceSet (higher layer signaling) configured by the BS.

In the above details, if UE has two SRS resource sets having a resourceType value of “aperiodic” in SRS-ResourceSet (higher layer signaling) configured by the BS, respective SRS resources in the two SRS resource sets may be transmitted at identical or different OFDM symbol locations in two different slots, each SRS resource set may include one SRS resource, each SRS resource in the two SRS resource sets may be made up of one SRS port, and the SRS port of each SRS resource in the two SRS resource sets may be connected to a different UE antenna port.

As an example, the first SRS resource set may include a first SRS resource made up of one SRS port, the second SRS resource set may include a second SRS resource made up of one SRS port, respective SRS ports of the first and second SRS resources may be connected to different UE antenna ports, the SRS port of the first SRS resource may be transmitted at a first OFDM symbol location of a first slot, and the SRS port of the second SRS resource may be transmitted at a second OFDM symbol location of a second slot. The first and second OFDM symbol locations may be identical to or different from each other in each slot, but slot locations may be different from each other.

In the above details, if UE has one SRS resource set having a resource Type value of “aperiodic” in SRS-ResourceSet (higher layer signaling) configured by the BS, the two SRS resources in the corresponding SRS resource set may be transmitted at different OFDM symbol locations in the same slot, and each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location in a first slot, and the SRS port of the second SRS resource may be transmitted at a second OFDM symbol location in the same slot.

In the above details, if the UE has one SRS resource set having a resourceType value of “periodic” or “semi-persistent” in SRS-ResourceSet (higher layer signaling) configured by the BS, the two SRS resources in the corresponding SRS resource set may be transmitted at different OFDM symbol locations, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location in a first slot, and the SRS port of the second SRS resource may be transmitted at a second OFDM symbol location in the same slot.

If the UE has not reported srs-AntennaSwitching2SP-1Periodic-r17, the UE may have a maximum of two (for example, 0, 1, or 2) different SRS resource sets having a resourceType value of “periodic” or “semi-persistent” in SRS-ResourceSet (higher layer signaling) configured by the BS. As an example, the UE may have one of the following details configured by the BS.
No configured SRS resource set having a resourceType value of “periodic” or “semi-persistent” in SRS-ResourceSet (higher layer signaling)
One SRS resource set having a resourceType value of “periodic” in SRS-ResourceSet (higher layer signaling)
One SRS resource set having a resourceType value of “semi-persistent” in SRS-ResourceSet (higher layer signaling)
One SRS resource set having a resourceType value of “periodic” in SRS-ResourceSet (higher layer signaling) and one SRS resource set having a resourceType value of “semi-persistent” therein

In the above details, two SRS resource sets having a resourceType value of “semi-persistent” in SRS-ResourceSet (higher layer signaling) may not be activated simultaneously.

In the above details, each SRS resource set may include two SRS resources, the two SRS resources may be transmitted at different OFDM symbol locations, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location in a first slot, and the SRS port of the second SRS resource may be transmitted at a second OFDM symbol location in the same slot.

If the UE has reported srs-AntennaSwitching2SP-1Periodic-r17, the UE may have a maximum of two SRS resource sets having a resourceType value of “semi-persistent” in SRS-ResourceSet (higher layer signaling) configured by the BS, and the UE may have a maximum of one SRS resource set having a resourceType value of “periodic” in SRS-ResourceSet (higher layer signaling) configured by the BS.

In the above details, two SRS resource sets having a resourceType value of “semi-persistent” in SRS-ResourceSet (higher layer signaling) may not be activated simultaneously.

In the above details, each SRS resource set may include two SRS resources, the two SRS resources may be transmitted at different OFDM symbol locations, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. The first and second OFDM symbol locations are different from each other, but slot locations may be identical to or different from each other.

If the UE has not reported srs-ExtensionAperiodicSRS-r17 only, the UE may have a maximum of one (for example, 0 or 1) SRS resource set having a resourceType value of “aperiodic” in SRS-ResourceSet (higher layer signaling) configured by the BS. As an example, the UE may have one of the following details configured by the BS.
No configured SRS resource set having a resourceType value of “aperiodic” in SRS-ResourceSet (higher layer signaling)
One SRS resource set having a resourceType value of “aperiodic” in SRS-ResourceSet (higher layer signaling)

In the above details, if there is one SRS resource set configured, each SRS resource set may include two SRS resources, the two SRS resources may be transmitted at different OFDM symbol locations in the same slot, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location in a first slot, and the SRS port of the second SRS resource may be transmitted at a second OFDM symbol location in the same slot.

If the UE has reported srs-ExtensionAperiodicSRS-r17 only, the UE may have a maximum of two (for example, 0, 1, or 2) SRS resource sets having a resourceType value of “aperiodic” in SRS-ResourceSet (higher layer signaling) configured by the BS. As an example, the UE may have one of the following details configured by the BS.
No configured SRS resource set having a resourceType value of “aperiodic” in SRS-ResourceSet (higher layer signaling)
One SRS resource set having a resourceType value of “aperiodic” in SRS-ResourceSet (higher layer signaling)
Two SRS resource sets having a resourceType value of “aperiodic” in SRS-ResourceSet (higher layer signaling)

In the above details, if there is one SRS resource set configured, each SRS resource set may include two SRS resources, the two SRS resources may be transmitted at different OFDM symbol locations in the same slot, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location in a first slot, and the SRS port of the second SRS resource may be transmitted at a second OFDM symbol location in the same slot.

In the above details, if there are two SRS resource sets configured, respective SRS resources in the two SRS resource sets may be transmitted at identical or different OFDM symbol locations in two different slots, each SRS resource set may include one SRS resource, each SRS resource in the two SRS resource sets may be made up of one SRS port, and the SRS port of each SRS resource of the two SRS resource sets may be connected to a different UE antenna port.

As an example, the first SRS resource set may include a first SRS resource made up of one SRS port, the second SRS resource set may include a second SRS resource made up of one SRS port, respective SRS ports of the first and second SRS resources may be connected to different UE antenna ports, the SRS port of the first SRS resource may be transmitted at a first OFDM symbol location of a first slot, and the SRS port of the second SRS resource may be transmitted at a second OFDM symbol location of a second slot. The first and second OFDM symbol locations may be identical to or different from each other in each slot, but slot locations may be different from each other.

If the UE has not reported both srs-AntennaSwitching2SP-1Periodic-r17 and srs-ExtensionAperiodicSRS-r17 which are UE capability reports

The UE may have a maximum of two SRS resource sets having different resource Type values in SRS-ResourceSet (higher layer signaling) configured by the BS.

In the above details, each SRS resource set may include two SRS resources, the two SRS resources may be transmitted at different OFDM symbol locations, each SRS resource in the corresponding SRS resource set may be made up of one SRS port, and the SRS port of each SRS resource may be connected to a different UE antenna port.

As an example, the corresponding SRS resource set may include first and second SRS resources each made up of one SRS port, respective SRS ports of the first and second SRS resources may be connected to different UE antenna ports, the SRS port of the first SRS resource may be transmitted at a first OFDM symbol location, and the SRS port of the second SRS resource may be transmitted at a second OFDM symbol location. The first and second OFDM symbol locations are different from each other, but slot locations may be identical to or different from each other.

### 2T4R

In relation to the UE's 2T4R operation, similar to a combination including at least one of the following details, the UE may receive a higher layer signaling configuration from the BS, and may perform a 2T4R operation accordingly.

If the UE has reported some or all of srs-AntennaSwitching2SP-1Periodic-r17 and srs-ExtensionAperiodicSRS-r17 which are UE capability reports

If the UE has reported only srs-AntennaSwitching2SP-1Periodic-r17,

The UE may have a maximum of two SRS resource sets having a resource Type value of “semi-persistent” in SRS-ResourceSet (higher layer signaling) configured by the BS, and the UE may have a maximum of one SRS resource set having a resourceType value of “periodic” in SRS-ResourceSet (higher layer signaling) configured by the BS, or

The UE may have a maximum of two SRS resource sets having different resource Type values in SRS-ResourceSet (higher layer signaling) configured by the BS.

In the above details, two SRS resource sets having a resourceType value of “semi-persistent” in SRS-ResourceSet (higher layer signaling) may not be activated simultaneously.

In the above details, each SRS resource set may include two SRS resources transmitted in different OFDM symbols.

In the above details, each SRS resource in each SRS resource set may be made up of two SRS ports, and the two SRS ports of each SRS resource in each SRS resource set may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location, the two SRS ports of the second SRS resource may be transmitted at a second OFDM symbol location, and the first and second OFDM symbol locations may be different from each other in each slot but may have identical or different slot locations.

If the UE has reported srs-ExtensionAperiodicSRS-r17 only,

The UE may have a maximum of two SRS resource sets having a resourceType value of “aperiodic” in SRS-ResourceSet (higher layer signaling) configured by the BS, and the UE may have a maximum of one SRS resource set having a resourceType value of “periodic” or “semi-persistent” in SRS-ResourceSet (higher layer signaling) configured by the BS, or

The UE may have a maximum of two SRS resource sets having different resourceType values in SRS-ResourceSet (higher layer signaling) configured by the BS.

In the above details, if UE has two SRS resource sets having a resourceType value of “aperiodic” in SRS-ResourceSet (higher layer signaling) configured by the BS, respective SRS resources in the two SRS resource sets may be transmitted at identical or different OFDM symbol locations in two different slots, each SRS resource set may include one SRS resource, each SRS resource in the two SRS resource sets may be made up of two SRS ports, and the two SRS ports of each SRS resource in the two SRS resource sets may be connected to different UE antenna ports.

As an example, the first SRS resource set may include a first SRS resource made up of two SRS ports, the second SRS resource set may include a second SRS resource made up of two SRS ports, the two SRS ports of the first and second SRS resources may be connected to different UE antenna ports, the two SRS ports of the first SRS resource may be transmitted at a first OFDM symbol location of a first slot, and the two SRS ports of the second SRS resource may be transmitted at a second OFDM symbol location of a second slot. The first and second OFDM symbol locations may be identical to or different from each other in each slot, but slot locations may be different from each other.

In the above details, if UE has one SRS resource set having a resourceType value of “aperiodic” in SRS-ResourceSet (higher layer signaling) configured by the BS, the two SRS resources in the corresponding SRS resource set may be transmitted at different OFDM symbol locations in the same slot, and each SRS resource in the corresponding SRS resource set may be made up of two SRS ports, and the SRS ports of each SRS resource may be connected to different UE antenna ports.

In the above details, if the UE has one SRS resource set having a resourceType value of “periodic” or “semi-persistent” in SRS-ResourceSet (higher layer signaling) configured by the BS, the two SRS resources in the corresponding SRS resource set may be transmitted at different OFDM symbol locations, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol. The first and second OFDM symbol locations may be different from each other, but slot locations may be identical to or different from each other.

If the UE has not reported srs-AntennaSwitching2SP-1Periodic-r17, the UE may have a maximum of two (for example, 0, 1, or 2) different SRS resource sets having a resourceType value of “periodic” or “semi-persistent” in SRS-ResourceSet (higher layer signaling) configured by the BS. As an example, the UE may have one of the following details configured by the BS.
No configured SRS resource set having a resourceType value of “periodic” or “semi-persistent” in SRS-ResourceSet (higher layer signaling)
One SRS resource set having a resourceType value of “periodic” in SRS-ResourceSet (higher layer signaling)
One SRS resource set having a resourceType value of “semi-persistent” in SRS-ResourceSet (higher layer signaling)
One SRS resource set having a resourceType value of “periodic” in SRS-ResourceSet (higher layer signaling) and one SRS resource set having a resourceType value of “semi-persistent” therein

In the above details, two SRS resource sets having a resourceType value of “semi-persistent” in SRS-ResourceSet (higher layer signaling) may not be activated simultaneously.

In the above details, each SRS resource set may include two SRS resources, the two SRS resources may be transmitted at different OFDM symbol locations, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. The first and second OFDM symbol locations are different from each other, but slot locations may be identical to or different from each other.

If the UE has reported srs-AntennaSwitching2SP-1Periodic-r17, the UE may have a maximum of two SRS resource sets having a resourceType value of “semi-persistent” in SRS-ResourceSet (higher layer signaling) configured by the BS, and the UE may have a maximum of one SRS resource set having a resourceType value of “periodic” in SRS-ResourceSet (higher layer signaling) configured by the BS.

In the above details, two SRS resource sets having a resourceType value of “semi-persistent” in SRS-ResourceSet (higher layer signaling) may not be activated simultaneously.

In the above details, each SRS resource set may include two SRS resources, the two SRS resources may be transmitted at different OFDM symbol locations, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. The first and second OFDM symbol locations are different from each other, but slot locations may be identical to or different from each other.

If the UE has not reported srs-ExtensionAperiodicSRS-r17, the UE may have a maximum of one (for example, 0 or 1) SRS resource set having a resourceType value of “aperiodic” in SRS-ResourceSet (higher layer signaling) configured by the BS. As an example, the UE may have one of the following details configured by the BS.
No configured SRS resource set having a resourceType value of “aperiodic” in SRS-ResourceSet (higher layer signaling)
One SRS resource set having a resourceType value of “aperiodic” in SRS-ResourceSet (higher layer signaling)

In the above details, if there is one SRS resource set configured, each SRS resource set may include two SRS resources, the two SRS resources may be transmitted at different OFDM symbol locations in the same slot, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location in a first slot, and the two SRS ports of the second SRS resource may be transmitted at a second OFDM symbol location in the same slot.

If the UE has reported srs-ExtensionAperiodicSRS-r17, the UE may have a maximum of two (for example, 0, 1, or 2) SRS resource sets having a resourceType value of “aperiodic” in SRS-ResourceSet (higher layer signaling) configured by the BS. As an example, the UE may have one of the following details configured by the BS.
No configured SRS resource set having a resourceType value of “aperiodic” in SRS-ResourceSet (higher layer signaling)
One SRS resource set having a resourceType value of “aperiodic” in SRS-ResourceSet (higher layer signaling)
Two SRS resource sets having a resourceType value of “aperiodic” in SRS-ResourceSet (higher layer signaling)

In the above details, if there is one SRS resource set configured, each SRS resource set may include two SRS resources, the two SRS resources may be transmitted at different OFDM symbol locations in the same slot, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location in a first slot, and the two SRS ports of the second SRS resource may be transmitted at a second OFDM symbol location in the same slot.

In the above details, if there are two SRS resource sets configured, respective SRS resources in the two SRS resource sets may be transmitted at identical or different OFDM symbol locations in two different slots, each SRS resource set may include one SRS resource, each SRS resource in the two SRS resource sets may be made up of two SRS ports, and the two SRS ports of each SRS resource of the two SRS resource sets may be connected to different UE antenna ports.

As an example, the first SRS resource set may include a first SRS resource made up of two SRS ports, the second SRS resource set may include a second SRS resource made up of two SRS ports, the two SRS ports of the first and second SRS resources may be connected to different UE antenna ports, the two SRS ports of the first SRS resource may be transmitted at a first OFDM symbol location of a first slot, and the two SRS ports of the second SRS resource may be transmitted at a second OFDM symbol location of a second slot. The first and second OFDM symbol locations may be identical to or different from each other in each slot, but slot locations may be different from each other.

If the UE has not reported both srs-AntennaSwitching2SP-1Periodic-r17 and srs-ExtensionAperiodicSRS-r17 which are UE capability reports

The UE may have a maximum of two SRS resource sets having different resource Type values in SRS-ResourceSet (higher layer signaling) configured by the BS.

In the above details, each SRS resource set may include two SRS resources, the two SRS resources may be transmitted at different OFDM symbol locations, each SRS resource in the corresponding SRS resource set may be made up of two SRS ports, and the two SRS ports of each SRS resource may be connected to different UE antenna ports.

As an example, the corresponding SRS resource set may include first and second SRS resources each made up of two SRS ports, the two SRS ports of the first and second SRS resources may be connected to different UE antenna ports, the two SRS ports of the first SRS resource may be transmitted at a first OFDM symbol location, and the two SRS ports of the second SRS resource may be transmitted at a second OFDM symbol location. The first and second OFDM symbol locations are different from each other, but slot locations may be identical to or different from each other.

### 1T4R

In relation to the UE's 1T4R operation, similar to a combination including at least one of the following details, the UE may receive a higher layer signaling configuration from the BS and may perform a 1T4R operation accordingly.

If the UE has reported some or all of srs-AntennaSwitching2SP-1Periodic-r17, srs-ExtensionAperiodicSRS-r17, and srs-OneAP-SRS-r17 which are UE capability reports

If the UE has not reported srs-AntennaSwitching2SP-1Periodic-r17, the UE may have a maximum of one (for example, 0 or 1) SRS resource set having a resourceType value of “periodic” or “semi-persistent” in SRS-ResourceSet (higher layer signaling) configured by the BS. As an example, the UE may have one of the following details configured by the BS.
No configured SRS resource set having a resourceType value of “periodic” or “semi-persistent” in SRS-ResourceSet (higher layer signaling)
One SRS resource set having a resourceType value of “periodic” in SRS-ResourceSet (higher layer signaling)
One SRS resource set having a resourceType value of “semi-persistent” in SRS-ResourceSet (higher layer signaling)

In the above details, each SRS resource set may include four SRS resources, the four SRS resources may be transmitted at different OFDM symbol locations, each SRS resource in the corresponding SRS resource set may be made up of one SRS port, and the one SRS port of each SRS resource may be connected to a different UE antenna port.

As an example, the corresponding SRS resource set may include first to fourth SRS resources each made up of one SRS port, the one SRS port of the first to fourth SRS resources may be connected to different UE antenna ports, the one SRS port of the first to fourth SRS resources may be transmitted at first to fourth OFDM symbol locations. The first to fourth OFDM symbol locations are different from each other, but slot locations may be identical to or different from each other.

If the UE has reported srs-AntennaSwitching2SP-1Periodic-r17, the UE may have a maximum of two SRS resource sets having a resource Type value of “semi-persistent” in SRS-ResourceSet (higher layer signaling) configured by the BS, and the UE may have a maximum of one SRS resource set having a resourceType value of “periodic” in SRS-ResourceSet (higher layer signaling) configured by the BS.

In the above details, two SRS resource sets having a resourceType value of “semi-persistent” in SRS-ResourceSet (higher layer signaling) may not be activated simultaneously.

In the above details, each SRS resource set may include four SRS resources, the four SRS resources may be transmitted at different OFDM symbol locations, each SRS resource in the corresponding SRS resource set may be made up of one SRS port, and the one SRS port of each SRS resource may be connected to a different UE antenna port.

As an example, the corresponding SRS resource set may include first to fourth SRS resources each made up of one SRS port, the one SRS port of the first to fourth SRS resources may be connected to different UE antenna ports, the one SRS port of the first to fourth SRS resources may be transmitted at first to fourth OFDM symbol locations, and the first to fourth OFDM symbol locations are different from each other, but slot locations may be identical to or different from each other.

According to which is reported by the UE among srs-ExtensionAperiodicSRS-r17 and srs-OneAP-SRS-r17 which are UE capability reports, the BS's higher layer signaling configuration and the UE's operation may be expected as follows:

If the UE has not reported both srs-ExtensionAperiodicSRS-r17 and srs-OneAP-SRS-r17, the UE may have 0 or 2 SRS resource sets having a resource Type value of “aperiodic” in SRS-ResourceSet (higher layer signaling) configured by the BS.

If the UE has reported both srs-ExtensionAperiodicSRS-r17 and srs-OneAP-SRS-r17, the UE may have 0, 1, 2, or 4 SRS resource sets having a resourceType value of “aperiodic” in SRS-ResourceSet (higher layer signaling) configured by the BS.

If the UE has reported only srs-ExtensionAperiodicSRS-r17 among srs-ExtensionAperiodicSRS-r17 and srs-OneAP-SRS-r17, the UE may have 0, 2, or 4 SRS resource sets having a resourceType value of “aperiodic” in SRS-ResourceSet (higher layer signaling) configured by the BS.

If the UE has reported only srs-OneAP-SRS-r17 among srs-ExtensionAperiodicSRS-r17 and srs-OneAP-SRS-r17, the UE may have 0, 1, or 2 SRS resource sets having a resource Type value of “aperiodic” in SRS-ResourceSet (higher layer signaling) configured by the BS.

In the above details, if there is one SRS resource set configured, each SRS resource set may include four SRS resources, the four SRS resources may be transmitted at different OFDM symbol locations in the same slot, each SRS resource in the corresponding SRS resource set may be made up of one SRS port, and the one SRS port of each SRS resource may be connected to a different UE antenna port.

As an example, the corresponding SRS resource set may include first to fourth SRS resources each made up of one SRS port, and the one SRS port of the first to fourth SRS resources may be connected to different UE antenna ports. The one SRS port of the first to fourth SRS resources may be transmitted at first to fourth OFDM symbol locations in the same slot, and the first to fourth OFDM symbol locations may be different from each other.

In the above details, if there are two SRS resource sets configured,

Each SRS resource set may include two SRS resources, or the first SRS resource set may have one SRS resource, and the second SRS resource set may have three SRS resources.

Respective SRS resources in respective SRS resource sets may be transmitted at different OFDM symbol locations in the same slot, and SRS transmission regarding respective SRS resource sets may be performed in different slots. During SRS transmission between different SRS resources of different SRS resource sets, the SRS resource set may be transmitted at identical or different OFDM symbol locations, but slot locations may be different.

Each SRS resource may be made up of one SRS port, and the one SRS port of each SRS resource may be connected to a different UE antenna port.

As an example, the first SRS resource set may include first and second SRS resources each made up of one SRS port, and the second SRS resource set may include third and fourth SRS resources each made up of one SRS port. The one SRS port of the first to fourth SRS resources may be connected to different UE antenna ports. The one SRS port of each of the first and second SRS resources may be transmitted at first and second OFDM symbol locations in an identical slot, and the first and second OFDM symbol locations may be different from each other. The one SRS port of each of the third and fourth SRS resources may be transmitted at third and fourth OFDM symbol locations in a slot different from the slot in which the first and second SRS resources are transmitted, and the third and fourth OFDM symbol locations may be different from each other. The first OFDM symbol location and the third and fourth OFDM symbol locations may be identical or different from each other, and the second OFDM symbol location may be likewise identical to or different from the third and fourth OFDM symbol locations.

As an example, the first SRS resource set may include a first SRS resource made up of one SRS port, and the second SRS resource set may include second to fourth SRS resources each made up of one SRS port. The one SRS port of the first to fourth SRS resources may be connected to different UE antenna ports. The one SRS port of the first SRS resource may be transmitted at a first OFDM symbol location in a slot. The one SRS port of each of the second to fourth SRS resources may be transmitted at second to fourth OFDM symbol locations in a slot different from the slot in which the first SRS resource is transmitted, and the second and fourth OFDM symbol locations may be different from each other. The first OFDM symbol location and the second to fourth OFDM symbol locations may be identical or different from each other.

In the above details, if there are four SRS resource sets configured, each SRS resource set may include one SRS resource, the four SRS resources may be transmitted at identical or different OFDM symbol locations in each slot, and SRS transmission regarding each SRS resource set may be performed in different slots. Each SRS resource in the corresponding SRS resource set may be made up of one SRS port, and the one SRS port of each SRS resource may be connected to a different UE antenna port.

As an example, the first to fourth SRS resource sets may include first to fourth SRS resources, respectively (that is, one SRS resource set includes one SRS resource), and the one SRS port of the first to fourth SRS resources may be connected to different UE antenna ports. The one SRS port of the first to fourth SRS resources may be transmitted at first to fourth OFDM symbol locations in different slots, and the first to fourth OFDM symbol locations in each slot may be identical to or different from each other, but slot locations may be different from each other.

If the UE has not reported all of srs-AntennaSwitching2SP-1Periodic-r17, srs-ExtensionAperiodicSRS-r17, and srs-OneAP-SRS-r17 which are UE capability reports, that is, if the three UE capability reports have not been reported all,

The UE may have a maximum of one (that is, 0 or 1) SRS resource set having a resourceType value of “periodic” or “semi-persistent” in SRS-ResourceSet (higher layer signaling) configured by the BS.

In the above details, each SRS resource set may include four SRS resources, the four SRS resources may be transmitted at different OFDM symbol locations, each SRS resource in the corresponding SRS resource set may be made up of one SRS port, and the one SRS port of each SRS resource may be connected to a different UE antenna port.

As an example, the corresponding SRS resource set may include first to fourth SRS resources each made up of one SRS port, and the one SRS port of the first to fourth SRS resources may be connected to different UE antenna ports. The one SRS port of the first to fourth SRS resources may be transmitted at first to fourth OFDM symbol locations, and the first to fourth OFDM symbol locations are different from each other, but slot locations may be identical to or different from each other.

The UE may have 0 or 2 SRS resource sets having a resource Type value of “aperiodic” in SRS-ResourceSet (higher layer signaling) configured by the BS. If there are two SRS resource sets configured, some or all of the following details may be considered.

Each SRS resource set may include two SRS resources, or the first SRS resource set may have one SRS resource, and the second SRS resource set may have three SRS resources.

Respective SRS resources in respective SRS resource sets may be transmitted at different OFDM symbol locations in the same slot, and SRS transmission regarding respective SRS resource sets may be performed in different slots. During SRS transmission between different SRS resources of different SRS resource sets, the SRS resources may be transmitted at identical or different OFDM symbol locations, but slot locations may be different.

Each SRS resource may be made up of one SRS port, and the one SRS port of each SRS resource may be connected to a different UE antenna port.

As an example, the first SRS resource set may include first and second SRS resources each made up of one SRS port, and the second SRS resource set may include third and fourth SRS resources each made up of one SRS port. The one SRS port of the first to fourth SRS resources may be connected to different UE antenna ports. The one SRS port of each of the first and second SRS resources may be transmitted at first and second OFDM symbol locations in an identical slot, and the first and second OFDM symbol locations may be different from each other. The one SRS port of each of the third and fourth SRS resources may be transmitted at third and fourth OFDM symbol locations in a slot different from the slot in which the first and second SRS resources are transmitted, and the third and fourth OFDM symbol locations may be different from each other. The first OFDM symbol location and the third and fourth OFDM symbol locations may be identical or different from each other, and the second OFDM symbol location may be likewise identical to or different from the third and fourth OFDM symbol locations.

As an example, the first SRS resource set may include a first SRS resource made up of one SRS port, and the second SRS resource set may include second to fourth SRS resources each made up of one SRS port. The one SRS port of the first to fourth SRS resources may be connected to different UE antenna ports. The one SRS port of the first SRS resource may be transmitted at a first OFDM symbol location in a slot. The one SRS port of each of the second to fourth SRS resources may be transmitted at second to fourth OFDM symbol locations in a slot different from the slot in which the first SRS resource is transmitted, and the second and fourth OFDM symbol locations may be different from each other. The first OFDM symbol location and the second to fourth OFDM symbol locations may be identical or different from each other.

In the above details, if there are multiple SRS resource sets configured (for example, if there are two or four SRS resource sets configured)

The UE may expect that each of p0, alpha, pathlossReferenceRS, and srs-PowerControlAdjustmentStates, which are power control parameters that may be configured in each SRS resource set through higher layer signaling by the BS, will have the same value configured in every SRS resource set. That is, the UE may expect that multiple SRS resource sets will all have the same power control parameters, as described below.

The power control parameter restriction may be applied only to SRS resource sets having a resourceType value of “aperiodic” configured in SRS-ResourceSet (higher layer signaling) for the UE by the BS.

The power control parameter restriction may be applied only to SRS resource sets having a resourceType value of “periodic”, “semi-persistent”, or “aperiodic” configured in SRS-ResourceSet (higher layer signaling) for the UE by the BS.

The UE may expect that the value of aperiodicSRS-ResourceTrigger (higher layer signaling) or the value of one entry in AperiodicSRS-ResourceTriggerList (higher layer signaling) will be configured by the BS to be the same value in every SRS resource set. Such a restriction will be described below as an aperiodic SRS trigger restriction.

In this regard, aperiodicSRS-ResourceTrigger (higher layer signaling) which is configured in an SRS resource set by the BS refers to aperiodic SRS trigger state information. If the UE has received an aperiodic SRS trigger regarding a specific aperiodic SRS trigger state from the BS through DCI, and if the value configured in aperiodicSRS-ResourceTrigger (higher layer signaling) is an SRS trigger state indicated by the DCI, the UE may perform aperiodic SRS transmission regarding the corresponding SRS resource set.

Similarly, AperiodicSRS-ResourceTriggerList (higher layer signaling) which is configured in an SRS resource set by the BS may include multiple pieces of aperiodic SRS trigger state information. If the UE has received an aperiodic SRS trigger regarding a specific aperiodic SRS trigger state from the BS through DCI, and if the aperiodic SRS trigger state indicated by the DCI is included among multiple values configured in AperiodicSRS-ResourceTriggerList (higher layer signaling), the UE may perform aperiodic SRS transmission regarding the corresponding SRS resource set.

While aperiodicSRS-ResourceTrigger (higher layer signaling) has provided a function such that the corresponding SRS resource set may be included in one aperiodic SRS trigger state, AperiodicSRS-ResourceTriggerList (higher layer signaling) provides a function such that the corresponding SRS resource set may be included in multiple aperiodic SRS trigger states, and there may thus be an increased possibility that the corresponding SRS resource set will be triggered by the BS.

The aperiodic SRS trigger restriction may be applied only to SRS resource sets having a resourceType value of “aperiodic” configured in SRS-ResourceSet (higher layer signaling) for the UE by the BS.

The UE may expect that slotOffset (higher layer signaling) in each SRS resource set from the BS will have a different value. Such a restriction will be described as follows.

The slot offset restriction may be applied only to SRS resource sets having a resource Type value of “aperiodic” configured in SRS-ResourceSet (higher layer signaling) for the UE by the BS.

### 1T1R, 2T2R, 4T4R

In relation to the UE's 1T1R, 2T2R, and 4T4R operations, as a combination including at least one of the following details, the UE may receive a higher layer signaling configuration from the BS, and may perform 1T1R, 2T2R, and 4T4R operations accordingly.

If the UE has not reported srs-AntennaSwitching2SP-1Periodic-r17 which is a UE capability report, the UE may have a maximum of two SRS resource sets configured by the BS.

If the UE has reported srs-AntennaSwitching2SP-1Periodic-r17 which is a UE capability report, the UE may receive a higher layer signaling configuration from the BS as follow:
Two SRS resource sets having a resourceType value of “semi-persistent” in SRS-ResourceSet (higher layer signaling), and one SRS resource set having a resourceType value of “periodic” in SRS-ResourceSet (higher layer signaling)

In the above details, two SRS resource sets having a resourceType value of “semi-persistent” in SRS-ResourceSet (higher layer signaling) may not be activated simultaneously.

A maximum of two SRS resource sets

Each SRS resource set may include one SRS resource. In the case of 1T1R, 2T2R, and 4T4R, the number of SRS ports configured in each SRS resource may be 1, 2, and 4, respectively.

In the case of 1T1R, 2T2R, and 4T4R, the UE may not expect that SRS transmission regarding two or more SRS resource sets having a usage (higher layer signaling) configured to be “antennaSwitching” will be configured or triggered at the same OFDM symbol location.

### 1T6R

In relation to the UE's 1T6R operation, similar to a combination including at least one of the following details, the UE may receive a higher layer signaling configuration from the BS, and may perform a 1T6R operation accordingly.

The UE may have a maximum of one (that is, 0 or 1) SRS resource set having a resource Type value of “periodic” in SRS-ResourceSet (higher layer signaling) configured by the BS. One SRS resource set may include six SRS resources, and each SRS resource may be made up of one SRS port. Respective SRS resources may be transmitted at different OFDM symbol locations in identical or different slots, and the one SRS port of each SRS resource may be connected to a different UE antenna port.

The UE may receive a configuration regarding an SRS resource set having a resource Type value of “semi-persistent” in SRS-ResourceSet (higher layer signaling) from the BS as follows.

If the UE has not reported srs-AntennaSwitching2SP-1Periodic-r17 which is a UE capability report, the UE may have a maximum of one (that is, 0 or 1) SRS resource set having a resourceType value of “semi-persistent” in SRS-ResourceSet (higher layer signaling) configured by the BS.

If the UE has reported srs-AntennaSwitching2SP-1Periodic-r17 which is a UE capability report, the UE may have a maximum of two (that is, 0, 1, or 2) SRS resource sets having a resourceType value of “semi-persistent” in SRS-ResourceSet (higher layer signaling) configured by the BS, and two SRS resource sets having a resourceType value of “semi-persistent” in SRS-ResourceSet (higher layer signaling) may not be activated simultaneously.

One SRS resource set may include six SRS resources, each SRS resource may be made up of one SRS port, respective SRS resources may be transmitted at different OFDM symbol locations in identical or different slots, and the one SRS port of each SRS resource may be connected to a different UE antenna port.

The UE may have a maximum of three (that is, 0, 1, 2, or 3) SRS resource sets having a resourceType value of “aperiodic” in SRS-ResourceSet (higher layer signaling) configured by the BS.

If there is one SRS resource set configured, six SRS resources may be included therein, each SRS resource may be made up of one SRS port, each SRS resource may be transmitted at a different OFDM symbol location in the same slot, and the one SRS port of each SRS resource may be connected to a different UE antenna port.

If there are two SRS resource sets configured, a total of six SRS resources may be divided and included in the two SRS resource sets, each SRS resource may be made up of one SRS port, all SRS resources in each SRS resource set may be transmitted at different OFDM symbol locations in the same slot, SRS transmission regarding different SRS resource sets may be performed at identical or different OFDM symbol locations, and the one SRS port of each SRS resource may be connected to a different UE antenna port.

As an example, the UE may include first to third SRS resources in the first SRS resource set and may include fourth to sixth SRS resources in the second SRS resource set. Transmission regarding the first to third SRS resources in the first SRS resource set may be performed at first to third OFDM symbol locations in a first slot, and the first to third OFDM symbol locations may be different from each other. Transmission regarding the fourth to sixth SRS resources in the second SRS resource set may be performed at fourth to sixth OFDM symbol locations in a second slot, and the fourth to sixth OFDM symbol locations may be different from each other. The first and second slot locations may be different from each other, and the first to third OFDM symbol locations and the fourth to sixth OFDM symbol locations may be identical to or different from each other.

As an example, the first and second SRS resource sets may include one (for example, first SRS resource) and five (for example, second to sixth SRS resources) SRS resource sets, respectively, and other combinations may not be excluded.

If there are three SRS resource sets configured, a total of six SRS resources may be divided and included in three SRS resource sets, each SRS resource may be made up of one SRS port. All SRS resources in each SRS resource set may be transmitted at different OFDM symbol locations in the same slot, SRS transmission regarding different SRS resource sets may be performed at identical or different OFDM symbol locations of different slots, and the one SRS port of each SRS resource may be connected to a different UE antenna port.

As an example, the UE may include first and second SRS resources in the first SRS resource set, may include third and fourth SRS resources in the second SRS resource set, and may include fifth and sixth SRS resources in the third SRS resource set. Transmission regarding the first and second SRS resources in the first SRS resource set may be performed at first and second OFDM symbol locations in a first slot, and the first and second OFDM symbol locations may be different from each other. Transmission regarding the third and fourth SRS resources in the second SRS resource set may be performed at third and fourth OFDM symbol locations in a second slot, and the third and fourth OFDM symbol locations may be different from each other. Transmission regarding the fifth and sixth SRS resources in the third SRS resource set may be performed at fifth and sixth OFDM symbol locations in a third slot, and fifth and sixth OFDM symbol locations may be different from each other. The first, second, and third slot locations may be different from each other, and the first and second OFDM symbol locations, the third and fourth OFDM symbol locations, and the fifth and sixth OFDM symbol locations may be identical to or different from each other.

As an example, the first, second, and third SRS resource sets may include three (for example, first to third SRS resources), two (for example, fourth and fifth SRS resources), and one (for example, sixth SRS resource), respectively, and other combinations may not be excluded.

### 1T8R

In relation to the UE's 1T8R operation, similar to a combination including at least one of the following details, the UE may receive a higher layer signaling configuration from the BS and may perform a 1T8R operation accordingly.

The UE may have a maximum of one (that is, 0 or 1) SRS resource set having a resource Type value of “periodic” in SRS-ResourceSet (higher layer signaling) configured by the BS, one SRS resource set may include eight SRS resources, each SRS resource may be made up of one SRS port, respective SRS resources may be transmitted at different OFDM symbol locations in identical or different slots, and the one SRS port of each SRS resource may be connected to a different UE antenna port.

The UE may receive a configuration regarding an SRS resource set having a resource Type value of “semi-persistent” in SRS-ResourceSet (higher layer signaling) from the BS as follows.

If the UE has not reported srs-AntennaSwitching2SP-1Periodic-r17 which is a UE capability report, the UE may have a maximum of one (that is, 0 or 1) SRS resource set having a resourceType value of “semi-persistent” in SRS-ResourceSet (higher layer signaling) configured by the BS.

If the UE has reported srs-AntennaSwitching2SP-1Periodic-r17 which is a UE capability report, the UE may have a maximum of two (that is, 0, 1, or 2) SRS resource sets having a resource Type value of “semi-persistent” in SRS-ResourceSet (higher layer signaling) configured by the BS, and two SRS resource sets having a resourceType value of “semi-persistent” in SRS-ResourceSet (higher layer signaling) may not be activated simultaneously.

One SRS resource set may include eight SRS resources, each SRS resource may be made up of one SRS port, respective SRS resources may be transmitted at different OFDM symbol locations in identical or different slots, and the one SRS port of each SRS resource may be connected to a different UE antenna port.

The UE may have 0, 2, 3, or 4 SRS resource sets having a resourceType value of “aperiodic” in SRS-ResourceSet (higher layer signaling) configured by the BS.

If there is two SRS resource sets configured, a total of eight SRS resources may be divided and included in the two SRS resource sets, each SRS resource may be made up of one SRS port, all SRS resources in each SRS resource set may be transmitted at different OFDM symbol locations in the same slot, SRS transmission regarding different SRS resource sets may be performed at identical or different OFDM symbol locations of different slots, and the one SRS port of each SRS resource may be connected to a different UE antenna port.

As an example, the UE may include first to fourth SRS resources in the first SRS resource set, and may include fifth to eighth SRS resources in the second SRS resource set. Transmission regarding the first to fourth SRS resources in the first SRS resource set may be performed at first to fourth OFDM symbol locations in a first slot, and the first to fourth OFDM symbol locations may be different from each other. Transmission regarding the fifth to eighth SRS resources in the second SRS resource set may be performed at fifth to eighth OFDM symbol locations in a second slot, and the fifth to eighth OFDM symbol locations may be different from each other. The first and second slot locations may be different from each other, and the first to fourth OFDM symbol locations and the fifth to eighth OFDM symbol locations may be identical to or different from each other.

As an example, the first and second SRS resource sets include one (for example, first SRS resource) and seven (for example, second to eighth SRS resources) SRS resource sets, respectively, and other combinations may not be excluded.

If there are three SRS resource sets configured, a total of eight SRS resources may be divided and included in the three SRS resource sets, each SRS resource may be made up of one SRS port, all SRS resources in each SRS resource set may be transmitted at different OFDM symbol locations in the same slot, SRS transmission regarding different SRS resource sets may be performed at identical or different OFDM symbol locations of different slots, and the one SRS port of each SRS resource may be connected to a different UE antenna port.

As an example, the UE may include first to third SRS resources in the first SRS resource set, may include fourth to sixth SRS resources in the second SRS resource set, and may include seventh and eighth SRS resources in the third SRS resource set. Transmission regarding the first to third SRS resources in the first SRS resource set may be performed at first to third OFDM symbol locations in a first slot, and the first to third OFDM symbol locations may be different from each other. Transmission regarding the fourth to sixth SRS resources in the second SRS resource set may be performed at fourth to sixth OFDM symbol locations in a second slot, and the fourth to sixth OFDM symbol locations may be different from each other. Transmission regarding the seventh and eighth SRS resources in the third SRS resource set may be performed at seventh and eighth OFDM symbol locations in a third slot, and the seventh and eighth OFDM symbol locations may be different from each other. The first, second, and third slot locations may be different from each other, and the first to third OFDM symbol locations, the fourth to sixth OFDM symbol locations, and the seventh and eighth OFDM symbol locations may be identical to or different from each other.

As an example, the first, second, and third SRS resource sets may include four (for example, first to fourth SRS resources), two (for example, fifth and sixth SRS resources), and two (for example, seventh and eighth SRS resource), respectively, and other combinations may not be excluded.

If there are four SRS resource sets configured, a total of eight SRS resources may be divided and included in the four SRS resource sets, each SRS resource may be made up of one SRS port, all SRS resources in each SRS resource set may be transmitted at different OFDM symbol locations in the same slot, SRS transmission regarding different SRS resource sets may be performed at identical or different OFDM symbol locations, and the one SRS port of each SRS resource may be connected to a different UE antenna port.

As an example, the UE may include first and second SRS resources in the first SRS resource set, may include third and fourth SRS resources in the second SRS resource set, may include fifth and sixth SRS resources in the third SRS resource set, and may include seventh and eighth SRS resources in the fourth SRS resource set. Transmission regarding the first and second SRS resources in the first SRS resource set may be performed at first and second OFDM symbol locations in a first slot, and the first and second OFDM symbol locations may be different from each other. Transmission regarding the third and fourth SRS resources in the second SRS resource set may be performed at third and fourth OFDM symbol locations in a second slot, and the third and fourth OFDM symbol locations may be different from each other. Transmission regarding the fifth and sixth SRS resources in the third SRS resource set may be performed at fifth and sixth OFDM symbol locations in a third slot, and the fifth and sixth OFDM symbol locations may be different from each other. Transmission regarding the seventh and eighth SRS resources in the fourth SRS resource set may be performed at seventh and eighth OFDM symbol locations in a fourth slot, and the seventh and eighth OFDM symbol locations may be different from each other. The first to fourth slot locations may be different from each other, and the first and second OFDM symbol locations, the third and fourth OFDM symbol locations, the fifth and sixth OFDM symbol locations, and the seventh and eighth OFDM symbol locations may be identical to or different from each other.

As an example, the first, second, third, and fourth SRS resource sets may include three (for example, first to third SRS resources), two (for example, fourth and fifth SRS resources), two (for example, sixth and seventh SRS resources), and one (for example, eighth SRS resource), respectively, and other combinations may not be excluded.

### 2T6R

In relation to the UE's 2T6R operation, similar to a combination including at least one of the following details, the UE may receive a higher layer signaling configuration from the BS and may perform a 2T6R operation accordingly.

The UE may have a maximum of one (that is, 0 or 1) SRS resource set having a resource Type value of “periodic” in SRS-ResourceSet (higher layer signaling) configured by the BS, and the one SRS resource set may include three SRS resources. Each SRS resource may be made up of two SRS ports, respective SRS resources may be transmitted at different OFDM symbol locations in identical or different slots, and the two SRS ports of respective SRS resources may be connected to different UE antenna ports.

The UE may receive a configuration regarding an SRS resource set having a resource Type value of “semi-persistent” in SRS-ResourceSet (higher layer signaling) from the BS as follows:

If the UE has not reported srs-AntennaSwitching2SP-1Periodic-r17 which is a UE capability report, the UE may have a maximum of one (that is, 0 or 1) SRS resource set having a resourceType value of “semi-persistent” in SRS-ResourceSet (higher layer signaling) configured by the BS.

If the UE has reported srs-AntennaSwitching2SP-1Periodic-r17 which is a UE capability report, the UE may have a maximum of two (that is, 0, 1, or 2) SRS resource sets having a resourceType value of “semi-persistent” in SRS-ResourceSet (higher layer signaling) configured by the BS, and two SRS resource sets having a resourceType value of “semi-persistent” in SRS-ResourceSet (higher layer signaling) may not be activated simultaneously.

One SRS resource set may include three SRS resources, and each SRS resource may be made up of two SRS ports. Respective SRS resources may be transmitted at different OFDM symbol locations in identical or different slots, and the two SRS ports of respective SRS resources may be connected to different UE antenna ports.

The UE may have a maximum of three (that is, 0, 1, 2, or 3) SRS resource sets having a resourceType value of “aperiodic” in SRS-ResourceSet (higher layer signaling) configured by the BS.

If there is one SRS resource set configured, three SRS resources may be included therein, and each SRS resource may be made up of two SRS ports. Respective SRS resources may be transmitted at different OFDM symbol locations in the same slot, and the two SRS ports of respective SRS resources may be connected to different UE antenna ports.

If there are two SRS resource sets configured, a total of three SRS resources may be divided and included in the two SRS resource sets, and each SRS resource may be made up of two SRS ports. All SRS resources in respective SRS resource sets may be transmitted at different OFDM symbol locations in the same slot, SRS transmission regarding different SRS resource sets may be performed at identical or different OFDM symbol locations of different slots, and the two SRS ports of respective SRS resources may be connected to different UE antenna ports.

As an example, the UE may include first and second SRS resources in the first SRS resource set and may include a third SRS resource in the second SRS resource set. Transmission regarding the first and second SRS resources in the first SRS resource set may be performed at first and second OFDM symbol locations in a first slot, and the first and second OFDM symbol locations may be different from each other. Transmission regarding the third SRS resource in the second SRS resource set may be performed at a third OFDM symbol location in a second slot. The first and second slot locations may be different from each other, and the first and second OFDM symbol locations and the third OFDM symbol location may be identical to or different from each other.

As an example, the first and second SRS resource sets may include one (for example, first SRS resource) and two (for example, second and third SRS resources), respectively, and other combinations may not be excluded.

If there are three SRS resource sets configured, a total of three SRS resources may be divided and included in the three SRS resource sets, and each SRS resource may be made up of two SRS ports. All SRS resources in respective SRS resource sets may be transmitted at different OFDM symbol locations in the same slot, SRS transmission regarding different SRS resource sets may be performed at identical or different OFDM symbol locations of different slots, and the two SRS ports of respective SRS resources may be connected to different UE antenna ports.

As an example, the UE may include a first SRS resource in the first SRS resource set, may include a second SRS resource in the second SRS resource set, and may include a third SRS resource in the third SRS resource set. Transmission regarding the first SRS resource in the first SRS resource set may be performed at a first OFDM symbol location in a first slot. Transmission regarding the second SRS resource in the second SRS resource set may be performed at a second OFDM symbol location in a second slot. Transmission regarding the third SRS resource in the third SRS resource set may be performed at a third OFDM symbol location in a third slot. The first, second, and third slot locations may be different from each other, and the first to third OFDM symbol locations may be identical to or different from each other.

### 2T8R

In relation to the UE's 2T8R operation, similar to a combination including at least one of the following details, the UE may receive a higher layer signaling configuration from the BS, and may perform a 2T8R operation accordingly.

The UE may have a maximum of one (that is, 0 or 1) SRS resource set having a resource Type value of “periodic” in SRS-ResourceSet (higher layer signaling) configured by the BS, and the one SRS resource set may include four SRS resources. Each SRS resource may be made up of two SRS ports, respective SRS resources may be transmitted at different OFDM symbol locations in identical or different slots, and the two SRS ports of respective SRS resources may be connected to different UE antenna ports.

The UE may receive a configuration regarding an SRS resource set having a resource Type value of “semi-persistent” in SRS-ResourceSet (higher layer signaling) from the BS as follows:

If the UE has not reported srs-AntennaSwitching2SP-1Periodic-r17 which is a UE capability report, the UE may have a maximum of one (that is, 0 or 1) SRS resource set having a resourceType value of “semi-persistent” in SRS-ResourceSet (higher layer signaling) configured by the BS.

If the UE has reported srs-AntennaSwitching2SP-1Periodic-r17 which is a UE capability report, the UE may have a maximum of two (that is, 0, 1, or 2) SRS resource sets having a resourceType value of “semi-persistent” in SRS-ResourceSet (higher layer signaling) configured by the BS, and two SRS resource sets having a resourceType value of “semi-persistent” in SRS-ResourceSet (higher layer signaling) may not be activated simultaneously.

One SRS resource set may include four SRS resources, and each SRS resource may be made up of two SRS ports, respective SRS resources may be transmitted at different OFDM symbol locations in identical or different slots, and the two SRS ports of respective SRS resources may be connected to different UE antenna ports.

The UE may have 0, 2, 3, or 4 SRS resource sets having a resourceType value of “aperiodic” in SRS-ResourceSet (higher layer signaling) configured by the BS.

If there is one SRS resource set configured, four SRS resources may be included therein, each SRS resource may be made up of two SRS ports, respective SRS resources may be transmitted at different OFDM symbol locations in the same slot, and the two SRS ports of respective SRS resources may be connected to different UE antenna ports.

If there are two SRS resource sets configured, a total of four SRS resources may be divided and included in the two SRS resource sets, and each SRS resource may be made up of two SRS ports. All SRS resources in respective SRS resource sets may be transmitted at different OFDM symbol locations in the same slot, SRS transmission regarding different SRS resource sets may be performed at identical or different OFDM symbol locations of different slots, and the two SRS ports of respective SRS resources may be connected to different UE antenna ports.

As an example, the UE may include first and second SRS resources in the first SRS resource set, and may include third and fourth SRS resources in the second SRS resource set. Transmission regarding the first and second SRS resources in the first SRS resource set may be performed at first and second OFDM symbol locations in a first slot, and the first and second OFDM symbol locations may be different from each other. Transmission regarding the third and fourth SRS resources in the second SRS resource set may be performed at third and fourth OFDM symbol locations in a second slot, and the third and fourth OFDM symbol locations may be different from each other. The first and second slot locations may be different from each other, and the first and second OFDM symbol locations and the third and fourth OFDM symbol locations may be identical to or different from each other.

As an example, the first and second SRS resource sets may include one (for example, first SRS resource) and three (for example, second to fourth SRS resources), respectively, and other combinations may not be excluded.

If there are three SRS resource sets configured, a total of four SRS resources may be divided and included in the three SRS resource sets, and each SRS resource may be made up of two SRS ports. All SRS resources in respective SRS resource sets may be transmitted at different OFDM symbol locations in the same slot, SRS transmission regarding different SRS resource sets may be performed at identical or different OFDM symbol locations of different slots, and the two SRS ports of respective SRS resources may be connected to different UE antenna ports.

As an example, the UE may include first and second SRS resources in the first SRS resource set, may include a third SRS resource in the second SRS resource set, and may include a fourth SRS resource in the third SRS resource set. Transmission regarding the first and second SRS resources in the first SRS resource set may be performed at first and second OFDM symbol locations in a first slot, and the first and second OFDM symbol locations may be different from each other. Transmission regarding the third SRS resource in the second SRS resource set may be performed at a third OFDM symbol location in a second slot. Transmission regarding the fourth SRS resource in the third SRS resource set may be performed at a fourth OFDM symbol location in a third slot. The first, second, and third slot locations may be different from each other, and the first to fourth OFDM symbol locations may be identical to or different from each other.

As an example, the first, second, and third SRS resource sets may include one (for example, first SRS resource), two (for example, second and third SRS resources), and one (for example, fourth SRS resource), respectively, and other combinations may not be excluded.

If there are four SRS resource sets configured, a total of four SRS resources may be divided and included in the four SRS resource sets, and each SRS resource may be made up of two SRS ports. All SRS resources in respective SRS resource sets may be transmitted at different OFDM symbol locations in the same slot, SRS transmission regarding different SRS resource sets may be performed at identical or different OFDM symbol locations of different slots, and the two SRS ports of respective SRS resources may be connected to different UE antenna ports.

As an example, the UE may include first, second, third, and fourth SRS resources in the first, second, third, and fourth SRS resource sets, respectively, and transmission regarding the first, second, third, and fourth SRS resources in the first, second, third, and fourth SRS resource sets may be performed at first, second, third, and fourth OFDM symbol locations in first, second, third, and fourth slots, respectively. The first to fourth slot locations may be different from each other, and the first to fourth OFDM symbol locations may be identical to or different from each other.

### 4T8R

In relation to the UE's 4T8R operation, similar to a combination including at least one of the following details, the UE may receive a higher layer signaling configuration from the BS and may perform a 4T8R operation accordingly.

If the UE has not reported srs-AntennaSwitching2SP-1Periodic-r17 which is a UE capability report,

The UE may have a maximum of two (for example, 0, 1, or 2) different SRS resource sets having a resourceType value of “periodic” or “semi-persistent” in SRS-ResourceSet (higher layer signaling) configured by the BS. As an example, the UE may have one of the following details configured by the BS.
No configured SRS resource set having a resourceType value of “periodic” or “semi-persistent” in SRS-ResourceSet (higher layer signaling)
One SRS resource set having a resourceType value of “periodic” in SRS-ResourceSet (higher layer signaling)
One SRS resource set having a resourceType value of “semi-persistent” in SRS-ResourceSet (higher layer signaling)
One SRS resource set having a resourceType value of “periodic” in SRS-ResourceSet (higher layer signaling) and one SRS resource set having a resourceType value of “semi-persistent” therein

In the above details, each SRS resource set may include two SRS resources, and each SRS resource may be made up of four SRS ports. Respective SRS resources may be transmitted at different OFDM symbol locations in identical or different slots, and the four SRS ports of respective SRS resources may be connected to different UE antenna ports.

If the UE has reported srs-AntennaSwitching2SP-1Periodic-r17 which is a UE capability report, the UE may have a maximum of two (that is, 0, 1, or 2) SRS resource sets having a resourceType value of “semi-persistent” in SRS-ResourceSet (higher layer signaling) configured by the BS, the UE may have a maximum of one (that is, 0 or 1) SRS resource set having a resourceType value of “periodic” in SRS-ResourceSet (higher layer signaling) configured by the BS, and two SRS resource sets having a resourceType value of “semi-persistent” in SRS-ResourceSet (higher layer signaling) may not be activated simultaneously.

Each SRS resource set may include two SRS resources, and each SRS resource may be made up of four SRS ports. Respective SRS resources may be transmitted at different OFDM symbol locations in identical or different slots, and the four SRS ports of respective SRS resources may be connected to different UE antenna ports.

The UE may have 0, 1, or 2 SRS resource sets having a resourceType value of “aperiodic” in SRS-ResourceSet (higher layer signaling) configured by the BS.

If there is one SRS resource set configured, two SRS resources may be included therein, and each SRS resource may be made up of four SRS ports. Respective SRS resources may be transmitted at different OFDM symbol locations in the same slot, and the four SRS ports of respective SRS resources may be connected to different UE antenna ports.

If there are two SRS resource sets configured, a total of two SRS resources may be divided and included in the two SRS resource sets, and each SRS resource may be made up of four SRS ports. All SRS resources in respective SRS resource sets may be transmitted at different OFDM symbol locations in the same slot, SRS transmission regarding different SRS resource sets may be performed at identical or different OFDM symbol locations of different slots, and the four SRS ports of respective SRS resources may be connected to different UE antenna ports.

As an example, the UE may include first and second SRS resources in the first and second SRS resource sets, respectively, transmission regarding the first and second SRS resources in the first and second SRS resource sets may be performed at first and second OFDM symbol locations in first and second slots, respectively. The first and second slot locations may be different from each other, and the first and second OFDM symbol locations may be identical to or different from each other.

When the UE performs an antenna switching operation, that is, when the UE transmits different SRS resources connected to different antenna port(s), the time interval between two adjacent SRS resources among all transmitted SRS resources generally needs to be about 15 μs. In consideration of this, a minimum guard period may be defined as in Table 26 below.

TABLE 26

| μ | Δf = 2^{μ} · 15 [kHz] | Y [symbol] |
|---|---|---|
| 0 | 15 | 1 |
| 1 | 30 | 1 |
| 2 | 60 | 1 |
| 3 | 120 | 2 |

In Table 26, μ may refer to numerology, Δf may refer to a subcarrier spacing, and Y may refer to the number of OFDM symbols expressing the guard period, that is, the time length of the guard period. The guard period may be configured based on parameter μ which determines numerology. In the guard period, the UE is configured not to transmit any other signals, and the guard period may be configured to be entirely used for antenna switching.

As an example, the guard period may be configured between transmission timepoints of two adjacent SRS resources in consideration of SRS resources transmitted at different OFDM symbol location in the same slot.

As an example, if the UE has two SRS resource sets configured for antenna switching usage, if the two SRS resource sets have been configured or triggered to be transmitted in two consecutive slots, and if the UE has reported UE capability to indicate that the UE is capable of transmitting an SRS at all OFDM symbol locations in a slot, the UE may expect that a guard period for antenna switching will exist as many as a minimum of Y OFDM symbols, based on Table 26, between the last OFDM symbol used to perform SRS transmission in the first slot used to perform SRS transmission regarding the first SRS resource set and the first OFDM symbol used to perform SRS transmission in the second slot used to perform SRS transmission regarding the second SRS resource set. That is, the actual time difference between two SRS transmissions may be greater than or equal to the number (Y) of OFDM symbols.

In such an inter-slot guard period, similarly to the above-described guard period between two SRS resources in a slot, if the actual time difference between the last SRS transmission of the first slot and the first SRS transmission of the next slot in two consecutive slots corresponds to the number (Y) of OFDM symbols, the UE may not transmit any signal in the period corresponding to Y OFDM symbols.

In such an inter-slot guard period, if the actual time difference between the last SRS transmission of the first slot and the first SRS transmission of the next slot in two consecutive slots corresponds to the number (Y) of OFDM symbols, and if SRS transmissions before and after the inter-slot guard period are all dropped (all canceled) due to overlapping with other signals, the UE may apply the same priority as the SRS transmissions before and after the guard period to the inter-slot guard period defined by the number (Y) of OFDM symbols and may thus determine that the SRS transmissions have been dropped (canceled) The UE may perform uplink transmission in the inter-slot guard period if the SRS transmissions are deemed to be dropped.

As to all antenna switching schemes described above, the UE may expect that all SRS resources in all SRS resource sets having a usage (higher layer signaling) configured to be “antennaSwitching” in the SRS resource sets by the BS will have the same number of SRS ports configure therefor.

As to the above-described antenna switching schemes based on 1T2R, 1T4R, 2T4R, 1T6R, 1T8R, 2T6R, 2T8R, and 4T8R operations, the UE may not expect that two or more of SRS resource sets having a usage (higher layer signaling) configured to be “antennaSwitching” by the BS will be configured or triggered in the same slot.

As to the above-described antenna switching schemes based on 1T1R, 2T2R, and 4T4R operations, the UE may not expect that two or more of SRS resource sets having a usage (higher layer signaling) configured to be “antennaSwitching” by the BS will be configured or triggered in the same OFDM symbol.

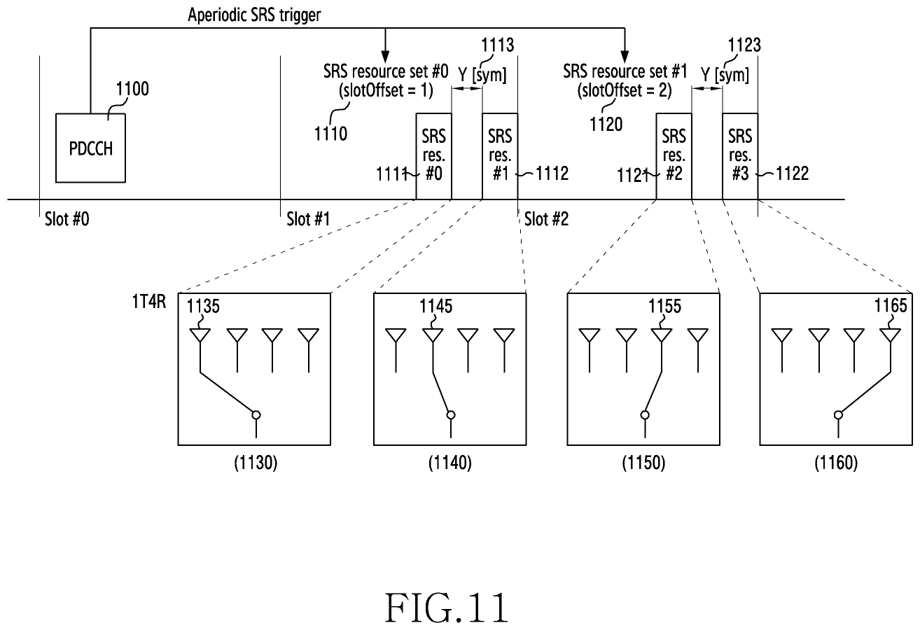

FIG. 11 illustrates an SRS antenna switching operation according to an embodiment.

Referring to FIG. 11, a situation is provided in which the UE operates according to 1T4R and has two aperiodic SRS resource sets (for example, SRS resource sets #0 and #1) configured therefor. The UE may receive a PDCCH 1100 from the BS, and may receive an aperiodic SRS trigger indication regarding SRS resource set #0 1110 and SRS resource set #1 1120 through the PDCCH. The slot offset value regarding SRS resource set #0 1110 may be configured through slotOffset (higher layer signaling), which has a value of 1, and aperiodic SRS transmission regarding SRS resource set #0 may be performed at a location one slot after the slot in which the PDCCH has been received (that is, in slot #1). The slot offset value regarding SRS resource set #1 1120 may be configured through slotOffset (higher layer signaling), which has a value of 2, and aperiodic SRS transmission regarding SRS resource set #1 may be performed at a location two slots after the slot in which the PDCCH has been received (that is, in slot #2).

SRS resource #0 1111 and SRS resource #1 1112 included in SRS resource set #0 1110 may be transmitted at different OFDM symbol locations in slot #1, and Y OFDM symbols may exist between SRS resources #0 and #1 as a guard period 1113. In addition, during transmission 1130 regarding SRS resource #0, the UE may connect one SRS port to the first reception antenna port 1135 of the UE, thereby performing SRS transmission. During transmission 1140 regarding SRS resource #1, the UE may connect one SRS port to the second reception antenna port 1145 of the UE, thereby performing SRS transmission.

SRS resource #2 1121 and SRS resource #3 1122 included in SRS resource set #1 1120 may be transmitted at different OFDM symbol locations in slot #1, and Y OFDM symbols may exist between SRS resources #2 and #3 as a guard period 1123. In addition, during transmission 1150 regarding SRS resource #2, the UE may connect one SRS port to the third reception antenna port 1155 of the UE, thereby performing SRS transmission. During transmission 1160 regarding SRS resource #3, the UE may connect one SRS port to the fourth reception antenna port 1165 of the UE, thereby performing SRS transmission.

By connecting the above-described four SRS resources #0 to #3 to different reception antenna ports of the UE and then transmitting an SRS, the UE may transmit an SRS from all different reception antenna ports to acquire information regarding channels connected to all reception antennas of the UE, and the BS may acquire information regarding channels between the BS and the UE therefrom and may utilize the information for uplink or downlink scheduling.

### UE Capability Report

In LTE and NR, a UE may perform a procedure in which, while being connected to a serving base station, the UE reports capability supported by the UE to the corresponding base station. In the following description, the above-described procedure will be referred to as a UE capability report.

The base station may transfer a UE capability enquiry message to the UE in a connected state to request a capability report. The message may include a UE capability request in each radio access technology (RAT) type of the base station. The RAT type-specific request may include supported frequency band combination information and the like. In addition, in the case of the UE capability enquiry message, UE capability in multiple RAT types may be requested through one RRC message container transmitted by the base station, or the base station may transfer a UE capability enquiry message including multiple UE capability requests in respective RAT types. That is, a capability enquiry may be repeated multiple times in one message, and the UE may configure a UE capability information message corresponding thereto and report the message multiple times. In next-generation mobile communication systems, a UE capability request may be made regarding multi-RAT DC (MR-DC), such as NR, LTE, E-UTRA-NR DC (EN-DC). The UE capability enquiry message may be transmitted initially after the UE is connected to the base station, in general, but may be requested in any condition if needed by the base station.

Upon receiving the UE capability report request from the base station in the above step, the UE may configure UE capability according to band information and RAT type requested by the base station. The method in which the UE configures UE capability in an NR system is summarized below:

1. If the UE receives a list regarding LTE and/or NR bands from the base station at a UE capability request, the UE may construct band combinations (BCs) regarding EN-DC and NR standalone (SA). That is, the UE may configure a candidate list of BCs regarding EN-DC and NR SA, based on bands received from the base station at a request through FreqBandList. The priority of bands follows the order described in FreqBandList.

2. If the base station sets “eutra-nr-only” flag or “eutra” flag and requests a UE capability report, the UE removes everything related to NR SA BCs from the configured BC candidate list. Such an operation may occur only if an LTE base station (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC. Since a BC before removal of the band corresponding to at least one SCell can already cover a fallback BC, the step 3 may be omitted. This step is applied in MR-DC as well, that is, LTE bands are also applied. BCs remaining after the above step may constitute the final “candidate BC list”.

4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra). → (nr->eutra-nr->eutra) The UE configures featureSetCombination regarding the configured supportedBandCombinationList and configures a list of “candidate feature set combinations” from a candidate BC list from which a list regarding fallback BCs (including capability of the same or lower level) is removed. The “candidate feature set combinations” may include all feature set combinations regarding NR and EUTRA-NR BCs, and may be provided from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities. After the UE capability is configured, the UE may transfer a UE capability information message including the UE capability to the base station. The base stations performs scheduling and transmission/reception management appropriate for the UE, based on the UE capability received from the UE.

### Non-Coherent Joint Transmission (NC-JT)

NC-JT may be used for a UE to receive a PDSCH from multiple TRPs.

Unlike legacy systems, 5G wireless communication systems may support not only services that require high transmission rates, but also services having a very short transmission delay and services requiring a high connection density. In a wireless communication network including multiple cells, transmission and reception points (TRPs), or beams, coordinated transmission between respective cells, TRPs, and/or beams may satisfy various service requirements by increasing the intensity of signals received by the UE or by efficiently controlling interference between respective cells, TRPs, and/or beams.

Joint transmission (JT) refers to a representative transmission technology for the above-described coordinated transmission wherein signals are transmitted to one UE through multiple different cells, TRPs, and/or beams, thereby increasing the intensity of signals received by the UE, or the throughput. The channels between respective cells, TRPs, and/or beams and the UE may significantly different characteristics. Particularly, in the case of C-JT supporting non-coherent precoding between respective cells, TRPs, and/or beams, individual precoding, MCS, resource assignment, TCI indication, or the like may be necessary according to link-specific channel characteristics between respective cells, TRPs, and/or beams and the UE.

The above-described NC-JT transmission may be applied to at least one channel from among a PDSCH, a PDCCH, a PUSCH, and a PUCCH. During PDSCH transmission, transmission information such as precoding, MCS, resource assignment, and TCI is indicated by DL DCI and, for the sake of NC-JT transmission, the transmission information needs to be indicated individually in each cell, TRP, and/or beam. This is a major factor increasing the payload necessary for DL DCI transmission, and this may adversely affect the reception performance of the PDCCH for transmitting DCI. Therefore, for the PDSCH's JT support, the tradeoff between the amount of DCI information and the control information reception performance needs to be designed carefully.

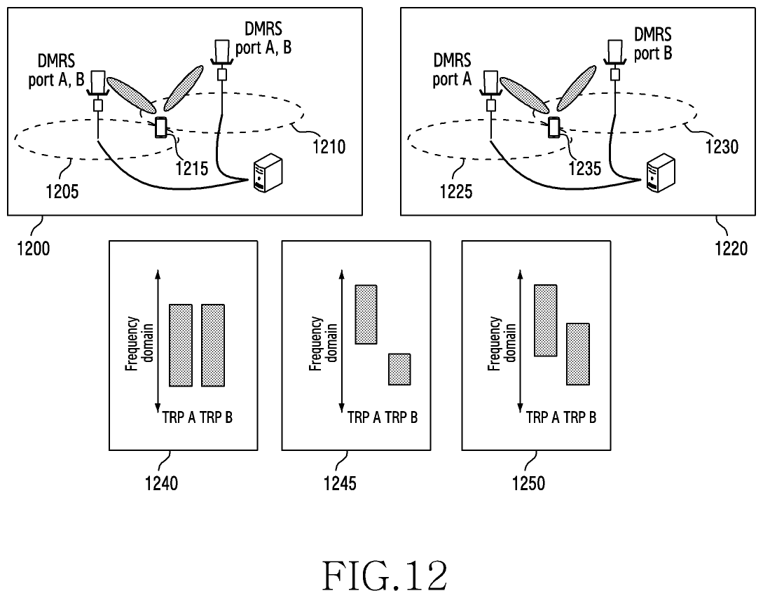

FIG. 12 illustrates an example of antenna port configuration and resource assignment for transmitting a PDSCH by using cooperative communication in a wireless communication system according to an embodiment.

Referring to FIG. 12, an example for PDSCH transmission will be described in each JT, and examples for assigning a radio resource in each TRP are illustrated.

FIG. 12 illustrates an example 1200 of coherent joint transmission (C-JT) supporting coherent precoding between respective cells, TRPs, and/or beams.

In the case of C-JT, TRP A 1205 and TRP B 1210 may transmit a PDSCH to the UE 1215, and multiple TRPs may perform joint precoding. This may indicate that, in order for TRP A 1205 and TRP B 1210 to transmit the same PDSCH, a DMRS is transmitted through the same DMRS ports. For example, each of TRP A 1205 and TRP B 1210 may transmit a DMRS to the UE through DMRS port A and DMRS port B. In this case, the UE may receive one piece of DCI information for receiving one PDSCH demodulated based on the DMRS transmitted through DMRS port A and DMRS port B.

FIG. 12 illustrates an example 1220 of non-coherent joint transmission (C-JT) supporting non-coherent precoding between respective cells, TRPs, and/or beams for the sake of PDSCH transmission.

In the case of NC-JT, respective cells, TRPs (e.g., TRP A 1225 and TRP B 1230), and/or beams transmit PDSCHs to the UE 1235, and individual precoding may be applied to respective PDSCHs. Respective cells, TRPs, and/or beams may transmit different PDSCHs or different PDSCH layers to the UE, thereby improving the throughput compared with single cell, TRP, and/or beam transmission. In addition, respective cells, TRPs, and/or beams may repeatedly transmit the same PDSCH to the UE, thereby improving the reliability compared with single cell, TRP, and/or beam transmission. For convenience of description, cells, TRPs, and/or beams will hereinafter be referred to as TRPs as a whole.

Various types of radio resource assignment may be considered as in the case 1240 in which frequency and time resources used by multiple TRPs for the sake of PDSCH transmission are all identical, the case 1245 in which frequency and time resources used by multiple TRPs never overlap, and the case 1250 in which frequency and time resources used by multiple TRPs partially overlap.

To support NC-JT, DCI in various types, structures, and relations may be considered such that multiple PDSCHs are simultaneously assigned to one UE.

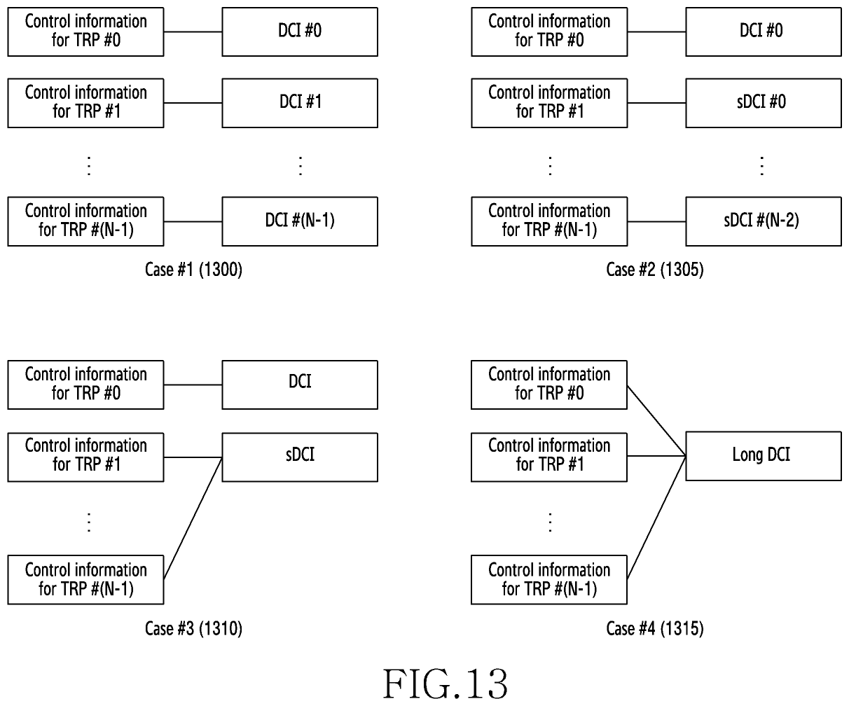

FIG. 13 illustrates an example of the configuration of DCI for NC-JT such that respective TRPs transmit different PDSCHs or different PDSCH layers to a UE in a wireless communication system according to an embodiment.

Referring to FIG. 13, case #1 1300 corresponds to when, besides the serving TRP (TRP #0) used during single PDSCH transmission, (N−1) additional TRPs (TRP #1 to TRP #(N−1)) transmit (N−1) different PDSCHs, and control information regarding the PDSCHs transmitted by the (N−1) additional TRPs is transmitted independently of control information regarding the PDSCH transmitted by the serving TRP. That is, the UE may acquire control information regarding PDSCHs transmitted from different TRPs (TRP #0 to TRP #(N−1)) through independent DCIs (DCI #0 to DCI #(N−1)). The independent DCIs may have identical or different formats, and the DCIs may have identical or different payloads. In the above-described case #1, respective PDSCHs may be controlled or assigned with a fully guaranteed degree of freedom. However, if different TRPs transmit respective DCIs, a difference in coverage between respective DCIs may occur, thereby degrading the reception performance.

Case #2 1305 corresponds to when, besides the serving TRP (TRP #0) used during single PDSCH transmission, (N−1) additional TRPs (TRP #1 to TRP #(N−1)) transmit (N−1) different PDSCHs, and respective DCIs regarding the PDSCHs of the (N−1) additional TRPs are transmitted while being dependent on DCI regarding the PDSCH transmitted from the serving TRP.

For example, DCI #0 which is control information regarding the PDSCH transmitted from the serving TRP (TRP #0) includes all information elements of DCI format 1_0, DCI format 1_1, and DCI format 1_2, but shortened DCI (hereinafter, referred to as sDCI) which is control information regarding the PDSCHs transmitted from the cooperative TRPs (TRP #1 to TRP #(N−1)) (sDCI #0 to sDCI #(N−2)) may include only some of the information elements of DCI format 1_0, DCI format 1_1, and DCI format 1_2. Therefore, the sDCI which transmits control information regarding the PDSCHs transmitted from the cooperative TRPs has a smaller payload than normal DCI (nDCI) which transmits control information regarding the PDSCH transmitted from the serving TRP, and thus may include reserved bits, compared with nDCI.

In the above-described case #2, the degree of freedom regarding control or assignment of respective PDSCHs may be limited according to the content of information elements included in sDCI, but sDCI has a better reception performance than nDCI, thereby decreasing the probability that a difference in coverage between respective DCIs will occur.

Case #3 1310 corresponds to when, besides the serving TRP (TRP #0) used during single PDSCH transmission, (N−1) additional TRPs (TRP #1 to TRP #(N−1)) transmit (N−1) different PDSCHs, one piece of control information regarding the PDSCHs of the (N−1) additional TRPs is transmitted, and this DCI is dependent on control information regarding the PDSCH transmitted from the serving TRP.

For example, DCI #0 which is control information regarding the PDSCH transmitted from the serving TRP (TRP #0) includes all information elements of DCI format 1_0, DCI format 1_1, and DCI format 1_2. In the case of control information regarding the PDSCHs transmitted from the cooperative TRPs (TRP #1 to TRP #(N−1)), only some of the information elements of DCI format 1_0, DCI format 1_1, and DCI format 1_2 may be gathered and transmitted in one “secondary” DCI (sDCI). For example, the sDCI may include at least one piece of information from among frequency domain resource assignment of cooperative TRPs, time domain resource assignment thereof, and HARQ-related information (for example, MCS). Furthermore, information not included in sDCI, such as a BWP indicator or a carrier indicator, may follow the serving TRP's DCI (DCI #0, normal DCI, nDCI).

In case #3 1310, the degree of freedom regarding control or assignment of respective PDSCHs may be limited according to the content of information elements included in sDCI, but the sDCI's reception performance can be adjusted, and the degree of complexity of the UE's DCI blind decoding may be reduced compared with case #1 1300 or case #2 1305.

Case #4 1315 corresponds to wen, besides the serving TRP (TRP #0) used during single PDSCH transmission, (N−1) additional TRPs (TRP #1 to TRP #(N−1)) transmit (N−1) different PDSCHs, and control information regarding the PDSCHs transmitted from the (N−1) additional TRPs is transmitted in the same DCI (long DCI) as control information regarding the PDSCH transmitted from the serving TRP. That is, the UE may acquire control information regarding PDSCHs transmitted from different TRPs (TRP #0 to TRP #(N−1)) through single DCI. In case #4 1315, the degree of complexity of the UE's DCI blind decoding may not increase, but the degree of freedom regarding control or assignment of respective PDSCHs may be low (for example, the number of cooperative TRPs is limited due to the limited long DCI payload).

Herein, sDCI may refer to various types of auxiliary DCI such as shortened DCI, secondary DCI, or normal DCI (above-described DCI format 1_0 or 1_1) including PDSCH control information transmitted from a cooperative TRP, and corresponding descriptions are similarly applicable to the various types of auxiliary DCI unless specified otherwise.

Herein, the above-described case #1 1300, case #2 1305, and case #3 1310 in which one or more DCIs (PDCCHs) are used to support NC-JT may be classified as NC-JT based on multiple PDCCHs, and the above-described case #4 1315 in which a single DCI (PDCCH) is used to support NC-JT may be classified as NC-JT based on a single PDCCH. In the case of PDSCH transmission based on multiple PDCCHs, the CORESET for scheduling DCI of the serving TRP (TRP #0) may be distinguished from the CORESET for scheduling DCI of the cooperative TRPs (TRP #1 to TRP #(N−1)). The CORESETs may be distinguished through the higher layer indicator of each CORESET, through the CORESET-specific beam configuration, and the like. In addition, in the case of NC-JT based on a single PDCCH, a single DCI schedules a single PDSCH having multiple layers, instead of scheduling multiple PDSCHs, and the multiple layers may be transmitted from multiple TRPs. The relation of connection between a layer and a TRP transmitting the layer may be indicated through a transmission configuration indicator (TCI) indication regarding the layer.

Herein, “cooperative TRP” may be replaced with various terms such as “cooperative panel” or “cooperative beam” during actual application.

The expression “when NC-JT is applied” may be variously interpreted according to the situation, such as “when a UE simultaneously receives one or more PDSCHs in one BWP”, “when a UE simultaneously receives a PDSCH, based on two or more transmission configuration indicator (TCI) indications, in one BWP”, “when a PDSCH received by a UE is associated with one or more DMRS port groups”, and the like, but one expression is used for convenience of description.

A radio protocol structure for NC-JT may be variously used herein according to a TRP deployment scenario. If the backhaul delay between cooperative TRPs is absent or small, a method which uses a structure based on MAC layer multiplexing (CA-like method) is possible, similarly to 410 in FIG. 4. On the other hand, if the backhaul delay between cooperative TRPs is too large to be disregarded (for example, if a time of 2 ms or longer is necessary to exchange information such as CSI, scheduling, or HARQ-ACK between cooperative TRPs), a method which uses a TRP-specific independent structure from the RLC layer, thereby securing characteristics robust against delay (DC-like method) is possible, similarly to 420 in FIG. 4.

A UE which supports C-JT and/or NC-JT may receive parameters, setting values, and the like regarding the C-JT and/or NC-JT from a higher layer configuration, and may set the UE's RRC parameter, based thereon. For the higher layer configuration, the UE may utilize a UE capability parameter, for example, tci-StatePDSCH. The UE capability parameter, for example, tci-StatePDSCH, may define TCI states for the purpose of PDSCH transmission. The number of TCI states may be configured to be 4, 8, 16, 32, 64, or 128 in the case of FR1, or to be 64, or 128 in the case of FR2. A maximum of eight states may be configured, which may be indicated by TCI field 3 bits of DCI through a MAC CE message, among the configured number of TCI states. The maximum value 128 refers to a value indicated by maxNumberConfiguredTCIstatesPerCC in parameter tci-StatePDSCH included in the UE's capability signaling. Such a series of configuration processes, ranging from higher layer configuration to MAC CE configuration, may be applied to a beamforming indication for at least one PDSCH in one TRP, or a beamforming change command.

### Multi-DCI-Based Multi-TRP

The multi-DCI-based multi-TRP transmission method may configure a downlink control channel for NC-JT transmission, based on a multi-PDCCH.

In the case of NC-JT based on multiple PDCCHs, when transmitting a DCI for each TRP's PDSCH schedule, the NC-JT may have CORESET or a search space distinguished for each TRP. The CORESET or search space for each TRP may be configured as in at least one of the following cases.

CORESET-specific higher layer index configuration: CORESET configuration information configured by a higher layer may include an index value, and the configured CORESET-specific index value may be used to distinguish a TRP which transmits a PDCCH in the CORESET. That is, it may be considered that, in a set of CORESETs having the same higher layer index value, the same TRP transmits a PDCCH, or that a PDCCH which schedules a PDSCH of the same TRP is transmitted. The above-described CORESET-specific index may be referred to as CORESETPoolIndex, and it may be considered that, in CORESETs having the same CORESETPoolIndex value configured therefor, a PDCCH is transmitted from the same TRP. It may be considered that, in the case of a CORESET having no CORESETPoolIndex value configured therefor, the default value of CORESETPoolIndex has been configured, and the default value may be 0.

If the type of CORESETPoolIndex held by each of multiple CORESETs included in PDCCH-Config (higher layer signaling) exceeds 1, that is, if each CORESET has a different CORESETPoolIndex, the UE may consider that the BS may use a multi-DCI-based multi-TRP transmission method.

To the contrary, if the type of CORESETPoolIndex held by each of multiple CORESETs included in PDCCH-Config (higher layer signaling) is 1, that is, if all CORESETs have the same CORESETPoolIndex of 0 or 1, the UE may consider that the BS performs transmission by using a single TRP without using the multi-DCI-based multi-TRP transmission method.

Multiple PDCCH-Config configuration: multiple PDCCH-Configs may be configured in one BWP, and each PDCCH-Config may include a TRP-specific PDCCH configuration. That is, one PDCCH-Config may have a TRP-specific CORESET list and/or a TRP-specific search space list configured therefor, and one or more CORESETs and one or more search spaces included in one PDCCH-Config may be deemed to correspond to a specific TRP.

CORESET beam/beam group configuration: a beam or beam group configured for each CORESET may be used to distinguish the TRP corresponding to the CORESET. For example, if multiple CORESETs have the same TCI state configured therefor, it may be considered that the CORESETs are transmitted through the same TRP, or that a PDCCH which schedules a PDCSH of the same TRP in the CORESETs is transmitted.

Search space beam/beam group configuration: a beam or beam group may be configured for each search space, and may be used to distinguish a TRP for each search space. For example, if multiple search spaces have the same beam/beam group or TCI state configured therefor, it may be considered that the same TRP transmits a PDCCH in the search spaces, or that a PDCCH which schedules a PDCSH of the same TRP in the search spaces is transmitted.

By distinguishing a CORESET or a search space for each TRP, PDSCH and HARQ-ACK information classification is possible for each TRP, thereby enabling TRP-specific independent HARQ-ACK codebook generation and independent PUCCH resource use.

The above-mentioned configuration may be independent in each cell or each BWP. For example, two different CORESETPoolIndex values may be configured for the PCell, but no CORESETPoolIndex value may be configured for a specific SCell. In this case, it may be considered that NC-JT transmission is configured for the PCell, but NC-JT transmission is not configured for the SCell having no CORESETPoolIndex value configured therefor.

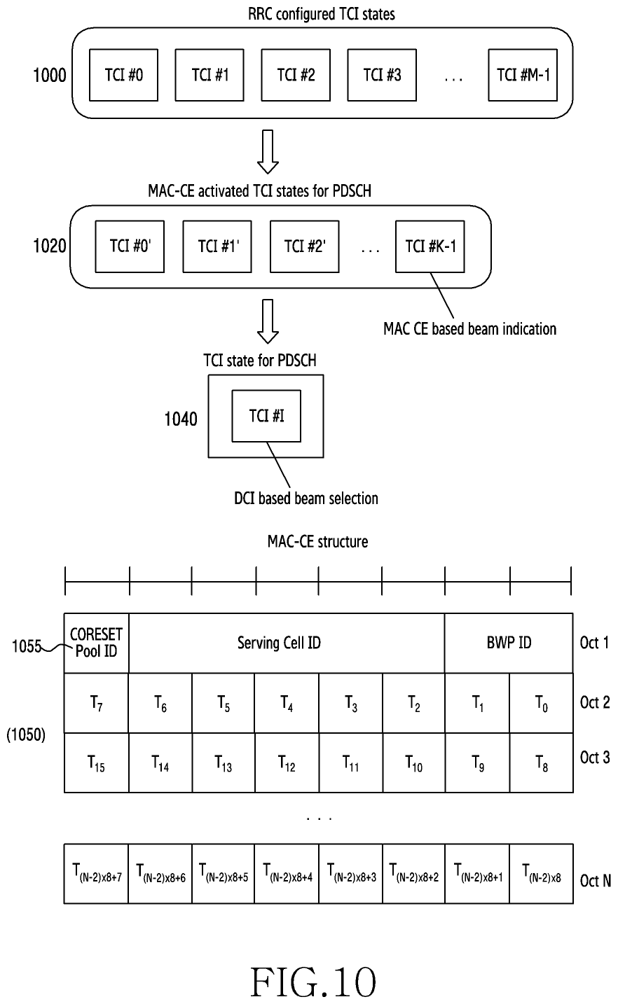

A PDSCH TCI state activation/deactivation MAC-CE applicable to the multi-DCI-based multi-TRP transmission method may follow FIG. 10. That is, if the UE has no CORESETPoolIndex configured in each of all CORESETs in PDCCH-Config (higher layer signaling), the UE may ignore the CORESET pool ID field 1055 in the MAC-CE 1050. If the UE can support the multi-DCI-based multi-TRP transmission method, that is, if the UE has different CORESETPoolIndex values regard to respective CORESETs in PDCCH-Config (higher layer signaling), the UE may activate the TCI state in the DCI included in the PDCCH transmitted from CORESETs having the same CORESETPoolIndex value as the CORESET pool ID field 1055 in the MAC-CE 1050. As an example, if the CORESET pool ID field 1055 in the MAC-CE 1050 is 0, the TCI state in the DCI included in the PDCCH transmitted from CORESETs, the CORESETPoolIndex of which is 0, may follow activation information of the corresponding MAC-CE.

If the UE is configured by the BS to be able to use the multi-DCI-based multi-TRP transmission method, that is, if the type CORESETPoolIndex held by each of multiple CORESETs included in PDCCH-Config (higher layer signaling) exceeds 1, or if respective CORESETs have different CORESETPoolIndex values, the UE may know that the following restrictions exist in PDSCHs scheduled from PDCCHs in respective CORESETs having two different CORESETPoolIndex values.
1) If PDSCHs indicated from PDCCHs in respective CORESETs having two different CORESETPoolIndex values overlap completely or partially, the UE may apply TCI states indicated from respective PDCCHs to different CDM groups, respectively. That is, two or more TCI states may not be applied to one CDM group.
2) If PDSCHs indicated from PDCCHs in respective CORESETs having two different CORESETPoolIndex values overlap completely or partially, the UE may expect that the number of actual front loaded DMRS symbols, the number of actional additional DMRS symbols, the location of actual DMRS symbols, and the DMRS type of respective PDSCHs will not differ from each other.
3) The UE may expect that BWPs and subcarrier spacings indicated from PDCCHs in respective CORESETs having two different CORESETPoolIndex values will be identical.
4) The UE may expect that information regarding PDSCHs scheduled from PDCCHs in respective CORESETs having two different CORESETPoolIndex values will be fully included in respective PDCCHs.

### Single-DCI-Based Multi-TRP

The single-DCI-based multi-TRP transmission method may configure a downlink control channel for NC-JT transmission, based on a single PDCCH.

In the single-DCI-based multi-TRP transmission method, one DCI may be used to schedule PDSCHs transmitted by multiple TRPs. The number of TCI states may be used to indicate the number of TRPs that transmit PDSCHs. That is, it may be considered that, if the number of TCI states indicated in the DCI which schedules PDSCHs is 2, the TCI state corresponds to single PDCCH-based NC-JT transmission and, if the number of TCI states is 1, the TCI state corresponds to single-TRP transmission. The TCI states indicated by DCI may correspond to one of TCI states activated by a MAC-CE, or two TCI states. If the TCI states of DCI correspond to two TCI states activated by a MAC-CE, there is a correspondence between the TCI codepoint indicated by DCI and the TCI states activated by a MAC-CE, and the TCI codepoint may correspond to two TCI states activated by a MAC-CE.

As an example, if at least one of all codepoints of a TCI state field in DCI indicates two TCI states, the UE may consider that the BS can perform transmission based on the single-DCI-based multi-TRP transmission method. At least one codepoint indicating two TCI states in the TCI state field may be activated through an enhanced PDSCH TCI state activation/deactivation MAC-CE.

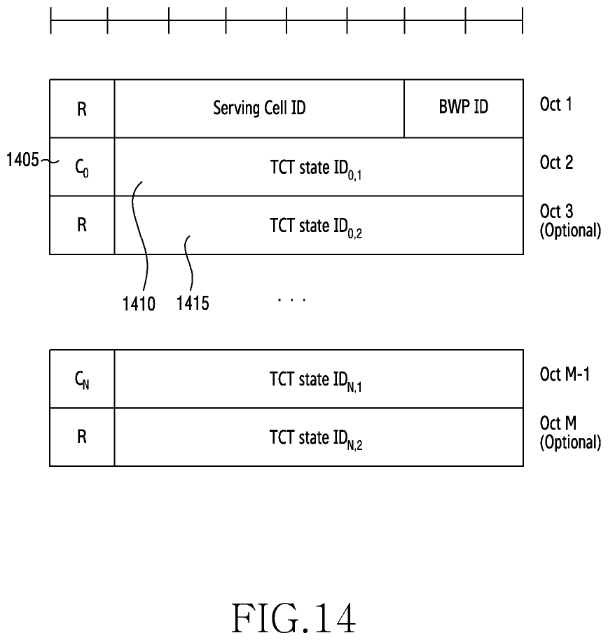

FIG. 14 illustrates an enhanced PDSCH TCI state activation/deactivation MAC-CE structure according to an embodiment. The respective fields in the MAC-CE and values that can be configured in respective fields are given in Table 27 below.

```
TABLE 27
  - Serving Cell ID: This field indicates the identity of the Serving Cell for which the MAC CE
applies. The lenth of the field is 5 bits. If the indicated Serving Cell is configured as part of a
simultaneousTCI-UpdateList1 or simultaneousTCI-UpdateList2 as specified in TS 38.331 [5], this
MAC CE applies to all the Serving Cells configured in the set simultaneousTCI-UpdateList1 or
simultaneousTCI-UpdateList2, respectively;
  - BWP ID: This field indicates a DL BWP for which the MAC CE applies as the codepoint of
the DCI bandwidth part indicator field as specified in TS 38.212 [9]. The length of the BWP ID field is
2 bits;
  - C_{I}: This field indicates whether the octet containing TCI state ID_{I,2} is present. If this field is
set to “1”, the octet containing TCI state ID_{i,2} is present. If this field is set to “0”, the octet containing
TCI state ID_{i,2} is not present;
  - TCI state ID_{i,j}: This field indicates the TCI state identified by TCI-StateID as specified in TS
38.331 [5], where i is the index of the codepoint of the DCI Transmission configuration indication field
as specified in TS 38.212 [9] and TCI state ID_{i,j} denotes the j-th TCI state indicated for the i-th
codepoint in the DCI Transmission Configuration Indication field. The TCI codepoint to which the TCI
States are mapped is determined by its ordinal position among all the TCI codepoints with sets of
TCI state ID_{i,j} fields, i.e. the first TCI codepoint with TCI state ID_{0,1} and TCI state ID_{0,2} shall be mapped
to the codepoint value 0, the second TCI codepoint with tTCI state ID_{1,1} and TCI state ID_{1,2} shall be
mapped to the codepoint value 1 and so on. The TCI state ID_{1,2} is optional based on the indication of
the CI field. The maximum number of activated TCI codepoint is 8 and the maximum number of TCI
states mapped to a TCI codepoint is 2.
  - R: Reserved bit, set to “0”.
```

Referring to FIG. 14, if the C₀ field 1405 has a value of 1, the MAC-CE may additionally include a TCI state ID_{0,2} field 1415 in the TCI state ID_{0,1} field 1410. This means that TCI state ID₀, 1 and TCI state ID_{0,2} are activated in the 0^{th} codepoint of the TCI state field included in the DCI. If the BS indicates the codepoint to the UE, two TCI states may be indicated to the UE. If the C₀ field 1405 has a value of 0, the MAC-CE cannot include the TCI state ID_{0,2} field 1415. This means that one TCI state corresponding to TCI state ID₀, 1 is activated in the 0^{th} codepoint of the TCI state field included in the DCI.

The above-mentioned configuration may be independent in each cell or each BWP. For example, a maximum of two activated TCI states may correspond to one TCI codepoint in the PCell, but a maximum of one activated TCI state may correspond to one TCI codepoint in a specific SCell. In this case, it may be considered that NC-JT transmission is configured for the PCell, but NC-JT transmission is not configured for the above-mentioned SCell.

### Single-DCI-Based Multi-TRP PDSCH Repetitive Transmission Scheme (TDM/FDM/SDM) Distinction Method

According to values indicated by DCI fields and higher layer signaling configurations from the BS, different single-DCI-based multi-TRP PDSCH repetitive transmission schemes (for example, TDM, FDM, SDM) may be indicated to the UE. Table 28 below illustrates a method for distinguishing single- or multi-TRP-based techniques indicated to the UE according to specific DCI field values and higher layer signaling configurations.

TABLE 28

| | | | repetitionNumber | | Transmission |
|---|---|---|---|---|---|
| | Number | Number | configuration and | Regarding | technique |
| | of TCI | of CDM | indication | repetitionScheme | indicated |
| Combination | states | groups | condition | configuration | to UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP |
| | | | | | FDM scheme A/ |
| | | | | | FDM scheme B/ |
| | | | | | TDM scheme A |
| 9 | 2 | 1 | Condition 1 | Not configured | Multi-TRP |
| | | | | | TDM scheme B |

In Table 28 above, descriptions of respective columns are as follows:

Number of TCI states (second column): refers to the number of TCI states indicated by the TCI state field in the DCI, and may be 1 or 2.

Number of CDM groups (third column): refers to the number of different CDM groups of DMRS ports indicated by the antenna port field in the DCI, and may be 1, 2, or 3.

repetitionNumber configuration and indication condition (fourth column): may have three conditions according to whether repetitionNumber is configured in all TDRA entries which may be indicated by the time domain resource allocation field in the DCI, and whether an actually indicated TDRA entry has a repetitionNumber configuration.

Condition 1: at least one of all TDRA entries which may be indicated by the time domain resource allocation field includes a configuration regarding repetitionNumber, and the TDRA entry indicated by the time domain resource allocation field in the DCI includes a configuration regarding repetitionNumber greater than 1

Condition 2: at least one of all TDRA entries which may be indicated by the time domain resource allocation field includes a configuration regarding repetitionNumber, and the TDRA entry indicated by the time domain resource allocation field in the DCI includes no configuration regarding repetitionNumber

Condition 3: all TDRA entries which may be indicated by the time domain resource allocation field includes no configuration regarding repetitionNumber

repetitionScheme configuration (fifth column): indicates whether repetitionScheme (higher layer signaling) is configured. One of “tdmSchemeA”, “fdmSchemeA”, and “fdmSchemeB” may be configured as the repetitionScheme (higher layer signaling).

Transmission technique indicated to UE (sixth column): refers to single or multiple TRP schemes indicated by each combination (first column) expressed in [Table 28] above.

Single-TRP: refers to single TRP-based PDSCH transmission. If the UE has pdsch-AggegationFactor in PDSCH-config (higher layer signaling) configured therefor, the configured number of single TRP-based PDSCH repetitive transmissions may be scheduled for the UE. Otherwise, single TRP-based PDSCH single transmission may be scheduled for the UE.

Single-TRP TDM scheme B: refers to time resource division-based PDSCH repetitive transmission between single TRP-based slots. According to above-described repetitionNumber-related Condition 1, the UE repeatedly transmits a PDSCH on the time resource as many slots as the repetitionNumber configured for the TDRA entry indicated by the time domain resource allocation field, which is greater than 1. The PDSCH's start symbol and symbol length indicated by the TDRA entry are equally applied to respective slots, the number of which corresponds to the repetitionNumber, and the same TCI state is applied to each PDSCH repetitive transmission. This technique is similar to a slot aggregation scheme in that inter-slot PDSCH repetitive transmission is performed on the time resource but is different from the slot aggregation in that it is possible to dynamically determine whether to indicate repetitive transmission, based on the time domain resource allocation field in the DCI.

Multi-TRP SDM: refers to a multi-TRP-based space resource division PDSCH transmission scheme. This method divides and receives layers from respective TRPs, and may increase the reliability of PDSCH transmission in that, although it is not a repetitive transmission scheme, transmission can be made with a reduced coding rate by increasing the number of layers. The UE may apply two TCI states indicated through the TCI state field in the DCI to two CDM groups indicated by the BS, respectively, thereby receiving a PDSCH.

Multi-TRP FDM scheme A: refers to a multi-TRP-based frequency resource division PDSCH transmission scheme, and has one PDSCH transmission occasion such that, although it is not repetitive transmission as in the case of multi-TRP SDM, transmission can be made with high reliability by increasing the amount of frequency resources and thus lowering the coding rate. Multi-TRP FDM scheme A may apply two TCI states indicated through the TCI state field in the DCI to frequency resources which do not overlap each other, respectively. If the PRB bundling size is determined to be “wideband”, and if the number of RBs indicated by the frequency domain resource allocation field is N, the UE receives the first ceil (N/2) RBs by applying the first TCI state, and receives the remaining floor (N/2) RBs by applying the second TCI state. As used herein, ceil (⋅) and floor (⋅) are operators indicating rounding up and down at the first decimal place, respectively. If the RPB bundling size is determined to be 2 or 4, even-numbered PRGs are received by applying the first TCI state, and odd-numbered PRGs are received by applying the second TCI state.

Multi-TRP FDM scheme B: refers to a multi-TRP-based frequency resource division PDSCH transmission scheme, and has two PDSCH transmission occasions such that the PDSCH can be repeatedly transmitted at respective occasions. Identically to multi-TRP FDM scheme A, multi-TRP FDM scheme B may apply two TCI states indicated through the TCI state field in the DCI to frequency resources which do not overlap each other, respectively. If the PRB bundling size is determined to be “wideband”, and if the number of RBs indicated by the frequency domain resource allocation field is N, the UE receives the first ceil (N/2) RBs by applying the first TCI state, and receives the remaining floor (N/2) RBs by applying the second TCI state. As used herein, ceil (⋅) and floor (⋅) are operators indicating rounding up and down at the first decimal place, respectively. If the RPB bundling size is determined to be 2 or 4, even-numbered PRGs are received by applying the first TCI state, and odd-numbered PRGs are received by applying the second TCI state.

Multi-TRP TDM scheme A: refers to a multi-TRP-based time resource division intra-slot PDSCH repetitive transmission scheme. The UE has two PDSCH transmission occasions in one slot, and the first reception occasion may be determined based on the PDSCH's start symbol and symbol length indicated through the time domain resource allocation field in the DCI. The start symbol of the second reception occasion of the PDSCH may be an occasion obtained by applying a symbol offset corresponding to StartingSymbolOffsetK (higher layer signaling) from the last symbol of the first transmission occasion, and a transmission occasion may be determined to correspond to the symbol length indicated thereby. If there is no configured StartingSymbolOffsetK (higher layer signaling), the symbol offset may be considered to be 0.

Multi-TRP TDM scheme B: refers to a multi-TRP-based time resource division inter-slot PDSCH repetitive transmission scheme. The UE has one PDSCH transmission occasions in one slot, and may receive repetitive transmission, based on the same PDSCH's start symbol and symbol length during as many slots as repetitionNumber indicated through the time domain resource allocation field in the DCI. If repetitionNumber is 2, the UE may receive PDSCH repetitive transmission of the first and second slots by applying the first and second TCI states, respectively. If repetitionNumber is greater than 2, the UE may use different TCI state application schemes according as tciMapping (higher layer signaling) is configured to be a specific one. If tciMapping is configured to be cyclicMapping, the first and second TCI states are applied to the first and second PDSCH transmission occasions, respectively, and the UE applies the same TCI state application method to remaining PDSCH transmission occasions. If tciMapping is configured to be sequenticalMapping, the first TCI state is applied to the first and second PDSCH transmission occasions, the second TCI state is applied to the third and fourth PDSCH transmission occasions, and the same TCI state application method is applied to remaining PDSCH transmission occasions.

The UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to when the UE receives a PDSCH to which cooperative communication is applied, based on conditions similar to those described above.

Determining priority between A and B may be variously described as, for example, selecting an entity having a higher priority according to a predetermined priority rule and performing an operation corresponding thereto, or omitting or dropping operations regarding an entity having a lower priority. Hereinafter, the above examples may be described through multiple embodiments, but they are not independent of each other, and one or more embodiments may be applied simultaneously or in combination.

For convenience, a cell, a transmission point, a panel, a beam, and/or a transmission direction which can be distinguished through an upper layer/L1 parameter such as a TCI state or spatial relation information, a cell ID, a TRP ID, or a panel ID may be described as a TRP, a beam, or a TCI state as a whole. Therefore, in actual applications, a TRP, a beam, or a TCI state may be appropriately replaced with one of the above terms. A beam in the disclosure may be understood as an SSB beam, a CSI-RS beam, an SSB resource, or a CSI-RS resource.

The UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to when the UE receives a PDSCH to which cooperative communication is applied, based on conditions similar to those described above.

Herein, upper layer signaling may refer to signaling corresponding to at least one signaling among MIB, SIB or SIB X (X=1, 2, . . . ),
RRC, and
MAC CE.

In addition, L1 signaling may correspond to at least one signaling method among signaling methods using the following physical layer channels or signaling, or a combination of one or more thereof.
Physical downlink control channel (PDCCH)
DCI
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
PUCCH
UCI

Determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a TTI, may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

First embodiment: a scheme for exchanging channel information between a UE and a BS to support DL joint transmission

Herein, DL joint transmission may be referred to as coherent joint transmission (C-JT) or non-coherent joint transmission (CN-JT), and channel information acquisition may be referred to as a CSI report, CSI acquisition, or other terms. This embodiment may be combined with other embodiments and operate accordingly.

To perform control and scheduling in multiple cells flexibly and efficiently, a base station may be configured such that multiple radio units (RUs) or multiple massive MIMO units (MMUs) are connected to one distributed unit (DU). The one DU may perform scheduling for transmitting DL signals and channels to a UE through the multiple RUs or multiple MMUs. To the contrary, UL signals and channels transmitted from the UE may be received by the multiple RUs or multiple MMUs and then processed by the one DU. In the following description, MMUs or RUs may be used interchangeably with TRPs.

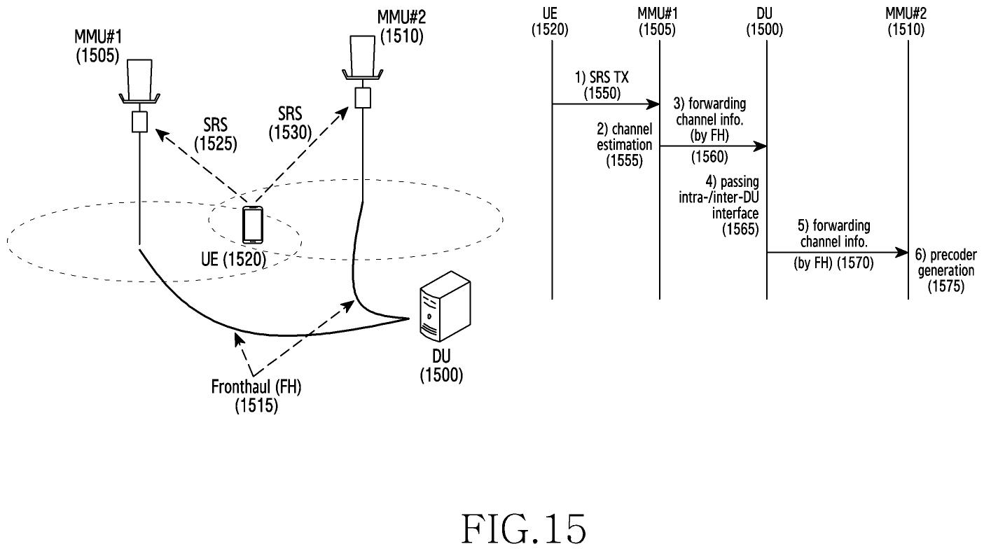

FIG. 15 illustrates elements constituting a BS and a process in which the BS acquires a channel through an SRS transmitted by a UE according to an embodiment.

Referring to FIG. 15, the BS may include one DU 1500 and two MMUs (for example, first MMU 1505 and second MMU 1510). One DU and one MMU may be connected to each other by a fronthaul (FH) 1515. The UE 1520 may transmit SRSs 1525 and 1530 to the BS for DL channel estimation and DL precoder calculation in the BS. The SRSs may be transmitted through mutually independent SRS resources corresponding to respective MMUs, or may be transmitted through one common SRS resource.

The BS which includes multiple MMUs and one DU connected thereto may receive an SRS transmitted by the UE and may estimate a DL channel based thereon, thereby calculating a DL precoder. Such an operation may be performed by the MMUs or by the DU. During DL signal transmission or UL signal reception, the BS may define up to which part of the processes undergone by the DL or UL signal on the physical layer will be performed by the MMUs and the DU, respectively, and this may be referred to as a function split. The BS may perform DL channel estimation and DL precoder calculation in the MMUs or DU as follows, according to how the function split is defined.

If DL channel estimation and DL precoder calculation are performed by the MMUs, increased functions to be performed by the MMUs may cause operations of the MMUs to be complicated, increase power consumption, cause exorbitant costs for MMU development, and increase purchasing costs for the MMU. However, in terms of DL channel estimation performance, the BS is instantly capable of DL channel estimation in the MMUs and thus may acquire a better DL channel estimation performance because there is no performance degradation occurring in the process in which, when the DU performs DL channel estimation, the MMUs quantize received SRS signals and transfer the SRS signals to the DU. If DL channel estimation is performed by the MMUs in consideration of the above-mentioned better DL channel estimation performance, DL precoder calculation is also possible based on more accurately recognizing the optimal number of MIMO layers which can be transmitted through the DL channel, thereby providing an excellent DL system yield performance. However, if multiple MMUs are connected to one DU as described above, and if respective MMUs are at different locations such that the multiple MMUs want to perform joint transmission, the BS cannot perform DL precoder calculation in consideration of the multiple MMUs. As such, when joint transmission is to be performed, DL precoder cannot be optimized during DL precoder calculation in consideration of the multiple MMUs.

If DL channel estimation and DL precoder calculation are performed by the DU, increased functions to be performed by the DU may simplify operations of the MMUs, decrease costs for MMU development, and decrease the MMU purchasing price. However, in terms of DL channel estimation performance, signal distortion may occur in the process in which the BS quantizes SRS signals received by the MMUs and transfer the SRS signals to the DU such that DL channel estimation is performed by the DU, and degraded performance may be expected compared with the method in which the MMUs perform DL channel estimation immediately after receiving SRSs.

If DL channel estimation is performed by the DU in consideration of the fact that a relatively degraded DL channel estimation performance may be obtained as described above, DL precoder calculation is also possible based on more inaccurately recognizing the optimal number of MIMO layers which can be transmitted through the DL channel, thereby providing a degraded DL system yield performance. However, if multiple MMUs are connected to one DU as described above, and if respective MMUs are at different locations such that the multiple MMUs want to perform joint transmission, the BS may transfer SRS signals received by respective MMUs to the DU, and the UD may gather all SRS signals received by the MMUs and perform DL channel estimation and DL precoder calculation in a batch mode, thereby optimizing the DL precoder which is to be used when the BS wants to perform joint transmission by using multiple MMUs during calculation.

If DL channel estimation and DL precoder calculation are performed by the MMUs, and if the BS wants to perform DL joint transmission to the UE by using multiple MMUs, the BS may share the DL channel estimated by each MMU with respective other MMUs. After all MMUs acquire DL channels between other MMUs and the UE, the BS may gather such DL channels between multiple MMUs and the UE at once and may perform integrated DL precoder calculation corresponding to all MMUs. Each MMU may select and use only the DL precoder part corresponding to each MMU in the integrated DL precoder. To share the DL channel estimated by each MMU with respective other MMUs, the BS may have to undergo the following processes:

The UE 1520 may transmit an SRS to the first MMU 1505 (1550).

Upon receiving the SRS transmitted by the UE, the first MMU may perform DL channel estimation, based on the SRS signal (1555).

The first MMU may transfer the DL channel estimated by the first MMU to the DU 1550 through the fronthaul (1560).

The DL channel estimated by the first MMU, transferred to the DU, may additionally pass through an interface in the DU (1565). If the first MMU and the second MMU are connected to the same channel card in the DU, DL channel estimated by the first MMU may need to pass through an Ethernet cable to be transferred to the second MMU, depending on the manner of implementation of the channel card. If the first MMU and the second MMU are connected to different channel cards in the DU, connection between the two channel cards may be made by an Ethernet cable, and the DL channel estimated by the first MMU may also need to pass through the Ethernet cable in this case as well. If the first MMU is connected to the first DU, and if the second MMU is connected to the second DU, connection between the two DUs may be made by an Ethernet cable, and the DL channel estimated by the first MMU may also need to pass through the Ethernet cable. When passing through an interface such as the above-mentioned Ethernet cable, a considerable (for example, tens or hundreds of ms) additional delay time may occur depending on the capacity of the Ethernet cable.

After passing through the additional interface in the DU, the DL channel estimated by the first MMU may be transferred to the second MMU 1510 through the fronthaul (1570).

After being transferred to the second MMU, the DL channel estimated by the first MMU may be used for DL precoder calculation for DL joint transmission together with the DL channel estimated by the second MMU (1575). The second MMU may calculate an integrated DL precoder for DL joint transmission by considering the DL channel estimated by the first MMU and the DL channel estimated by the second MMU, may select a part of the integrated DL precoder, which corresponds to the second MMU, and may use the selected part of the integrated DL precoder during DL joint transmission. For example, assuming that the DL channel estimated by the first MMU and the DL channel estimated by the second MMU are referred to as H1′ and H2, respectively, the second MMU may derive an integrated DL precoder W, as in W=[W1′W2]=f(H1′, H2), in consideration of a function f(⋅), which denotes a specific precoder calculation scheme, when calculating an integrated DL precoder for DL joint transmission, and W1′ and W2 may refer to DL precoder parts corresponding to the first MMU and the second MMU, respectively, among the integrated DL precoder derived by the second MMU by using the f(⋅). In this regard, H1 may refer to information regarding the cannel between the first MMU and the UE estimated based on the SRS received by the first MMU, and H1′ may refer to the channel between the first MMU and the UE, which may be obtained by the second MMU in consideration of the quantization process or the like necessary when transferring H1 through the above process.

The above process may require the second MMU to similarly transfer the DL channel estimated by the second MMU to the first MMU, based on the SRS transmitted to the second MMU by the UE. Therefore, the first MMU may also calculate an integrated DL precoder for DL joint transmission as above, may select a precoder part corresponding to the second MMU therefrom, and may use the selected precoder part during DL joint transmission.

The first MMU may have information H1 regarding the channel between the first MMU and the UE acquired through DL channel estimation, based on the SRS received by the first MMU, and a DL channel H2′ estimated by the second MMU, transferred through the above process. Similarly, the second MMU may have information H2 regarding the channel between the second MMU and the UE acquired through DL channel estimation, based on the SRS received by the second MMU, and a DL channel H1′ estimated by the first MMU, transferred through the above process. Therefore, even if the first MMU and the second MMU use the same f(⋅), different channel values may be input thereto, and the integrated DL precoders for DL joint transmission derived by the first MMU and the second MMU may accordingly differ from each other.

However, many quantization processes may occur while undergoing multiple MMUs and a DU, which constitute a BS for the above process, and additional interfaces in the DU, and an unneglectable delay time may occur. Accordingly, when a specific MMU is provided with a channel between another MMU and the UE, the accuracy of the channel may be degraded. The delay time that may occur may increase the delay time from the timepoint at which channel estimation between a specific UE and the BS is performed to the time at which DL transmission is performed to the UE through DL scheduling. This may cause additional performance degradation according to the time-variable radio channel characteristics.

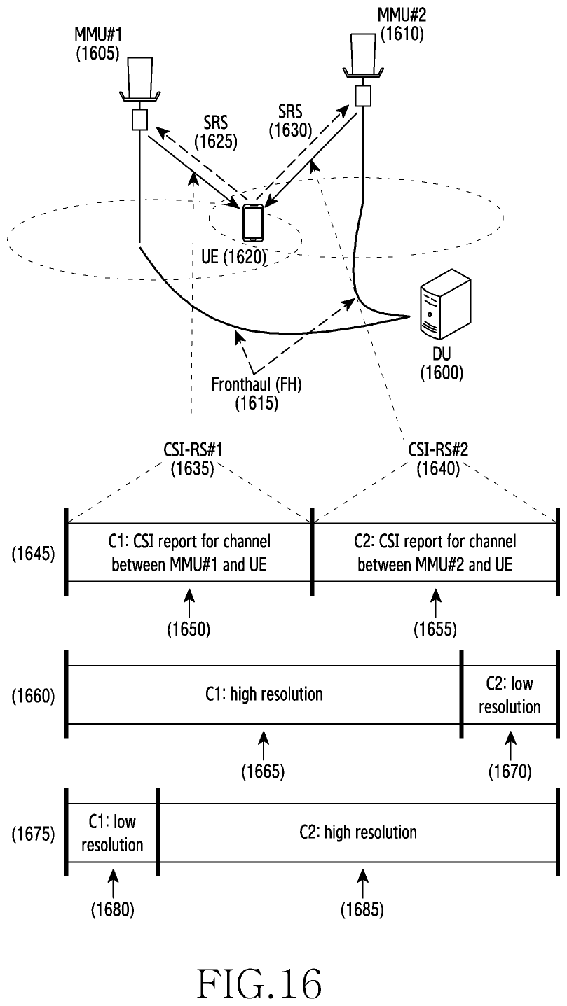

FIG. 16 illustrates a channel information feedback method according to an embodiment.

Referring to FIG. 16, the BS may include one DU 1600 and two MMUs (for example, first MMU 1605 and second MMU 1610). One DU and one MMU may be connected to each other by a fronthaul (FH) 1615. The UE 1620 may transmit SRSs 1625 and 1630 to the BS for DL channel estimation and DL precoder calculation in the BS. The SRSs may be transmitted through mutually independent SRS resources corresponding to respective MMUs or may be transmitted through one common SRS resource. The UE may receive a CSI-RS from the BS and estimate DL channels between respective MMUs and the UE. More particularly, the UE 1620 may estimate the channel between the first MMU and the UE through a first CSI-RS 1635 transmitted by the BS through the first MMU 1605 and may estimate the channel between the second MMU and the UE through a first CSI-RS 1640 transmitted by the BS through the second MMU 1610. Even if the BS can estimate DL channels between respective MMUs and the UE, based on an SRS transmitted by the UE in consideration of the reciprocity between DL and UL channels due to characteristics of TDD bands, the BS does not have the UE's CQI information which is necessary for scheduling, and thus, the BS may additionally need a CSI report which may include pieces of information such as RI, PMI, and CQI calculated based on a DL channel estimated by the UE, for the sake of scheduling by the BS. In addition, the CSI report from the UE may also be used to alleviate problems such as channel estimation accuracy during channel information exchange in the BS as described above, additional delay time, and the like. As an example, to calculate an integrated DL precoder for DL joint transmission, the first MMU may not use a modified channel resulting from a DL channel which has been estimated by the second MMU and transferred to the first MMU, and which includes quantization errors and the like, and may use a PMI, which is included in a CSI report transmitted by the UE after calculating the channel between the second MMU and the UE, as information that replaces the channel.

To this end, as an example, the UE may have individual CSI reports corresponding to channels between respective MMUs and the UE, configured by the BS. To transmit a CSI report regarding the cannel between the first MMU and the UE to the BS, the UE may receive a first CSI-RS 1635 transmitted from the first MMU, perform DL channel estimation, calculate corresponding CSI, and transmit a CSI report (hereinafter, referred to as C1) to the BS. In addition, to transmit a CSI report regarding the cannel between the second MMU and the UE to the BS, the UE may receive a second CSI-RS 1640 transmitted from the second MMU, perform DL channel estimation, calculate corresponding CSI, and transmit a CSI report (hereinafter, referred to as C2) to the BS (1645). If the UE has the same codebook configured in CSI reports C1 and C2 corresponding to channels between respective MMUs and the UE, C1 and C2 may have the same bit length, or there may be a difference in bit length according to detailed configurations of the codebook, but the difference may be negligible. The codebook which may be configured for the UE may be at least one of Type-I single panel codebook, Type-I multi-panel codebook, Type-II codebook, enhanced Type-II codebook, and Further enhanced Type-II codebook.

As an example, the UE may have common CSI reports corresponding to channels between respective MMUs and the UE, configured by the BS. The UE may be configured by the BS such that the first CSI-RS 1635 and the second CSI-RS 1640 are included in a CSI resource setting connected in a single CSI report configuration, may calculate CSI corresponding to channels between two MMUs and the UE, and may transmit a CSI report corresponding to a combination of C1 and C2 to the BS (1645). The codebook which can be configured for the UE may be enhanced Type-II codebook for coherent joint transmission. In this case, C1 and C2 to be transmitted by the UE may have the same bit length, or there may be a difference in bit length according to detailed configurations of the codebook, but the difference may be negligible, as in the above description.

However, a PMI calculated from the UE for a CSI report is a precoder quantized by a codebook predefined between the BS and the UE while corresponding to specific RI. Therefore, the PMI is not information expressing a channel itself, although the PMI reflects characteristics of the channel, and a channel estimated by the BS based on an SRS transmitted by the UE is substantially accurate. Therefore, the PMI may have an insufficient amount of information to be used during precoder calculation together with the channel estimated by the BS based on the SRS.

To solve the above-mentioned problem during channel information exchange in the BS and the limitation during legacy CSI report transmission, the UE and the BS may consider a CSI report regarding channels between all MMUs and the UE such that, within the total bit length given, fewer bits may be assigned to express a channel between a specific MMU (for example, first MMU) and the UE, and more bits may be assigned to express a channel between another MMU (for example, second MMU) and the UE. From the standpoint of the first MMU, the channel between the first MMU and the UE may be acquired through an SRS transmitted by the UE. In connection with the channel between the second MMU and the UE, a CSI report with a high degree of accuracy, which is expressed by more bits assigned as described above, may be received from the UE, thereby calculating an integrated DL precoder which may be used during DL joint transmission. From the standpoint of the second MMU, the channel between the second MMU and the UE may be acquired through an SRS transmitted by the UE. In connection with the channel between the first MMU and the UE, a CSI report with a high degree of accuracy, which is expressed by more bits assigned as described above, may be received from the UE, thereby calculating an integrated DL precoder which may be used during DL joint transmission.

As an example, assuming that the combined bit length of the C1 and C2 is B (fixed value), and if bit lengths corresponding to C1 and C2 are defined to be B1 and B2, respectively, B1 and B2 may correspond to horizontal lengths of 1650 and 1655, respectively, and similar bit lengths are considered for C1 and C2 (1645). That is, each of B1 and B2 may be considered as B/2. However, when calculating CSI in a channel between a specific MMU and the UE, the UE may assign a larger bit length within given B, thereby improving the accuracy of CSI that expresses the channel. As an example, within given B, the UE may allocate more bits when calculating a CSI report that expresses the channel between the first MMU and the UE, and may use fewer bits when calculating a CSI report that expresses the channel between the second MMU and the UE (1660). In this case, B1 and B2 correspond to horizontal lengths of 1665 and 1670, respectively, and although the sum of B1 and B2 is still B, B1 may be substantially greater than B2 (B1>>B2). A CSI report regarding the channel between the first MMU and the UE generated in this manner may be transmitted to the second MMU and used instead of information regarding the channel between the first MMU and the UE when calculating an integrated DL precoder to be used during DL joint transmission by the second MMU. The UE may assign more bits when calculating a CSI report to be transmitted to the first MMU than when calculating a CSI report expressing the channel between the second MMU and the UE, and may use fewer bits when calculating a CSI report expressing the channel between the first MMU and the UE (1675). In this case, B1 and B2 may correspond to horizontal lengths of 1680 and 1685, respectively, and although the sum of B1 and B2 is still B, B2 may be assigned substantially greater than B1 (B2>>B1).

A CSI report regarding the channel between the second MMU and the UE generated in this manner may be transmitted to the first MMU and used instead of information regarding the channel between the second MMU and the UE when calculating an integrated DL precoder to be used during DL joint transmission by the first MMU. That is, in the channel between each MMU (for example, first MMU) and the UE, channel information may be acquired by performing channel estimation based on an SRS transmitted by the UE. In the channel between another MMU (for example, second MMU) other than each MMU and the UE, the UE may estimate the channel between the second MMU and the UE, based on a CSI-RS transmitted by the second MMU, instead of undergoing a process in the BS in which a channel estimated by receiving an SRS from the UE is transferred from the second MMU to the first MMU, and the UE may transmit CSI regarding the channel between the second MMU and the UE calculated based thereon to the first MMU as a CSI report. The first MMU may replace the channel between the second MMU and the UE, based on the CSI report from the UE. In addition, in consideration of a CSI report regarding multiple MMUs, a substantially small value may be assigned to a specific part (for example, B1) of the entire amount (B) of bits of the CSI report, and a larger amount of bits may be assigned to a remaining part (for example, B2) such that the first MMU can receive, from the UE, a CSI report calculated with a higher degree of precision in the channel between the second MMU and the UE, which cannot be obtained by the first MMU through an SRS.

### Second Embodiment: A CSI Reporting Scheme by a UE for DL Joint Transmission Support

When the UE calculates CSI regarding channels between multiple MMUs and the UE and performs CSI reporting, the UE may assign more bits to a channel between a specific MMU and the UE, among the bit length assigned to the entire CSI as described above, thereby performing a CSI calculation at a high resolution, which is relatively accurate, may assign fewer bits to a channel between another specific MMU and the UE, thereby performing a CSI calculation at a low resolution, which is relatively inaccurate, and may configure entire CSI and perform CSI reporting. The UE may be notified of performing and reporting a CSI calculation at a high or low resolution regarding a channel between a specific MMU and the UE by the BS through a combination of higher layer signaling, MAC-CE signaling, and L1 signaling. The BS may configure higher layer signaling for the UE such that, when calculating CSI regarding channels between respective MMUs and the UE, one CSI reporting configuration includes configurations related to the CSI calculation regarding channels between all MMUs and the UE, and individual CSI reports regarding respective channels between the MMUs and the UE may be configured for the UE.

The above-described method for calculating relatively accurate or inaccurate CSI in channels between different MMUs and the UE may consider the following details. For example, two MMUs (for example, first and second MMUs) connected to one UD may be considered. When calculating CSI regarding channels between the two MMUs and the UE, B may be considered as the total amount of bits. When calculating CSI regarding each of the channel between the first MMU and the UE and the channel between the second MMU and the UE, B1 and B2 may be considered as amounts of bits, and B1+B2=B may be considered. If the UE includes configurations related to CSI calculations regarding channels between the first and second MMUs and the UE in one CSI report configuration, the UE may expect that CRI-RS resources at least corresponding to the number of MMUs will be included in the CSI resource setting connected to the CSI report configuration, and may not expect that a CRI-RS resource indicator (CRI) report will be included in reportQuantity (higher layer signaling). Even if multiple CRI-RS resources are received, the UE does not report CRI which may indicate that the CRI has been calculated through the CRI-RS resource selected by the UE. This may imply that CSI included in the CSI report which the UE reports by using all of the multiple CRI-RS resources has been calculated.

In addition, if the UE has individual CSI reports configured regarding channels between respective MMUs and the UE, that is, if the UE has a first CSI report configured regarding the channel between the first MMU and the UE and has a second CSI report configured regarding the channel between the second MMU and the UE, the UE may be by the BS notified that the multiple CSI reports are connected to each other, by using an indicator, through a combination including at least one of higher layer signaling, MAC-CE signaling, and L1 signaling. Among the total amount of bits regarding the multiple CSI reports, the UE may be configured by the BS to use more bits in a channel between a specific MMU and the UE such that the channel is accurately quantized, and may be configured to use fewer bits in a channel between another specific MMU and the UE such that the channel is relatively inaccurately quantized, or to include minimum information in the CSI report in the channel between the corresponding MMU and the UE.

### Method 1

The UE may calculate relatively accurate or inaccurate CSI in channels between different MMUs and the UE, based on a codebook currently defined in specifications and codebook parameters defined in the codebook.

The UE may receive individual CSI report configurations from the BS in the channel between the first MMU and the UE and the channel between the second MMU and the UE. As an example, the UE may receive a first CSI report configuration from the BS for a CSI report regarding the channel between the first MMU and the UE and may receive a second CSI report configuration from the BS for a CSI report regarding the channel between the second MMU and the UE. The UE may configure specific parameters in the first CSI report configuration and the second CSI report configuration differently from each other such that more bits are used for a specific CSI report, thereby expressing the channel more accurately, and fewer bits is used for the other CSI report, thereby expressing the channel relatively inaccurately. Specific parameters in the first CSI report configuration and the second CSI report configuration, which are to be considered by the UE, may be at least one of cqi-FormatIndicator, pmi-FormatIndicator, csi-ReportingBand, codebookConfig, subbandSize, parameters regarding oversampling factors, and parameters regarding codebook subset restrictions.

As an example, the UE may have a first CSI report configuration regarding sub-band CQI and sub-band PMI reports configured by the BS, and may have a second CSI report configuration regarding wideband CQI and wideband PMI reports configured thereby. As an example, the UE may configure large or small oversampling factor values in the first CSI report configuration and the second CSI report configuration, respectively, such that the first CSI report configuration can select a detailed PMI in the space dimension due to the large oversampling factor, and the second CSI report configuration can select a relatively inaccurate PMI due to the small oversampling factor. As an example, the UE may have a Type-I single panel codebook configured in the first CSI report configuration, and may have a Type-II codebook configured in the second CSI report configuration. The UE may select one from multiple PMIs through the Type-I single panel codebook, may express a channel through linear coupling of multiple PMIs through the Type-II codebook, and may report linear coupling coefficients corresponding to respective PMIs during the linear coupling of multiple PMIs, in this method.

The UE may receive one CSI report configuration from the BS for the sake of CSI calculation regarding the channel between the first MMU and the UE and the channel between the second MMU and the UE, some of configuration parameters in the CSI report may be commonly applied when calculating CSI regarding the channel between the first MMU and the UE and CSI regarding the channel between the second MMU and the UE, and remaining some may be defined as individual parameters and applied when calculating the two types of CSI. For example, one cqi-FormatIndicator existing in one CSI report may be configured for the UE to calculate CSI regarding channels between different MMUs and the UE, and pmi-FormatIndicator, csi-ReportingBand, codebookConfig, subbandSize, and oversampling factor-related parameters may be individually configured in two CSI calculations. Accordingly, the UE may perform CSI calculation by using different amounts of bits when calculating CSI regarding channels between different MMUs and the UE.

### Method 2

The UE may newly consider a codebook currently defined in specifications and parameters not defined in the codebook, thereby calculating relatively accurate or inaccurate CSI regarding channels between different MMUs and the UE.

The UE may receive individual CSI report configurations from the BS in the channel between the first MMU and the UE and the channel between the second MMU and the UE. As an example, the UE may receive a first CSI report configuration from the BS for a CSI report regarding the channel between the first MMU and the UE and may receive a second CSI report configuration from the BS for a CSI report regarding the channel between the second MMU and the UE. The UE may configure specific parameters in the first CSI report configuration and the second CSI report configuration differently from each other such that more bits are used for a specific CSI report, thereby expressing the channel more accurately, and fewer bits are used for the other CSI report, thereby expressing the channel relatively inaccurately. As an example, the UE may have a Type-I single panel codebook configured in the first CSI report configuration, may have cqi-FormatIndicator and pmi-FormatIndicator configured as wideband, and may have no oversampling factor configured, thereby reducing the overhead during CSI reporting, and reducing the amount of bits through inaccurate CSI calculation regarding the channel between the first MMU and the UE. If the UE has an enhanced Type-II codebook configured as the codebook type in the second CSI report, the UE may have the following parameters configured additionally by the BS such that more accurate CSI calculation is possible, and the amount of bits corresponding to B-B1 may be used.

The UE may consider 8, 12, 16, 24, or 32 which is greater than the maximum (6), as the number of PMIs used for linear coupling on space resources. The UE may consider different combinations of PMIs to be used for linear coupling in respective layers and may report the PMIs to the BS during CSI reporting. The UE may have a value greater than 4 configured in oversampling-related parameters.

The UE may have a configured value of ¾, ⅞, 15/16, or 1, besides the maximum value (½), configured in the p value for adjusting the number of PMIs used on frequency resources.

The UE may have one value from among a BWP, a half BWP, a quarter BWP, an RB unit, and one RE unit configured in the unit of frequency resources during quantization on frequency resources, thereby expressing more accurate channel state on frequency resources.

The UE may use values greater than the maximum value (¾) in the beta value for adjusting the number of non-zero coefficients among linear coupling coefficients corresponding to respective PMIs during linear coupling of multiple PMIs on space resources and frequency resources. The UE may have a value of ⅞, 15/16, or 1 configured by the BS in the beta value.

The above-described example may be similarly applied to other codebook types, as well as enhanced Type-II codebook. In a unique parameter that another codebook has, a value smaller or greater than the range of values that the parameter has may be supported, thereby expressing a more accurate channel state.

When calculating CSI based on a codebook for expressing a more accurate channel state as described above, the UE may receive a CSI-RS, the density of which is greater than 1. Accordingly, by receiving a CSI-RS having a density value greater than 0.5 or 1, the UE may use more REs on frequency resources for channel estimation, compared with receiving a CSI-RS having a configured density of 0.5 or 1, and may thus recognize the channel's frequency selectivity more accurately.

### Method 3

The UE may calculate relatively accurate or inaccurate CSI in channels between different MMUs and the UE, based on an explicit channel state reporting scheme not currently defined in specifications. Codebooks and CSI reporting schemes defined in specifications may include an RI including an assumption that the UE receives a specific rank, a PMI including an assumption that a specific DL precoder corresponding to the rank is used in a codebook commonly understood by the UE and the BS, a CQI including an assumption that, when the DL precoder is used, the UE may receive the channel with a specific performance, and the like. Such pieces of information may express the optimal performance that the UE may acquire under a given channel. Therefore, such a CSI reporting scheme may be referred to as implicit CSI reporting. This may be because the UE does not send feedback regarding the channel itself to the BS but considers that the channel between the BS and the UE as information given to the UE, and reports indices to the BS such that the UE can obtain the optimal performance derivable within the information. However, as described above, the information to be obtained currently by the first MMU in the BS is information regarding the channel itself between the UE and an MMU (for example, second MMU) other than the first MMU, and is for the purpose of calculating a DL precoder to be used during DL joint transmission therethrough. Therefore, the information may be unnecessary to the first MMU in the case of CSI reporting conducted by the UE according to the codebook provided in the relevant standard, or may cause a burden in that partial reprocessing is necessary to be used as desired by the first MMU.

Therefore, unlike performing CSI reporting based on the codebook currently defined in specifications, the UE may consider an explicit channel state reporting scheme wherein, to report information regarding the channel itself between a specific MMU and the UE to the BS more accurately, the UE estimates and processes the channel itself between the BS and the UE and reports the channel to the BS. The UE may express a radio channel between the UE and a specific MMU through a predetermined quantization process. Typical schemes may include a scalar quantization scheme in which quantization may be applied in each coefficient of the MIMO channel, and a vector quantization scheme in which quantization may be applied in each row or column of the MIMO channel. As an example, if the UE considers a MIMO channel between NTX transmission antennas of a specific MMU and NRX reception antennas of the UE by using a specific frequency unit, the MIMO channel may be expressed by NTX rows and NRX columns and may become a matrix, each component of which is a complex number.

If the UE reports explicit CSI to the BS in consideration of the scalar quantization scheme, the UE may divide NTX×NRX complex components into sizes and phases or into real number parts and imaginary number parts, thereby applying scalar quantization in respective parts. It will be assumed that respective components of the MIMO channel between a specific MMU and the UE are divided into sizes and phases. In terms of sizes, all components may be normalized by the size of a component having the largest size among all components of the MIMO channel and then quantized to values between 0 and 1, and the phases of 0 to 2^{π} may be quantized to given bit values. During size-related quantization, values between 0 and 1 may be quantized evenly or unevenly. The phase of 0 to 2^{π} may also be quantized evenly or unevenly to given bit values. During size-related scalar quantization, the UE may additionally report the size of the component having the largest size among all components of the MIMO channel to the BS. The reporting may be conducted according to the definition of L1-RSRP defined in specifications. Alternatively, the UE may designate the range of specific upper and lower limits in the maximum size value, may perform additional scalar quantization, and may conduct reporting.

If the UE reports explicit CSI to the BS in consideration of the vector quantization scheme, the UE may select NRX vectors having a length of NTX, for example, and report the selected NRX to the BS. Alternatively, the UE may select NTX vectors having a length of NRX and report the selected NTX to the BS. Alternatively, the UE may decompose a NTX×NRX MINO channel into three matrices through singular value decomposition, may select an eigenvector, the lengths of which corresponding to a specific number of eigenvalues are NTX and NRX, and report the selected eigenvector to the BS. If the UE uses the singular value decomposition scheme, the specific number of eigenvalues may be selected through various methods as follows: the specific number of eigenvalues is arbitrarily selected by the UE, the specific number of eigenvalues is selected such that the given amount of CSI report bits can be used to the maximum, or the specific number of eigenvalues is selected as many as the number of dominant eigenvalues corresponding to a specific part or more (for example, 90% or more) of the total sum of eigenvalues. In multiple vectors, the length of which to be used for vector quantization is NTX or NRX, the UE may store the multiple vectors as a codebook promised between the BS and the UE and use the multiple vectors. The UE may continuously use the same codebook with no change. As required by the UE or the BS, the UE or the BS may transmit signaling for updating the codebook to the UE or the BS. When performing vector quantization, the UE may transmit information regarding the direction of the MIMO channel to the BS. Therefore, the UE may additionally report information corresponding to the size value of the channel to the BS according to the definition of L1-RSRP defined in specifications, similarly to the above-described scalar quantization scheme. The UE may also designate the range of specific upper and lower limits in the size value of the channel, may perform additional scalar quantization, and may conduct reporting.

### Method 4

When calculating CSI regarding channels between multiple MMUs and the UE, the UE may not calculate the CSI in the channel between a specific MMU and the UE. Therefore, the UE may not calculate the CSI in the channel between the first MMU and the UE, for example, such that B1 bits which could otherwise be used to calculate the CSI regarding the channel between the first MMU and the UE are additionally used for B2 bits available to calculate the CSI regarding the channel between the second MMU and the UE, thereby reporting more accurate channel information to the BS by using a total of B bits to calculate the CSI regarding the channel between the second MMU and the UE. To the contrary, the UE may not calculate the CSI in the channel between the second MMU and the UE, for example, such that B2 bits which could otherwise be used to calculate the CSI regarding the channel between the second MMU and the UE are additionally used for B1 bits available to calculate the CSI regarding the channel between the first MMU and the UE, thereby reporting more accurate channel information to the BS by using a total of B bits to calculate the CSI regarding the channel between the first MMU and the UE. That is, the UE may configure one value between B1 and B2 to be 0, and may calculate CSI by considering that the non-zero value between B1 and B2 is B.

### Method 5

The UE may be notified of to a combination including at least one of above-described Method 1 to Method 4 by the BS through a combination including at least one of higher layer signaling, MAC-CE signaling, and L1 signaling, or may follow a method fixedly defined in specifications.

As an example, the UE may combine Method 3 and Method 4 and transmit a CSI report to the BS. The UE may assign 0 bit to the channel between the second MMU and the UE as in Method 4, and may assign all bits available for the entire CSI report to the channel between the first MMU and the UE, thereby using the assigned all bits to generate explicit channel information as in Method 3. The UE may provide the second MMU with the entire CSI report generated in this manner. The UE may assign 0 bit to the channel between the first MMU and the UE as in Method 4, and may assign all bits available for the entire CSI report to the channel between the second MMU and the UE, thereby using the assigned all bits to generate explicit channel information as in Method 3.

As an example, the UE may combine Method 1 and Method 3 and transmit a CSI report to the BS. The UE may use the codebook currently defined in specifications in the channel between the second MMU and the UE, as in Method 1, such that a codebook parameter, which requires a small amount of bits such that a lower degree of accuracy can be obtained, is configured therefor. For example, the UE may determine the CQI and PMI on a wideband basis when calculating CSI regarding the channel between the second MMU and the UE, and may have a codebook type configured to be Type-I single panel. The UE may have restrictions configured in all rank values other than the rank value determined such that the UE can use the smallest number of bits during CSI reporting, through a rank restriction configuration. Concurrently, the UE may generate explicit channel information regarding the channel between the first MMU and the UE according to Method 3. In this regard, after the amount (B) of bits regarding the entire CSI report is determined, and after B2 bits are used such that more inaccurate CSI may be calculated in the channel between the second MMU and the UE, the UE may use all remaining (B-B2) bits to generate explicit channel information regarding the channel between the first MMU and the UE.

The UE may report UE capability to the BS to indicate that a combination of at least one of above-described Method 1 to Method 5 can be supported. If the UE does not report UE capability to the BS to indicate that a combination of at least one of above-described Method 1 to Method 5 can be supported, that may indicate that methods other than the at least one combination of methods reported by the UE are supported, or that none of above-described Method 1 to Method 5 are supported. As an example, if the UE defines UE capability to indicate that Method 2 and Method 3 can be supported, and if the UE does not report the UE capability to the BS, the BS may consider that the report indicates both that the UE does not support Method 2 and Method 3 and that Method 1 is supported.

The UE may perform quantization in channels between multiple MMUs and the UE, based on above-described Method 1 to Method 5, such that relatively accurate CSI is reported to the BS in the channel between a specific MMU and the UE through a CSI report. As an example, the UE may use a small amount of bits (B1) within given B bits in the channel between the first MMU and the UE, thereby quantizing the channel, and may use a large amount of bits (B2) in the channel between the second MMU and the UE, thereby quantizing the channel. The UE may have individual CQIs included in channels between respective MMUs and the UE, or may have a common CQI included in consideration of all channels between all MMUs and the UE (hereinafter, “common CQI” may be referred to as “joint CQI”).

When calculating individual CQIs, the UE may calculate the RI and PMI in the channel between the first MMU and the UE, for example, may calculate the CQI based thereon, may similarly calculate the RI and PMI in the second MMU, and may individually calculate the CQI based thereon. That is, individual CQIs may be calculated in the first MMU and the second MMU.

As an example, the UE may calculate the CSI in the channel between the first MMU and the UE and the channel between the second MMU and the UE by using B1 and B2 bits, and may calculate a joint CQI in consideration of channels between all MMUs and the UE such that the joint CQI is included in B1 or B2 or both B1 and B2. When calculating the joint CQI, the UE may consider a combination of at least one of the following details. The following details will be described when the UE uses a small amount of bits (B1) in the channel between the first MMU and the UE to quantize the channel, and uses a large amount of bits (B2) in the channel between the second MMU and the UE to quantize the channel. Situations contrary thereto, or cases in which more than two MMUs are considered may not be excluded.

### Method 6

The UE may calculate a joint CQI in consideration of both a low-accuracy PMI to be included in B1 and a high-accuracy PMI to be included in B2. The UE may calculate the joint CQI, based on a PMI selected by the UE, according to legacy CQI definition. In such a case, the BS will estimate a channel, based on an SRS transmitted to the first MMU by the UE, and may calculate a precoder, based on the estimated channel, without using the low-accuracy PMI to be included in B1, and the joint CQI will inevitably have a low level of accuracy. In addition, if the UE assigns B1-0 bits when calculating the CSI in the channel between the first MMU and the UE, that is, if there is no PMI report in the channel between the first MMU and the UE, the UE will inevitably consider only the PMI to be included in B2 when calculating the joint CQI according to the legacy CQI definition. Therefore, if the UE calculates the joint CQI based on Method 6, the legacy CQI definition may be maintained, but a situation in which the UE reports a CSI inappropriate to be utilized by the BS may occur.

### Method 7

When calculating the joint CQI, the UE may not follow the legacy CQI definition, but may calculate the joint CQI in consideration of both a channel estimated based on a CSI-RS transmitted from the first MMU and a high-accuracy PMI to be included in B2. Through such joint CQI calculation, the UE may report, to the BS, a CQI calculated in consideration of a type close, to the maximum extent, to a DL precoder to be calculated by the first MMU by using CSI regarding the channel between the first MMU and the UE, which has been estimated by the first MMU based on an SRS transmitted to the UE, and the channel between the second MMU and the UE, which is to be transferred to the first MMU by the UE through a CSI report. Accordingly, upon receiving a DL precoder to be used by the BS, the UE may calculate a value closest to the UE's reception performance as the joint CQI and may report the joint CQI to the BS.

The UE may estimate the channel between the first MMU and the UE, based on a CSI-RS transmitted by the first MMU in the channel between the first MMU and the UE, and may reflect the estimated channel as an influence on the channel between the first MMU and the UE during joint CQI calculation. The UE may reflect CSI calculated based on a CSI-RS transmitted by the second MMU in the channel between the second MMU and the UE as an influence on the channel between the second MMU and the UE during joint CQI calculation. As an example, the UE may input CSI (C2) calculated based on the channel (H1) between the first MMU and the UE and the channel between the second MMU and the UE to a DL precoder calculation function, and may obtain a specific DL precoder as an output.

The DL precoder calculation function may be calculated based on implementation of the UE and the BS without any information exchange between the UE and the BS. Alternatively, information may be exchanged between the UE and the BS through a combination of at least one of higher layer signaling, MAC-CE signaling, and L1 signaling, and the UE and the BS may be coordinated to have the same understanding regarding in what manner the DL precoder is calculated, thereby calculating the DL precoder calculation function. In such a case, the difference in understanding between the UE and the BS may be minimized, but there may be a shortcoming in that the implementation scheme needs to be publicly exchanged between the BS and the UE, and there may be an additional restriction in that the UE or the BS, which is equipped with a simpler implementation, needs to be the reference. Based on the DL precoder calculated in this manner, the UE may calculate the joint CQI which is to be included in the CSI report.

### Method 8

When calculating the joint CQI, the UE may not follow the legacy CQI definition, but may calculate the joint CQI in consideration of both a channel estimated based on a CSI-RS transmitted from the first MMU and a channel estimated based on a CSI-RS transmitted from the second MMU. The difference from Method 7 may be related to what information is used in the channel between the second MMU and the UE when the UE calculates the joint CQI. In the case of Method 7, the UE may make a prediction close, to the maximum extent, to the DL precoder to be actually calculated by the first MMU and may transfer the DL precoder's performance. In Method 8, in connection with the joint CQI which the UE will calculate and report to the BS, the maximum value of performance which may be obtained through a CSI report calculated by the UE in the channel between the second MMU and the UE may be transferred. The amount of information may be lost due to quantization in the process of transferring information regarding the channel between the second MMU and the UE to the BS. Therefore, in consideration of this, the UE may calculate the joint CQI, based on channels between the UE and MMUs, in consideration of both the first MMU and the second MMU in the absence of loss of the amount of information. Assuming that the UE uses a model trained based on a specific AI/ML scheme, to calculate the CSI based on the channel between the second MMU and the UE (for example, assuming that channel between second MMU and the UE is considered as an input, a compressed form of the channel may be derived as a corresponding output, and the output information is considered as CSI, which is reported to the BS by the UE), the BS may use a model trained in the opposite manner to the model in the UE such that the CSI is considered as an input, and the channel between the second MMU and the UE may be derived as a corresponding output, and the first MMU may calculate a DL precoder based thereon. The UE may report a joint CQI to the BS to express the reception performance in the UE in the DL precoder which may be used by the BS as described. The UE may estimate the channel between the first MMU and the UE, based on a CSI-RS transmitted by the first MMU, and may reflect the estimated channel as an influence on the channel between the first MMU and the UE during joint CQI calculation. The UE may estimate the channel between the second MMU and the UE, based on a CSI-RS transmitted by the second MMU, and may reflect the estimated channel as an influence on the channel between the second MMU and the UE during joint CQI calculation. As an example, the UE may input the channel (H1) between the first MMU and the UE and the channel (H2) between the second MMU and the UE to a DL precoder calculation function and may obtain a specific DL precoder as an output.

The DL precoder calculation function may be calculated based on implementation of the UE and the BS without any information exchange between the UE and the BS. Alternatively, a notification may be exchanged between the UE and the BS through a combination of at least one of higher layer signaling, MAC-CE signaling, and L1 signaling, and the UE and the BS may be coordinated to have the same understanding regarding in what manner the DL precoder is calculated, thereby calculating the DL precoder calculation function. In such a case, the difference in understanding between the UE and the BS may be minimized, but there may be a shortcoming in that the implementation scheme needs to be publicly exchanged between the BS and the UE, and there may be an additional restriction in that the UE or the BS, which is equipped with a simpler implementation, needs to be the reference.

The UE may report UE capability to the BS to indicate that a combination of at least one of above-described Method 6 to Method 8 can be supported. If the UE does not report UE capability to the BS to indicate that a combination of at least one of above-described Method 6 to Method 8 can be supported, the UE capability may indicate that methods other than the at least one combination of methods reported by the UE are supported, or that none of Method 6 to Method 8 are supported. As an example, if the UE defines UE capability to indicate that Method 7 can be supported, and if the UE does not report the UE capability to the BS, the BS may consider that the report indicates both that the UE does not support Method 7 and that Method 6 is supported.

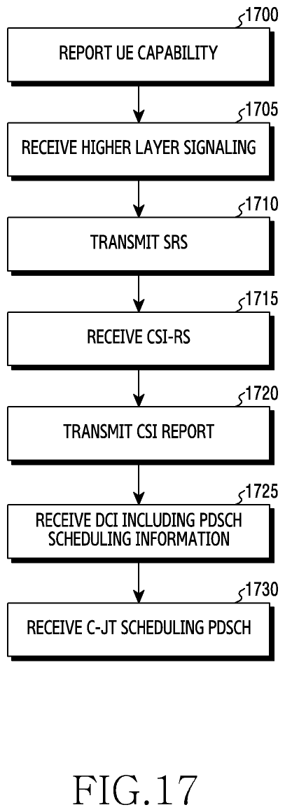

FIG. 17 illustrates operations of a UE according to an embodiment.

In step 1700, the UE may transmit UE capability to the BS. The UE capability signaling that the BS may receive may be related to a combination of at least one of an SRS for antenna switching, UE capability related to CSI-RS support, UE capability indicating whether above-described Method 1 to Method 5 are supported, and UE capability indicating whether above-described Method 6 to Method 8 are supported. Step 1700 may be omitted.

In step 1705, the UE may receive higher layer signaling from the BS. The UE may define a higher layer parameter regarding a combination of at least one of an SRS for antenna switching, higher layer signaling related to CSI-RS support, above-described Method 1 to Method 5, and above-described Method 6 to Method 8 from the BS, and may use one among the same.

In step 1710, the UE may transmit an SRS to the BS. The SRS transmitted from the UE may be configured such that the usage (higher layer signaling) in an SRS resource set including an SRS resource used to transmit the SRS is antenna switching. In addition, when transmitting the SRS to the BS, the UE may transmit individual SRSs to multiple MMUs or may transmit a single SRS to multiple MMUs.

In step 1715, the UE may receive a CSI-RS from the BS. The UE may receive one CSI-RS or multiple CSI-RSs included in a CSI resource setting connected to the CSI report configured through higher layer signaling from the BS. In the case of one CSI-RS, the UE may receive the identical CSI-RS from multiple MMUs. In the case of multiple CSI-RSs, the UE may consider that respective CSI-RSs are transmitted from respective MMUs.

In step 1720, the UE may transmit a CSI report calculated by receiving the CSI-RS to the BS. As described above, the UE may use more bits in a channel between a specific MMU and the UE than channels between other MMUs and the UE, thereby expressing the channel between a specific MMU and the UE more accurately during quantization.

In step 1725, the UE may receive DCI which may include PDSCH scheduling information from the BS, and may acquire information related to PDSCH scheduling from the BS, based thereon.

In step 1730, the UE may receive a PDSCH from the BS. The PDSCH may be transmitted by the BS according to a DL joint transmission scheme. The BS may calculate an integrated DL precoder for DL joint transmission, based on information regarding channels between respective MMUs and the UE acquired through the UE's SRS transmission and the UE's CSI report transmission, and may apply the integrated DL precoder to PDSCH transmission.

The above-described flowchart illustrates a method of the disclosure, and may be variously modified. For example, although illustrated as a series of steps, various steps in respective drawings may overlap, occur in parallel, occur in different order, or occur multiple times. Some steps may be omitted or replaced with other steps. As an example, in above-described step 1710 (UE's SRS transmission), step 1715 (UE's CSI-RS reception), and step 1720 (UE's CSI report transmission), the order of respective operations may be changed, and the accuracy of a channel between a specific MMU and the UE obtained by the BS, based on a CSI report and an SRS transmitted by the UE, may differ as the order is changed.

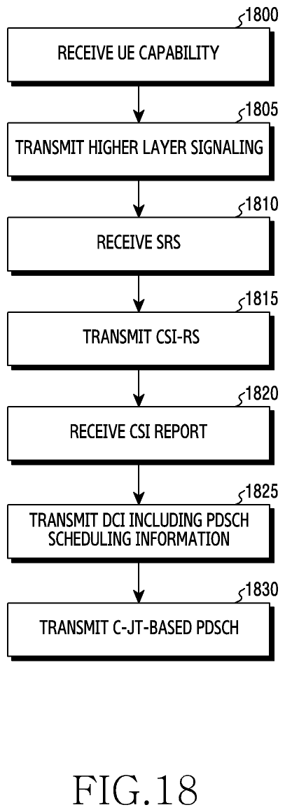

FIG. 18 illustrates operations of a base station according to an embodiment.

In step 1800, the BS may receive UE capability from the UE. The UE capability signaling that the BS may receive may be related to a combination of at least one of an SRS for antenna switching, UE capability related to CSI-RS support, UE capability indicating whether above-described Method 1 to Method 5 are supported, and UE capability indicating whether above-described Method 6 to Method 8 are supported. Step 1800 may be omitted.

In step 1805, the BS may transmit higher layer signaling to the UE according to the UE capability reported by the UE. The UE may define a higher layer parameter regarding a combination of at least one of an SRS for antenna switching, higher layer signaling related to CSI-RS support, above-described Method 1 to Method 5, and above-described Method 6 to Method 8 from the BS, and may use one among the same.

In step 1810, the BS may receive an SRS from the UE. The SRS transmitted from the UE may be configured such that the usage (higher layer signaling) in an SRS resource set including an SRS resource used to transmit the SRS is antenna switching. In addition, when transmitting the SRS to the BS, the UE may transmit individual SRSs to multiple MMUs or may transmit a single SRS to multiple MMUs.

In step 1815, the BS may transmit a CSI-RS to the UE. The UE may receive one CSI-RS or multiple CSI-RSs included in a CSI resource setting connected to the CSI report configured through higher layer signaling from the BS. In the case of one CSI-RS, the UE may receive the identical CSI-RS from multiple MMUs. In the case of multiple CSI-RSs, the UE may consider that respective CSI-RSs are transmitted from respective MMUs.

In step 1820, the BS may receive a CSI report calculated and transmitted by the UE, based on the CSI-RS transmitted to the UE. As described above, the UE may use more bits in a channel between a specific MMU and the UE than channels between other MMUs and the UE, thereby expressing the channel between a specific MMU and the UE more accurately during quantization. The BS may receive a CSI report transmitted by the UE after expressing, in each MMU, channels between the UE and MMUs other than the corresponding MMU more accurately, and may acquire information regarding channels between other MMUs and the UE, based thereon.

In step 1825, the BS may transmit DCI which may include PDSCH scheduling information to the UE.

In step 1830, the BS may transmit a PDSCH to the UE according to a DL joint transmission scheme. The BS may calculate an integrated DL precoder for DL joint transmission, based on information regarding channels between respective MMUs and the UE acquired through the UE's SRS transmission and the UE's CSI report transmission, and may apply the integrated DL precoder to PDSCH transmission.

The above-described flowchart illustrates a method of the disclosure, and the method illustrated in the flowchart in the specification may be variously modified. For example, although illustrated as a series of steps, various steps in respective drawings may overlap, occur in parallel, occur in different order, or occur multiple times. Some steps may be omitted or replaced with other steps. As an example, in above-described step 1810 (BS's SRS reception), step 1815 (BS's CSI-RS transmission), and step 1820 (BS's CSI report reception), the order of respective operations may be changed, and the accuracy of a channel between a specific MMU and the UE obtained by the BS, based on a CSI report and an SRS transmitted by the UE, may differ as the order is changed.

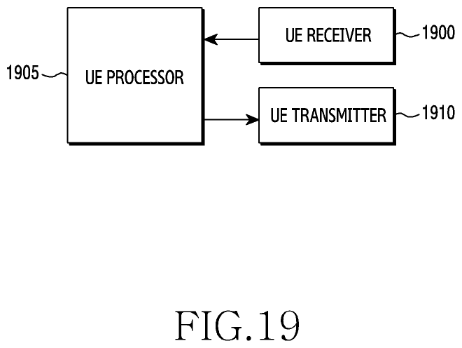

FIG. 19 illustrates a structure of a UE in a wireless communication system according to an embodiment.

Referring to FIG. 19, the UE may include a transceiver, which refers to a UE receiver 1900 and a UE transmitter 1910 as a whole, a memory, and a UE processor 1905 (or UE controller or processor). The UE transceiver 1900 and 1910, the memory, and the UE processor 1905 may operate according to the above-described communication methods of the UE. Components of the UE are not limited to the above-described example. For example, the UE may include a larger or smaller number of components than the above-described components. The transceiver, the memory, and the processor may be implemented in the form of a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

The transceiver may receive signals through a radio channel, output the signals to the processor, and transmit signals output from the processor through the radio channel.

The memory may store programs and data necessary for operations of the UE. The memory may store control information or data included in signals transmitted/received by the UE. The memory may include storage media such as a read only memory (ROM), a random access memory (RAM), a hard disk, a CD-ROM, and a DVD, or a combination of storage media. The memory may include multiple memories.

The processor may control a series of processes such that the UE can operate according to the above-described embodiments. For example, the processor may control components of the UE to receive DCI configured in two layers to simultaneously receive multiple PDSCHs. The processor may include multiple processors, and the processor may perform operations of controlling the components of the UE by executing programs stored in the memory.

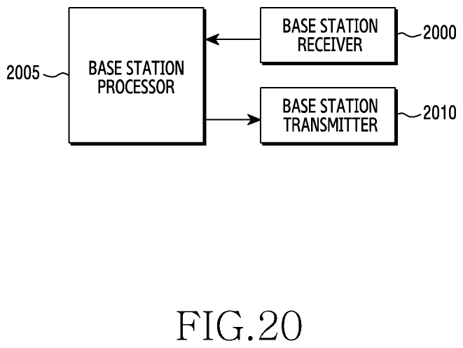

FIG. 20 illustrates a structure of a base station in a wireless communication system according to an embodiment.

Referring to FIG. 20, the base station may include a transceiver, which refers to a base station receiver 2000 and a base station transmitter 2010 as a whole, a memory, and a base station processor 2005 (or base station controller or processor). The base station transceiver 2000 and 2010, the memory, and the base station processor 2005 may operate according to the above-described communication methods of the base station. However, P components of the base station are not limited to the above-described example. For example, the base station may include a larger or smaller number of components than the above-described components. The transceiver, the memory, and the processor may be implemented in the form of a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. However, this is only an embodiment of the transceiver, and the components of the transceiver are not limited to the RF transmitter and the RF receiver.

The transceiver may receive signals through a radio channel, output the signals to the processor, and transmit signals output from the processor through the radio channel.

The memory may store programs and data necessary for operations of the base station. The memory may store control information or data included in signals transmitted/received by the base station. The memory may include storage media such as a ROM, a RAM, a hard disk, a CD-ROM, and a DVD, or a combination of storage media. The memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods in the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

The programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the unit refers to a software element or a hardware element, such as a Field Programmable Gate Array (FPGA) or an Application Specific Integrated Circuit (ASIC), which performs a predetermined function. However, the unit does not always have a indicating limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more CPUs within a device or a security multimedia card. Furthermore, the unit in embodiments may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a wireless communication system, the method comprising:
receiving, from a base station, first configuration information on a sounding reference signal (SRS) resource;
receiving, from the base station, second configuration information for a channel state information (CSI) report;
transmitting, to the base station, an SRS for a first channel between a first transmission and reception point (TRP) and the terminal based on the first configuration information; and
transmitting, to the base station, the CSI report including a measurement result of a second channel between a second TRP and the terminal based on the second configuration information.

2. The method of claim 1,
wherein information for the first channel is based on the SRS, and
wherein information for the second channel is based on the CSI report.

3. The method of claim 1,
wherein the second configuration information includes information on resources for the CSI report,
wherein the resources include at least one first resource on which a measurement result of the first channel is reported and at least one second resource on which the measurement result of the second channel is reported, and
wherein a number of bits for the at least one second resource is greater than a number of bits for the at least one first resource.

4. The method of claim 1,
wherein the SRS resource includes a first SRS resource for the first TRP and a second SRS resource for the second TRP, or
wherein the SRS resource includes common resources for the first TRP and the second TRP.

5. The method of claim 1,
wherein the first TRP and the second TRP are included in the base station.

6. A method performed by a base station in a wireless communication system, the method comprising:
transmitting, to a terminal, first configuration information on a sounding reference signal (SRS) resource;
transmitting, to the terminal, second configuration information for a channel state information (CSI) report;
receiving, from the terminal, an SRS for a first channel between a first transmission and reception point (TRP) and the terminal based on the first configuration information; and
receiving, from the terminal, the CSI report including a measurement result of a second channel between a second TRP and the terminal based on the second configuration information.

7. The method of claim 6,
wherein information for the first channel is identified based on the SRS, and
wherein information for the second channel is identified based on the CSI report.

8. The method of claim 6,
wherein the second configuration information includes information on resources for the CSI report,
wherein the resources include at least one first resource on which a measurement result of the first channel is reported and at least one second resource on which the measurement result of the second channel is reported, and
wherein a number of bits for the at least one second resource is greater than a number of bits for the at least one first resource.

9. The method of claim 6,
wherein the SRS resource includes a first SRS resource for the first TRP and a second SRS resource for the second TRP, or
wherein the SRS resource includes common resources for the first TRP and the second TRP.

10. The method of claim 6,
wherein the first TRP and the second TRP are included in the base station.

11. A terminal in a wireless communication system, the terminal comprising:
a transceiver; and
at least one processor coupled with the transceiver and configured to:
receive, from a base station, first configuration information on a sounding reference signal (SRS) resource,
receive, from the base station, second configuration information for a channel state information (CSI) report,
transmit, to the base station, an SRS for a first channel between a first transmission and reception point (TRP) and the terminal based on the first configuration information, and
transmit, to the base station, the CSI report including a measurement result of a second channel between a second TRP and the terminal based on the second configuration information.

12. The terminal of claim 11,
wherein information for the first channel is based on the SRS, and
wherein information for the second channel is based on the CSI report.

13. The terminal of claim 11,
wherein the second configuration information includes information on resources for the CSI report,
wherein the resources include at least one first resource on which a measurement result of the first channel is reported and at least one second resource on which the measurement result of the second channel is reported, and
wherein a number of bits for the at least one second resource is greater than a number of bits for the at least one first resource.

14. The terminal of claim 11,
wherein the SRS resource includes a first SRS resource for the first TRP and a second SRS resource for the second TRP, or
wherein the SRS resource includes common resources for the first TRP and the second TRP.

15. The terminal of claim 11,
wherein the first TRP and the second TRP are included in the base station.

16. A base station in a wireless communication system, the base station comprising:
a transceiver; and
at least one processor coupled with the transceiver and configured to:
transmit, to a terminal, first configuration information on a sounding reference signal (SRS) resource,
transmit, to the terminal, second configuration information for a channel state information (CSI) report,
receive, from the terminal, an SRS for a first channel between a first transmission and reception point (TRP) and the terminal based on the first configuration information, and
receive, from the terminal, the CSI report including a measurement result of a second channel between a second TRP and the terminal based on the second configuration information.

17. The base station of claim 16,
wherein information for the first channel is identified based on the SRS, and
wherein information for the second channel is identified based on the CSI report.

18. The base station of claim 16,
wherein the second configuration information includes information on resources for the CSI report,
wherein the resources include at least one first resource on which a measurement result of the first channel is reported and at least one second resource on which the measurement result of the second channel is reported, and
wherein a number of bits for the at least one second resource is greater than a number of bits for the at least one first resource.

19. The base station of claim 16,
wherein the SRS resource includes a first SRS resource for the first TRP and a second SRS resource for the second TRP, or
wherein the SRS resource includes common resources for the first TRP and the second TRP.

20. The base station of claim 16,
wherein the first TRP and the second TRP are included in the base station.
